(19) United States
(12) Patent Application Publication
(10) Pub. No.: US 2024/0121663 A1
(43) Pub. Date: Apr. 11, 2024

(54) TECHNOLOGIES TO SUPPORT EXTENDED REALITY NETWORK TRAFFIC

(71) Applicant: Intel Corporation, Santa Clara, CA (US)

(72) Inventors: Rafia Malik, Portland, OR (US); Sudeep Palat, Cheltenham (GB); Yujian Zhang, Beijing (CN); Marta Martinez Tarradell, Hillsboro, OR (US); Yi Guo, Shanghai (CN); Youn Hyoung Heo, San Jose, CA (US)

(21) Appl. No.: 18/470,624

(22) Filed: Sep. 20, 2023

Related U.S. Application Data
(60) Provisional application No. 63/411,365, filed on Sep. 29, 2022.
(60) Provisional application No. 63/485,519, filed on Feb. 16, 2023.
(60) Provisional application No. 63/494,705, filed on Apr. 6, 2023.

(51) Int. Cl. H04W 28/06; H04L 47/32; H04W 28/02

(52) U.S. Cl. CPC H04W 28/06; H04L 47/32; H04W 28/0278

(57) ABSTRACT

The present disclosure provides various mechanisms to improve the communication of critical data, such as extended reality (XR) data, cloud gaming (CG) data, ultra-reliable low latency communications (URLLC) data, internet of things (IoT) data, and/or any other type of high priority data/traffic. The described mechanisms include enhancements to buffer status reporting mechanisms; packet, protocol data unit (PDU), and/or service data unit (SDU) discard mechanisms; mechanisms to resolve issues related to system frame number (SFN) wraparound; and network congestion detection mechanisms. Other embodiments may be described and/or claimed.

### CROSS REFERENCE TO RELATED APPLICATIONS

The present application claims priority to U.S. Provisional App. No. 63/411,365 filed Sep. 29, 2022 (“'365”), U.S. Provisional App. No. 63/485,519 filed Feb. 16, 2023 (“'519”), and U.S. Provisional App. No. 63/494,705 filed Apr. 6, 2023 (“'705”), the contents of each of which are hereby incorporated by reference in their entireties and for all purposes.

### BACKGROUND

Extended reality (XR) is a catch-all term that refers to augmented reality (AR), virtual reality (VR), mixed reality or mediated reality (MR) technologies, where “X” in “XR” is a variable that can interpolate between these various realities or extrapolate or extend beyond them. The XR fields are rapidly growing and being applied in a wide range of areas, such as entertainment, marketing, real estate, training, maintenance, and remote work.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings, in which:

FIG. 1 depicts an example procedure for updated BSR after PDU discard; FIGS. 2, 3, 4, 5, 6, 13, 14, 15, and 16 depict example medium access control (MAC) control elements (CE);

FIG. 7 depicts an example of a system frame number (SFN) wraparound issue for discontinuous reception (DRX);

FIG. 8 depicts an example of a hyper SFN (HSFN) boundary ambiguity issue;

FIG. 9 depicts an example of resolving traffic misalignment after SFN wraparound using an updated connected mode DRX (cDRX) formula;

FIG. 10 depicts an example of an HSFN boundary ambiguity being resolved using cDRX reference SFN in RRC;

FIG. 11 depicts example I and P frames in XR traffic;

FIG. 12 depicts an example of PDU discard under network congestion;

FIG. 17 depicts an example XR traffic model;

FIG. 18 depicts an example network architecture;

FIG. 19 depicts an example wireless network;

FIG. 20 depicts example hardware resources; and

FIGS. 21, 22, 23, 24, 25, and 26 depict example processes for practicing various embodiments discussed herein.

### DETAILED DESCRIPTION

The present disclosure is generally related to wireless communication, cellular networks, cloud computing, edge computing, data centers, network topologies, and communication system implementations, and in particular, to technologies to support extended reality (XR) traffic in wireless networks, such as efficient buffer status reporting for XR traffic, packet discard mechanisms for XR traffic, and differentiated handling of XR traffic.

### 1. EXTENDED REALITY (XR) ASPECTS

Extended reality (XR) traffic can demand high data rates, with low latency transmission to provide the desired user experience and meet quality of service (QoS) requirements. In XR, groups of packet(s) (sometimes referred to as a “PDU Set”) may have different characteristics and QoS requirements, and there may even exist dependency within or among such groups of packets or PDU sets. This dependency could be among packets belonging to the same PDU set (intra-PDU set dependency) or it could be between packets belonging to different PDU sets (inter-PDU set dependency). If there exists such dependency between XR PDUs, then loss/failure of a “critical” or high importance packet could potentially render the decoder unable to decode the dependent packets without successfully receiving the “critical” packet. Such high importance packets or PDU sets may require special treatment/prioritization, such as in the case of network congestion.

The present disclosure provides various embodiments to improve the communication of critical data, such as by enhancing reliability and resource-efficient communication of critical data. The described embodiments include enhancements to buffer status reporting mechanisms; packet/PDU/SDU discard mechanisms; mechanisms to resolve issues related to system frame number (SFN) wraparound; and network congestion detection mechanisms. These embodiments reduce the amount of transmissions over the air interface thereby reducing network congestion, reducing resource consumption, improved power savings, capacity improvements, and improved user experience. The following discussion is described in the context of XR data transmission, however, it should be understood that the embodiments herein are not limited to XR data, and can be straightforwardly applied to other types of critical data, such as cloud gaming (CG) data, ultra-reliable low latency communications (URLLC) data, IoT data, QoS flows/data, and/or any other type of high-priority data/traffic.

### 1.1. [AE9280] Enhancements to Buffer Status Reporting for XR Traffic

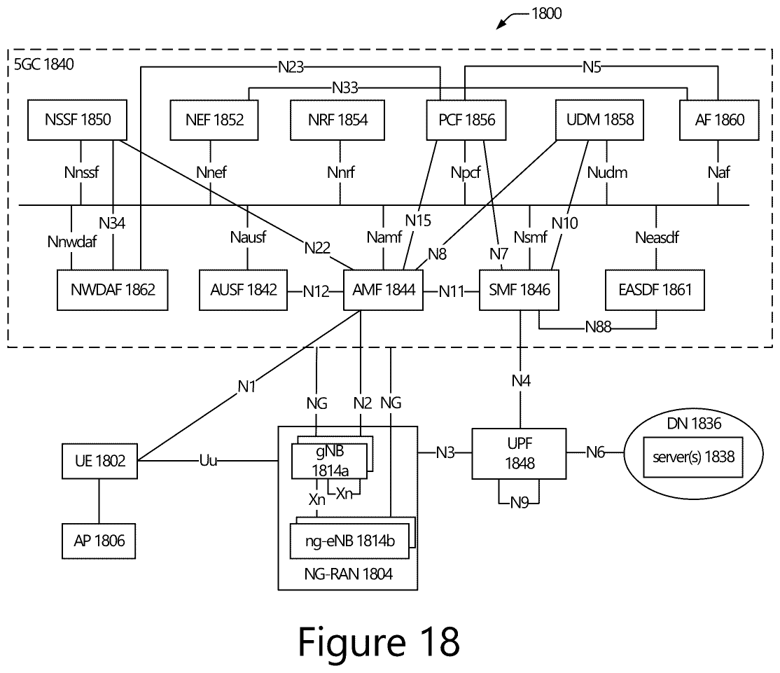

The embodiments discussed herein can be used to streamline the buffer status reporting, packet discarding, and resource allocation processes. In some examples, the embodiments herein solve and/or minimize the issue when a network may have allocated uplink (UL) grants for packets that may have been discarded before a RAN node (e.g., network access node (NAN) 1814, such as gNB 1814a in FIG. 18) receives an updated BSR. The present disclosure describes efficient buffer status reporting of XR traffic in the UL to support the characteristic traits of XR traffic (e.g., low latency, high data rates, enhanced reliability, and the like) and minimizing resource consumption and/or overhead in the event of packet discarding. In these ways, unnecessary transmission of PDUs over the air interface can be reduced or avoided, which can reduce network congestion and decrease resource consumption. Enhancements to the BSR process can also lead to capacity improvements and power savings in the network.

The following sections describe UL scheduling and hybrid automatic repeat request (HARQ) retransmission aspects, an example use-case where issues could arise wherein the network (NW) allocates UL grants for packets that have been discarded by a UE (e.g., UE 1802 in FIG. 18) before the NW (e.g., RAN node 1814 in FIG. 18) receives an updated BSR, and the extent the current 5GS can cope with or handle these issues; a framework to mitigate/resolve this issue; and optimizations to the buffer status reporting process to help avoid this issue from arising, using XR traffic awareness information. The mechanisms explained infra, as well as any of the other mechanisms discussed herein, can be equally co-applicable, for example, they may work fully or partially together.

### 1.1.1. Study on XR Enhancements for NR

The RAN1 release (Rel-)17 Study Item “Study on XR Evaluations for NR” has shown that eXtended Reality (XR) and Cloud Gaming (CG) are within the use cases and services considered important for NR in Rel-18 and beyond. In general, XR and CG are wide terms referring to various types of augmented, virtual, and mixed environments, where human-to-machine and human-to-human communications are performed with the assistance of handheld and wearable end user devices (UEs). Cloud gaming (CG) refers to a group of use cases where the overwhelming majority of computations related to gaming (e.g., single-player or multi-player games) is/are offloaded from a UE 1802 to an edge compute node or remote server(s) (e.g., XR server(s) 1738 of Figure XR, server(s) 1838 of FIG. 18, and/or the like). XR is a broad-scope umbrella term for multiple heterogeneous use cases and services that were studied and outlined in 3GPP TR 22.842, 3GPP TR 26.928, among others. These XR use cases can be roughly divided into AR, VR, MR. While XR and CG present a set of attractive use cases for future mobile systems, they also impose a set of challenges for NR/5GS that need to be studied and potentially addressed.

Many of the XR and CG use cases are characterized by quasi-periodic traffic (with possible jitter) with high data rate in the downlink (DL) (e.g., video streams, and/or the like) combined with the frequent UL (e.g., pose/control update) and/or UL video streams. Both DL and UL traffic are also characterized by relatively strict packet delay budget (PDB).

Many of the end-user XR and CG devices are expected to be mobile and small-scale (or small form factor) with limited battery power resources. Therefore, additional power enhancements and/or power-saving enhancements may be needed to reduce the overall UE power consumption when running XR/CG services and to extend the effective UE battery lifetime. It is understood that the current discontinuous reception (DRX) configurations do not fit well for non-integer XR traffic periodicity, variable XR data rate, and quasi-periodic XR periodicity.

The set of anticipated XR/CG services has a certain variety and characteristics of the data streams (e.g., video and the like) may change “on-the-fly”, while the services are running over NR/5G. Therefore, additional information on the running services from higher layers (e.g., the QoS flow association, frame-level QoS, application data unit (ADU)-based QoS, XR-specific QoS, and/or the like) may be beneficial to facilitate informed choices of radio parameters. It is clear that XR application awareness by the UE 1802 and RAN 1804 (or gNB 1814a) would improve user experience, improve the NR/5G system capacity in supporting XR services, and reduce UE power consumption. SA Working Groups (WGs) are expected to lead the work on identifying necessary enhancements to improve XR awareness, and RAN WGs will be made aware of these enhanced parameters and can potentially tailor the radio processing of XR traffic.

In 3GPP work item description (WID) document RP-220285, titled “Revised SID: Study on XR Enhancements for NR” (FS_NR_XR_enh), includes objectives on XR-awareness in RAN (RAN2) and objectives on XR-specific capacity improvements (RAN1, RAN2). The XR-awareness objectives include studying and identifying XR traffic (both UL and DL) characteristics, QoS metrics, and application layer attributes beneficial for a RAN node to be aware of; and studying how this information aids XR-specific traffic handling. The XR-specific capacity improvement objectives include studying mechanisms that provide more efficient resource allocation and scheduling for XR service characteristics (e.g., periodicity, multiple flows, jitter, latency, reliability, and the like), with focus on the following mechanisms: SPS and CG enhancements; and dynamic scheduling/grant enhancements. The following progress/discussions have been made in related topics so far in RAN WGs.

RAN1 has had some discussion on BSR and SR enhancements, but current agreements made are more high level. The main point under discussion in RAN1 has been on how to reduce scheduling latency in the case of dynamic UL grants, for example, from the initial point when a UE sends an SR to when the UL grants are scheduled for data transmission. Main points agreed are as follows: (i) RAN1 will study enhancement related to scheduling request and/or BSR with the focus on L1 enhancements; and (ii) when DG is used as the baseline, after SR is triggered, both BSR and UL data can be transmitted using the UL grant after SR. Additionally, RAN1 has agreed that whether/how to enhance BSR to improve capacity performance of XR traffic is within RAN2 scope and is not handled by RAN1, however, there are now two opens at RAN1 side as below: (i) companies are encouraged to provide the size of resources by the first UL grant after SR; and (ii) RAN1 can evaluate BSR enhancement to improve capacity performance.

RAN2 has received some contributions on this topic, however, these contributions mostly include high-level proposals with a focus on BSR enhancements to support QoS aware scheduling, including: (i) large quantization error for large XR packets can be avoided by enhanced BSR granularity, by reporting buffer size more precisely; (ii) latency information of buffered data can be included in the BSR for prioritized scheduling of low latency data or data for which delay budget is about to expire; (iii) traffic pattern can be included in the BSR to report changes to XR traffic pattern or packet arrival rate; and (iv) new BSR triggers can be defined, for example, if there is low latency requirement for remaining data in buffer or if a new PDU set arrives in buffer, and/or the like.

In some cases, the NW (e.g., RAN 1804) might have outdated BSR information when a UE 1802 discards packets without knowledge of the network. Moreover, in some cases the NW may have assigned an UL grant for packets that are discarded by the UE 1802 before the RAN node 1814 (e.g., gNB 1814a) receives an updated BSR. In other cases, the NW might have not allocated a grant yet, but it is still important to know about a reduction in the UE's 1802 buffered data volume (e.g., for future scheduling, resource usage/planning). From the UE's 1802 perspective, this scenario could happen in the case when some critical PDUs within a PDU set are lost, corrupted, or delayed, and therefore, the UE 1802 decides to discard remaining PDUs within the PDU set to avoid unnecessary transmission. A similar scenario may also appear in inter-dependent PDU sets (e.g., when a PDU set is lost, corrupted, or delayed), which may lead to the discard of related/dependent PDU sets. However, before receiving an updated BSR from the UE 1802, the RAN node 1814 may already have allocated UL grants for the PDUs which were in the UL buffer earlier, for example, at the time of sending the previous BSR.

### 1.1.2. Current Use-Cases and Handling Aspects

The aforementioned problems stem from the case of UL transmission from the delay or timing mismatch in declaring a packet as lost at the transmitter (Tx) and receiver (Rx) end, and the gap between the UE 1802 and RAN node 1814 when certain packets are discarded at the UE 1802.

### 1.1.2.1. UL Grant Scheduling

In the current 5GS, a BSR can be triggered when new data or PDU set(s) or part of a PDU set arrives in the UL transmission buffer of the UE 1802. The UE 1802 transmits a scheduling request (SR) to the RAN node 1814 when no resources or configured grants are available to transmit the BSR. The RAN node 1814 is initially unaware of the amount of data to be transmitted, and schedules a few UL grants for BSR transmission. Once the RAN node 1814 receives the BSR, it can then perform QoS aware packet scheduling (see e.g., [TS38321]) and allocates UL resources considering the received BSR.

### 1.1.2.2. HARQ Retransmission

If a packet transmitted by the UE 1802 in UL fails to be successfully received at the RAN node 1814, there is no HARQ acknowledgement (ACK)/negative ACK (NACK) feedback from the RAN node 1814. Rather, since it is the RAN node 1814 that both receives and schedules UL resources, feedback for PUSCH is via a UL grant with a new data indicator (NDI) not toggled (e.g., a retransmission grant).

### 1.1.2.3. Example PDU Discard Problem

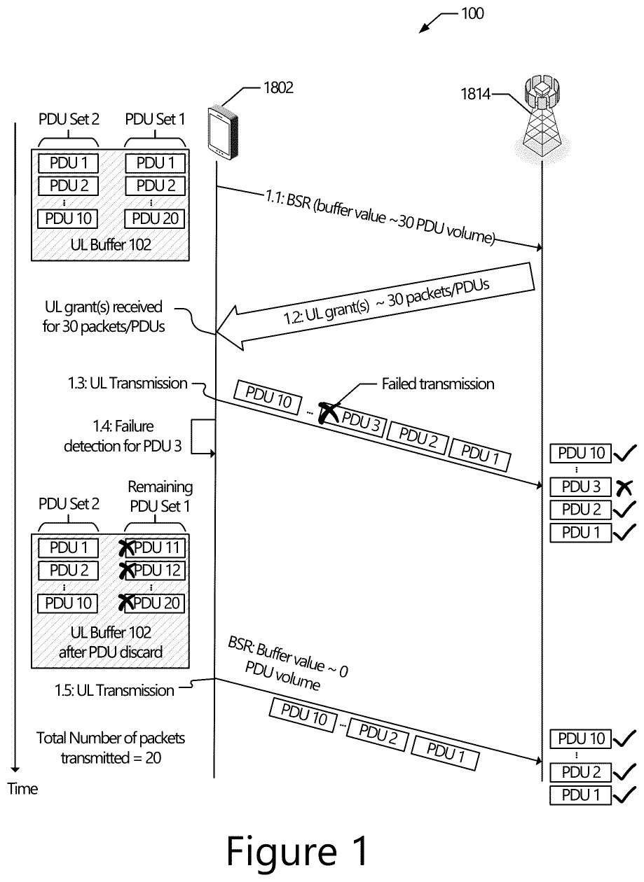

FIG. 1 depicts an example process 100 for updated BSR after PDU discard. Here, the UE 1802 has PDU set 1 and PDU set 2 in the UL buffer 102 for transmission, where PDU set 1 has 20 PDUs and PDU set 2 has 10 PDUs. At operation 1.1, the UE 1802 sends a BSR to the RAN node 1814. The BSR provides the RAN node 1814 with information about UL data volume in the MAC entity corresponding to the two PDU sets in the UL buffer. In this example, the BSR includes a buffer value that indicates a 30 PDU data volume.

At operation 1.2, the RAN node 1814 allocates one or more UL grants to the UE 1802, and at operation 1.3, the UE 1802 attempts to transmit the 30 PDUs in the UL based on the one or more UL grants. In this example, the RAN node 1814 allocates UL grant(s) for the two PDU sets (e.g., 30 PDUs), but PDU 3 from PDU set 1 is lost or corrupted during transmission, as detected by the UE 1802 at operation 1.4. If PDU 3 is a critical data packet, such that the remaining packets of PDU set 1 (e.g., PDU 4 to PDU 20) are unnecessary or cannot be decoded, the UE 1802 upon exhausting HARQ retransmissions would consider the packet as unsuccessfully delivered and may decide to discard the remaining packets of PDU set 1 in the UL buffer, as is shown by the “remaining PDU Set 1” in the UL buffer 102 after discard. However, by this time the UE 1802 may have already transmitted, for example, PDU 4 to PDU 10 (e.g., at operation 1.3), and the RAN node 1814 may already have allocated UL grants for PDUs 11 to 20, since even though the RAN node 1814 is aware of the lost PDU 3, it does not know of the implication (in terms of discarding remaining packets of the PDU set) of losing this packet. This leads to a waste of UL grants already assigned by the RAN node 1814. At operation 1.5, the UE 1802 transmits the PDUs in PDU set 2.

### 1.1.2.4. Current PDU Discard Handling Aspects

In the current 5GS, when the UE 1802 has discarded packets for which it initially requested resource allocation (UL grants) from the RAN node 1814 in a previous UL BSR, the UE 1802 may be able to act in the following ways.

One approach involves the UE 1802 sending a padding BSR MAC CE as part of a MAC PDU reporting the updated data volume after packet discard. This would help the network if the UE 1802 has a chance to send the padding BSR before the RAN node 1814 allocates UL grants (to schedule packets discarded by UE). If so, then the use-case discussed in section 1.1.2.4 can be avoided. Whether a padding BSR can be transmitted, however, depends on the UE's 1802 situation, for example, a padding BSR is only transmitted when there is sufficient space in a MAC PDU to accommodate the BSR MAC CE plus its subheader (see e.g., [TS38321]). Also, considering the high data rate of XR traffic, and the high expected traffic volume, for example in interactive applications, there is no guarantee that the padding BSR could be transmitted before the RAN node 1814 has allocated any resources for the discarded packets, rather a high probability could be assumed for the contrary to happen.

Another approach involves the UE 1802 skipping the UL grant even if the UL grant is already allocated by the RAN node 1814 (intended for the discarded packets). This may be done if the UE 1802 is configured with the capability to skip UL transmission (e.g., PUSCH skipping). However, this might require that no UL control information (UCI) is multiplexed on that PUSCH. While this is possible (if configured), the current specifications do not require (e.g., mandate) this UE 1802 behavior, particularly for the case of XR traffic and/or when packets are discarded.

Since the current 5GS is unable to assuredly handle the PDU discard problem described previously (see e.g., section 1.1.2.4), the following sections discuss approaches towards resolving/mitigating these issues.

### 1.1.3. New BSR Triggering Condition Upon Discarding Packets

In some implementations, a new BSR triggering condition is introduced, such that when the UE 1802 performs the packet discard operation, it sends an updated BSR to the RAN node 1814 with the updated data volume in the buffer (e.g., after subtracting the discarded packets' volume). For example, the UE 1802 reports a reduction in UL data volume via a BSR or other kind of reporting mechanism as discussed infra. The UE 1802 may decide to perform the PDU discard when some packets/PDUs are identified as unnecessary or superfluous for transmission. For example, when packet(s) are not useful at the Rx side because related or dependent packets/PDUs were not successfully decoded, were lost or corrupted, or the delivery is or would be after the maximum threshold (which may be defined as a configured delay budget expired). Additionally or alternatively, the UE 1802 may decide to perform PDU discard autonomously or upon receipt of an indication from the NW and/or upper layers.

Depending on the size of UL grant following an SR, it is also possible that the UE 1802 sends few packets of the PDU set (including critical packet) along with the BSR and learns of the transmission failure. This might trigger the discard of all the remaining packets in the UL buffer that are related to that PDU set. Therefore, it is also possible that there may not be data left in the UL buffer for the corresponding logical channel group (LCG).

In summary, when the UE 1802 decides or performs discard of some data, this can trigger the transmission of a BSR or other form of indication that may convey the UE's 1802 feedback, such as on the data status or amount of data at the UE 1802. In one example, a new MAC control element (CE) for Discard update BSR, discussed infra, can be used for this purpose. Additional condition(s) can be defined in connection with the PDU discard for the UE 1802 to trigger the BSR. A first example additional condition can be at least one of the logical channels which belong to an LCG contains UL data. A second example additional condition can be a threshold to be applied to the discarded data (e.g., the UE 1802 needs to discard at least certain amount of data). A third example additional condition can be a threshold might apply to the remaining data in general or in relation to one specific logical channel or group. Any combination of the aforementioned additional conditions may be used, and/or other additional conditions can be defined. These conditions may work by themselves or in conjunction with other condition(s).

An example of an associated specification update to 3GPP TS 38.321 (“[TS38321]”) (e.g., 3GPP TS 38.321 v17.5.0 (2023 Jun. 30), the contents of which are hereby incorporated by reference in its entirety) for the new BSR trigger when the UE 1802 discards data is as shown by table 1.1.3.

```
TABLE 1.1.3
A BSR shall be triggered if any of the following events occur for activated cell group:
    UL data, for a logical channel which belongs to an LCG, becomes available to the MAC entity; and either
      this UL data belongs to a logical channel with higher priority than the priority of any logical channel
      containing available UL data which belong to any LCG; or
      none of the logical channels which belong to an LCG contains any available UL data.
    in which case the BSR is referred below to as ′Regular BSR′;
    UL resources are allocated and number of padding bits is equal to or larger than the size of the Buffer
  Status Report MAC CE plus its subheader, in which case the BSR is referred below to as ′Padding BSR′;
    retxBSR-Timer expires, and at least one of the logical channels which belong to an LCG contains UL data,
  in which case the BSR is referred below to as ′Regular BSR′;
    periodicBSR-Timer expires, in which case the BSR is referred below to as ′Periodic BSR′.
    A discard of certain PDUs is performed,
      at least one of the logical channels which belong to an LCG contains UL data, and/or
      none of the logical channels which belong to an LCG contains any available UL data,
          in which case the BSR is referred below to as “Discard update BSR”
```

### 1.1.4. New MAC CE for Discard Update BSR

In some implementations, a new MAC CE is used for the BSR update generated in the scenario where the UE 1802 discards certain data/PDUs, which is referred to herein as a “Discard update BSR”, “Discarded update BSR”, and/or the like. The priority of the “Discarded update BSR” could be the different from or same as that of a Regular BSR. Note that the BSR in section 1.1.3 with the new triggering condition could use an existing BSR format (e.g., including any of those discussed in [TS38321]) or a new BSR format defined herein. The feedback on the reduction of the UE's 1802 data buffer volume (which is also referred herein as a “Discard update BSR”) can be defined or specified in multiple ways. In a first example, which is shown by FIG. 2, the Discard update BSR contains information on the discarded PDUs as well as an updated buffer status report. In a second example, which is shown by FIG. 3, the Discard update BSR only provides information on which bytes should not be considered from a previous BSR (e.g., a BSR sent before the subject MAC CE).

FIG. 2 shows an example MAC CE 200 containing information on discarded PDUs and an updated BSR. The bitmap_{N} field (where N is a number) indicates which (PDCP) PDUs are dropped and which PDUs are not dropped in the Tx PDCP entity starting from the PDCP PDU identified by the PDCP sequence number (SN) field (e.g., 12 bit or 18 bit, where the length of the PDCP SN is as configured by upper layers for the data radio bearer (DRB) and/or QoS flow), and its associated PDU set is identified by the PDCP PDU Set SN field. The bit position of Nth bit in the bitmap is N and the bit position of the first bit in the bitmap is 1. Even if the PDCP PDU Set SN field is omitted, the bitmap could still be functional if PDUs from a PDU set are received sequentially and in order. Such bitmap can also be conveyed in a control PDCP PDU, as discussed in U.S. Provisional App. No. 63/359,150 filed on 7 Jul. 2022) (“'150”), the contents of which are hereby incorporated by reference in its entirety.

The DRB ID field indicates the identity of a DRB for which the MAC CE 200 applies. The length of the DRB ID field is 5 bits. The buffer size field identifies the total amount of data available according to the data volume calculation procedure in [TS38322] and [TS38323] across all logical channels of an LCG after the MAC PDU has been built (e.g., after the logical channel prioritization (LCP) procedure, which may result the value of the buffer size field to zero). The amount of data is indicated in a number of bytes. The size of the radio link control (RLC) headers and MAC subheaders are not considered in the buffer size computation. The length or size of the buffer size field may vary depending on the particular format being used, and these sizes are discussed in [TS38321]. In this example, there are multiple buffer size fields, and the buffer size fields are included in ascending order based on the LCGᵢ. The number of buffer size fields included may be maximized, while not exceeding a number of padding bits. Additionally or alternatively, a buffer size fields for corresponding LCGs are included in decreasing order of a highest priority of the logical channel having data available for transmission in each of the LCGs. Additional aspects of the buffer size field are also discussed in [TS38321].

FIG. 3 shows an example MAC CE 300 containing information on a delta (δ) (or change) from a last sent BSR. The information on the δ from the previously (last) sent BSR may be contained in the δ buffer sizeₘ field (where m is a number). This might be a helpful approach when a delta (δ) BSR may occupy less resources than sending a new/updated BSR. The MAC CE 300 may also be referred to as a delta BSR (or δ BSR) and it should be understood that the delta (δ) in the δ buffer size field can be denoted with an uppercase delta (Δ) and/or using any other suitable symbol. In some examples, the δ BSR is only used when the UE 1802 has not received new data in the UL buffer at the time when it sends the Discard update BSR (e.g., MAC CE 300) since the last transmitted BSR. In some examples, the δ buffer size field may be formatted in a same or similar manner as the buffer size field discussed previously and/or in [TS38321].

The MAC CEs 200 and 300 also include an LCGᵢ field (where i is a number), which indicates the presence of the buffer size field (or the δ buffer size field) for the logical channel group i. The LCGᵢ field set to 1 indicates that the buffer size field (or the δ buffer size field) for the logical channel group i is reported. The LCGᵢ field set to 0 indicates that the buffer size field (or the δ buffer size field) for the logical channel group i is not reported. The LCGᵢ field(s) is/are also used for a long BSR format, extended long BSR format, pre-emptive BSR format, and extended pre-emptive BSR format, and in some implementations, the MAC CEs 200 and 300 can be incorporated into those formats as well. For the long truncated BSR format and the extended long truncated BSR format, this field indicates whether logical channel group i has data available. The LCGᵢ field set to 1 indicates that logical channel group i has data available. The LCGᵢ field set to 0 indicates that logical channel group i does not have data available.

A third example includes a Discard update BSR that contains an updated (reduced) volume and uses a legacy BSR format. The legacy BSR formats can include any of the BSR MAC CEs discussed in [TS38321] (e.g., short BSR format; extended short BSR format; long BSR format; extended long BSR format; short truncated BSR format; extended short truncated BSR format; long truncated BSR format; extended long truncated BSR format; pre-emptive BSR format; extended pre-emptive BSR format; sidelink BSR (SL-BSR) format; and/or truncated SL-BSR format). In this example, if the packets are discarded at the Tx before any transmission attempt is made, the allocated PDCP SNs can be reused for new packets, and a legacy BSR format which only indicates the reduction in data volume can be used. However, if the packets (intended for discard) have already been transmitted (successful or failed transmission), then it may be useful to indicate the PDCP SN gap to the receiving entity and a new BSR format (e.g., the BSR format in FIG. 2) could be used.

### 1.1.5. Enhanced UL Skipping for Already Allocated Resources

This enhancement is an application of the UL skipping procedure, specifically for the case of XR traffic where the UE 1802 may decide to discard certain packets of a PDU set, such that said packets were indicated as present in a previous BSR, and the RAN node 1814 has not received or processed an updated BSR since then. Given the large data volume usually associated with XR transmission, the absence of user data could potentially be detected by the RAN node 1814 (e.g., due to low received signal power on the skipped PUSCH), in which case it could become aware of a discarded-packet situation.

Another scenario is for the RAN node 1814 to detect this based on data present in the grant. If the UE 1802 has data from a lower priority logical channel, it may include that instead of skipping the UL. In this, case, the network could detect the PDU-discard situation by the presence of data from a lower priority logical channel. The UE 1802 may also flush the HARQ buffer for the corresponding HARQ process.

### 1.1.6. Optimizations to BSR Based on XR Traffic Awareness Information

It may be assumed based on SA2 discussion and 3GPP TR 23.700-60, that in UL, the UE 1802 (e.g., the media applications operated by the UE 1802) is aware of the XR traffic characteristics (also referred to as media traffic characteristics, per-XR flow information, and/or the like), which includes PDU and PDU set related information, such as delay budget (e.g., per PDU, per PDU set, and/or remaining PDB of the PDU set for radio interface), importance or criticality of a given PDU within a PDU set (e.g., if other PDUs are dependent on a given critical PDU), size of a PDU set, PDU Set sequence number carried in each constituent PDU, boundary indicators (e.g., first and last PDU of a PDU set), PDU set level packet handling/treatment requirements, PDU set jitter information, and/or other relevant information, such as traffic pattern information, statistics, QoS characteristics, application characteristics, associated PCC rules, burst periodicity, traffic periodicity and periodicity changes, number of temporal and spatial media layers and their (PDU set) periodicities and their (PDU set) dependencies, media detection rules that specify RTP header type (for media where RTP header is used), and/or the like. The XR related information may also be associated with a burst of data which may contain one or more PDUs or PDU sets. The UE 1802 may indicate in the BSR preceding the transmission of a PDU set, the delay budget of the PDU set, for example, the delay budget of the data to be transmitted, the importance or priority of the data in the buffer, or the data size/volume of the PDU set. This could potentially aid in QoS aware scheduling by the network where the RAN node 1814 is cognizant of the traffic characteristics in UL. While the implementations discussed previously are aimed towards providing a resolution to the problem arising in use-case depicted in section 1.1.2.4, certain optimizations to BSR and resource scheduling can be adopted to help avoid the problem in the first place. To this end, some potential optimizations are provided infra.

### 1.1.6.1. Optimization Based on Importance/Priority of XR Traffic

In some examples, the logical channel configuration could provide an indication on the importance/priority of the XR traffic that is to be carried. Different approaches on how to define such indication(s) are described infra.

### 1.1.6.1.1. Indication in Logical Channel Configuration

A first approach involves a new indication, which is configured for a logical channel to indicate if it carries critical data. For example, a new criticality configuration could be included in the configuration for logical channels for the UL side (new IE shown in red and underline), as shown by the example of table 1.1.6.1.1-1.

TABLE 1.1.6.1.1-1
LogicalChannelConfig IE

-- ASN1START
-- TAG-LOGICALCHANNELCONFIG-START

| LogicalChannelConfig ::= | SEQUENCE { | | |
|---|---|---|---|
| ul-SpecificParameters | SEQUENCE { | | |
| priority | INTEGER (1..16), | | |
| prioritisedBitRate | ENUMERATED {kBps0, kBps8, kBps16, kBps32, kBps64, | | |
| | kBps128, kBps256, kBps512, kBps1024, | | |
| | kBps2048, kBps4096, kBps8192, kBps16384, | | |
| | kBps32768, kBps65536, infinity}, | | |
| bucketSizeDuration | ENUMERATED {ms5, ms10, ms20, ms50, ms100, ms150, | | |
| | ms300, ms500, ms1000, spare7, spare6, | | |
| | spare5, spare4, spare3, spare2, spare1}, | | |
| allowedServingCells | SEQUENCE (SIZE (1..maxNrofServingCells-1)) OF | | |
| | ServCellIndex | OPTIONAL, -- Cond PDCP-CADuplication | |
| allowedSCS-List | SEQUENCE (SIZE (1..maxSCSs)) OF SubcarrierSpacing | | |
| | | OPTIONAL, -- Need R | |
| maxPUSCH-Duration | ENUMERATED {ms0p02, ms0p04, ms0p0625, ms0p125, ms0p25, | | |
| | ms0p5, ms0p01-v1700, spare1} | | |
| | | OPTIONAL, -- Need R | |
| configuredGrant Type1Allowed | ENUMERATED {true} | | |
| | | OPTIONAL, | -- Need R |
| logicalChannelGroup | INTEGER (0..maxLCG-ID) | OPTIONAL, | -- Need R |
| schedulingRequestID | SchedulingRequestId | | |
| OPTIONAL, -- Need R | | | |
| logicalChannelSR-Mask | BOOLEAN, | | |
| logicalChannelSR-DelayTimerApplied | BOOLEAN, | | |
| . . . , | | | |
| bitRateQueryProhibitTimer | ENUMERATED {s0, sodot4, sodot8, sldot6, s3, s6, s12, s30} | | |
| | | OPTIONAL, -- Need R | |
| [ [ | | | |
| allowedCG-List-r16 | SEQUENCE (SIZE (0.. maxNrofConfiguredGrantConfigMAC-1- | | |
| r16)) OF ConfiguredGrantConfigIndexMAC-r16 | | OPTIONAL, | -- Need S |
| allowedPHY-PriorityIndex-r16 | ENUMERATED {p0, p1} | OPTIONAL | -- Need S |
| ] ], | | | |
| [ [ | | | |

| | | | |
|---|---|---|---|
| logicalChannelGroupIAB-Ext-r17 | INTEGER (0..maxLCG-ID-IAB-r17) | OPTIONAL, | -- Need R |
| allowedHARQ-mode-r17 | ENUMERATED {harqModeA, harqModeB} | OPTIONAL | -- Need R |

| | | |
|---|---|---|
| ] ], | | |
| [ [ | | |
| dependencyCritical-r18 | BOOLEAN | OPTIONAL |
| ] ] | | |
| } | | OPTIONAL, -- Cond UL |

| | | |
|---|---|---|
| ..., | | |
| [ [ | | |
| channelAccessPriority-r16 | INTEGER (1..4) | OPTIONAL, -- Need R |
| bitRateMultiplier-r16 | ENUMERATED {x40, x70, x100, x200} | OPTIONAL -- Need R |
| ] ] | | |
| } | | |

-- TAG-LOGICALCHANNELCONFIG-STOP
-- ASN1STOP

TABLE 1.1.6.1.1-2
LogicalChannelConfig field descriptions

allowedCG-List
This restriction applies only when the UL grant is a configured grant. If present, UL MAC SDUs from this logical
channel can only be mapped to the indicated configured grant configuration. If the size of the sequence is zero,
then UL MAC SDUs from this logical channel cannot be mapped to any configured grant configurations. If the field
is not present, UL MAC SDUs from this logical channel can be mapped to any configured grant configurations. If
the field configuredGrantType1Allowed is present, only those configured grant type 1 configuration indicated in this
sequence are allowed for use by this logical channel; otherwise, this sequence shall not include any configured
grant type 1 configuration. Corresponds to “allowedCG-List” as specified in [TS38321]. This field is ignored when
SDT procedure is ongoing.
allowedHARQ-mode
Indicates the allowed HARQ mode of a HARQ process mapped to this logical channel. If the parameter is absent,
there is no restriction for HARQ mode for the mapping. This field applies to SRB1, SRB2 and DRBs.
allowedPHY-PriorityIndex
This restriction applies only when the UL grant is a dynamic grant. If the field is present and the dynamic grant has
a PHY-priority index, UL MAC SDUs from this logical channel can only be mapped to the dynamic grants
indicating PHY-priority index equal to the values configured by this field. If the field is present and the dynamic
grant does not have a PHY-priority index, UL MAC SDUs from this logical channel can only be mapped to this
dynamic grant if the value of the field is p0, see TS 38.213 [13], clause 9. If the field is not present, UL MAC SDUs
from this logical channel can be mapped to any dynamic grants. Corresponds to “allowedPHY-PriorityIndex” as
specified in [TS38321].
allowedSCS-List
If present, UL MAC SDUs from this logical channel can only be mapped to the indicated numerology. Otherwise,
UL MAC SDUs from this logical channel can be mapped to any configured numerology. Corresponds to
‘allowedSCS-List’ as specified in [TS38321].
Only the following values are applicable depending on the used frequency:
FR1: 15, 30, or 60 kHz
FR2-1: 60 or 120 kHz
FR2-2: 120, 480, or 960 kHz
allowedServingCells
If present, UL MAC SDUs from this logical channel can only be mapped to the serving cells indicated in this list.
Otherwise, UL MAC SDUs from this logical channel can be mapped to any configured serving cell of this cell
group. Corresponds to ‘allowedServingCells’ in [TS38321].
bitRateMultiplier
Bit rate multiplier for recommended bit rate MAC CE as specified in [TS38321]. Value ×40 indicates bit rate
multiplier 40, value ×70 indicates bit rate multiplier 70 and so on.
bitRateQueryProhibitTimer
The timer is used for bit rate recommendation query in [TS38321], in seconds. Value s0 means 0 s, s0dot4 means
0.4 s and so on.
bucketSizeDuration
Value in ms. ms5 corresponds to 5 ms, value ms10 corresponds to 10 ms, and so on.
channelAccessPriority
Indicates the Channel Access Priority Class (CAPC), as specified in 3GPP TS 38.300, to be used on uplink
transmissions for operation with shared spectrum channel access in FR1. The network configures this field only for
SRB2 and DRBs.
configuredGrantType1Allowed
If present, or if the capability lcp-Restriction as specified in TS 38.306 [26] is not supported, UL MAC SDUs from
this logical channel can be transmitted on a configured grant type 1. Otherwise, UL MAC SDUs from this logical
channel cannot be transmitted on a configured grant type 1. Corresponds to ‘configuredGrantType1Allowed’ in
[TS38321]. This field is ignored when SDT procedure is ongoing.
dependencyCritical-r18
If present, it indicates that data for this logical channel may be critical in comparison to other related XR data
packets.
logicalChannelGroup, logicalChannelGroupIAB-Ext
ID of the logical channel group, as specified in [TS38321], which the logical channel belongs to. The
logicalChannelGroupIAB-Ext is only applicable to the IAB-MT. When logicalChannelGroupIAB-Ext is configured,
logicalChannelGroup shall be ignored.
logicalChannelSR-Mask
Controls SR triggering when a configured uplink grant of type1 or type2 is configured. true indicates that SR
masking is configured for this logical channel as specified in [TS38321].
logicalChannelSR-DelayTimerApplied
Indicates whether to apply the delay timer for SR transmission for this logical channel. Set to false if
logicalChannelSR-Delay Timer is not included in BSR-Config.
maxPUSCH-Duration
If present, UL MAC SDUs from this logical channel can only be transmitted using uplink grants that result in a
PUSCH duration shorter than or equal to the duration indicated by this field. Otherwise, UL MAC SDUs from this
logical channel can be transmitted using an uplink grant resulting in any PUSCH duration. Corresponds to
“maxPUSCH-Duration” in [TS38321]. The PUSCH duration is calculated based on the same length of all symbols,
and the shortest length applies if the symbol lengths are different.
priority
Logical channel priority, as specified in [TS38321].
prioritisedBitRate
Value in kiloBytes/s. Value kBps0 corresponds to 0 kiloBytes/s, value kBps8 corresponds to 8 kiloBytes/s, value
kBps16 corresponds to 16 kiloBytes/s, and so on. For SRBs, the value can only be set to infinity.
schedulingRequestId
If present, it indicates the scheduling request configuration applicable for this logical channel, as specified in
[TS38321].

LCP can consider whether logical channel carries critical data to determine the priority order for multiplexing the corresponding logical channel onto UL resources. This “criticality” factor may also be considered in conjunction with some delay parameter which could for example be conveyed in the BSR. Then, the logical channel with critical data, which is also delay sensitive (or has some delay timer expiring soon) could be considered highest priority to be multiplexed first, and also have relevant configuration for higher reliability, for example, lower MCS. Table 1.1.6.1.1-3 shows an example change to the LCP procedure defined by [TS38321] § 5.4.3.1, which can also be applied to the LCP procedure defined by [TS38321] § 5.22.1.4.1 (e.g., for sidelink LCP).

TABLE 1.1.6.1.1-3
RRC controls the scheduling of uplink data by signalling for each logical
channel per MAC entity:
dependencyCritical-r18 which indicates presence of critical data upon
which other data is dependent;
priority where an increasing priority value indicates a lower priority level;
prioritisedBitRate which sets the Prioritized Bit Rate (PBR);
bucketSizeDuration which sets the Bucket Size Duration (BSD).

In the example of table 1.1.6.1.1-3, if the dependencyCritical-r18 IE is set to true, the logical channel carries data packet(s) that may be essential for successful decoding of subsequent packets. Reusing the current priority IE will not work for XR traffic, since it does not clearly represent the unique characteristic of data inter-dependence which thus far only exists for XR traffic. It can be the case that each logical channel for which the value of dependencyCritical-r18 IE is set to true, may be allocated to the same LCG using the logicalChannelGroup.

Additional control of the LCP procedure by configuring mapping restrictions for each logical channel could also be possible. Either existing RRC configuration such as allowedPHY-PriorityIndex could be re-used, or an additional configuration for the case of XR traffic could be introduced, such as the allowedPHY-CriticalIndex shown by table 1.1.6.1.1-4. Table 1.1.6.1.1-4 shows another example change to the LCP procedure defined by [TS38321] § 5.4.3.1, which can also be applied to the LCP procedure defined by [TS38321] § 5.22.1.4.1 (e.g., for sidelink LCP).

TABLE 1.1.6.1.1-4
RRC additionally controls the LCP procedure by configuring mapping
restrictions for each logical channel:
allowedSCS-List which sets the allowed Subcarrier Spacing(s) for
transmission;
maxPUSCH-Duration which sets the maximum PUSCH duration allowed
for transmission;
configuredGrantType1Allowed which sets whether a configured grant
Type 1 can be used for transmission;
allowedServingCells which sets the allowed cell(s) for transmission;
allowedCG-List which sets the allowed configured grant(s) for
transmission;
allowedPHY-PriorityIndex which sets the allowed PHY priority index(es)
of a dynamic grant for transmission;
allowedPHY-CriticalIndex which sets the PHY critical bit of an UL grant
for transmission;
allowedHARQ-mode which sets the allowed uplinkHARQ-mode for
transmission.

### 1.1.6.1.2. New/Separate Logical Channel Group for Logical Channels Carrying XR Traffic

A second approach involves using a new and/or separate LCG for logical channels carrying (critical) XR traffic. Here, one or multiple new LCG_{y} could also be defined, updating the maxLCG-ID value for logicalChannelGroup to x, or a new IE logicalChannelGroupXR-Ext-r18 could be defined with maxLCG-ID-XR-r18 set to x or more. Another option could be that for the case of XR traffic, particular value(s) of LCGᵢ (e.g., i=y) could be designated for the logical channels which carry critical traffic. Then, if a BSR carries LCG_{y} which signifies critical data packets, the RAN node 1814 may configure, for example, more robust MCS level for initial transmissions or retransmissions of critical packets to aid their successful delivery. Moreover, if packets being carried by a logical channel for which critical value is set to true are lost/corrupted, the RAN node 1814 can anticipate impending packet discard for the remaining packets of the PDU set and can either update resource allocation or may even cancel PUSCH transmissions as per RAN node 1814 implementation.

Such an optimization could have two-fold benefits: on one hand critical packets could be transferred more reliably reducing the chance/need of packet discard, and on the other hand it may allow RAN node 1814 to perform discard-aware scheduling to avoid wasteful resource allocation.

### 1.1.6.1.3. Information on Data Criticality in BSR

A third approach involves using information on data criticality in the BSR. For each LCG included in the BSR, a criticality flag could be included, to indicate if logical channels for any given LCG carry critical data packets. An example MAC CE is shown in FIG. 4.

FIG. 4 shows an example BSR MAC CE 400 that includes data criticality information. The BSR MAC CE 400 includes a Cᵢ field, which indicates the presence of critical data for the logical channel group i. The Cᵢ field set to 1 indicates that logical channel(s) in the logical channel group i carry critical data. The buffer size field and the LCGᵢ field may be the same as discussed previously w.r.t FIGS. 2-3. For LCGs carrying critical data, the RAN node 1814 could allocate resources with enhanced reliability configurations or could prioritize resource scheduling for transmission of such critical data.

### 1.1.6.2. Optimization Based on XR Traffic Characteristics/Requirements

Information on XR traffic characteristics (e.g., delay budget requirements, and/or any other suitable XR traffic characteristics, such as any of those discussed herein) for XR traffic at the UE 1802 and at the RAN node 1814 can provide benefits with regards to efficient use of resources, and delay aware resource scheduling. Different approaches on such characteristics can be utilized are described infra.

### 1.1.6.2.1. Avoid Unnecessary Transmissions Based on Delay Budget

If the RAN node 1814 is made aware of the delay budget requirement of the PDU set (e.g., either from the CN 1840 or from the Rx application's requirement(s)), or if some delay information is indicated by the UE 1802 (e.g., in the BSR), then the RAN node 1814 can also assess whether successful reception of a particular packet (e.g., PDU 3 in the example of FIG. 1) or reception of a PDU set is possible. The RAN node 1814 can signal, to the UE 1802, a duration max_delay based on the delay budget requirement of the PDU set in an RRC configuration for the DRB, or on a preconfigured delay tolerance. This max_delay can be configured by the RAN node 1814 at the beginning of a PDU set transmission, and is most likely considered to be applied in conjunction with some other XR traffic awareness information available to the UE 1802 and/or RAN node 1814, such as information on the size of the PDU set, information on critical data in the PDUs, the overall or individual packet delay requirements for the data in the PDU set, and/or the like.

In some examples, the max_delay can be or indicate the maximum time duration before which the RAN node 1814 should receive all packets in a PDU set considering all factors contributing towards end-to-end latency. Additionally or alternatively, the max_delay can be or indicate the maximum time by which all critical data packets in a PDU set should be received for successful decoding of the information carried by that PDU set. Note that the max_delay value can be different from individual packet delay budget requirement, for example, a per packet PDB could be 10 ms for XR traffic, however given the PDU-to-PDU set mapping of several packets, the Rx at the RAN node 1814 may wait a max_delay duration of 20 ms for critical packets even if individual PDB for the XR traffic flow is exceeded.

Such critical packets (e.g., PDU 3 in the example of FIG. 1) are to be correctly received on their own, but are also important for decoding the overall PDU set to which they belong. The UE 1802 can track the elapsed time duration, and if it receives a retransmission grant from the RAN node 1814 (after unsuccessful initial transmission of PDU 3), based on the max_delay value, the UE 1802 can decide whether there is sufficient time to perform the n^{th} HARQ retransmission, where n≥1. If the UE 1802 receives a retransmission grant, but the max_delay value is already exceeded, then the UE 1802 may ignore the retransmission grant, recycle it for other data packets for the same LCG with same QoS requirement, and/or perform UL skipping (if configured). In this way since both RAN node 1814 and the UE 1802 are aware of the delay budget requirements, the UE 1802 could limit the number of HARQ retransmissions, avoid unnecessary (re)transmissions, and thus avoid wasting resources. Additionally, the RAN node 1814 could pre-emptively cancel or not schedule PUSCH transmissions if packet discard is imminent following an expiration of max_delay timer.

Table 1.1.6.2.1-1 shows an example PDCP configuration (PDCP-Config) IE, which is used to set the configurable PDCP parameters for signaling, MBS multicast and data radio bearers. In this example, the PDCP-Config is updated to include the max_delay parameter discussed previously. Additional aspects of the PDCP-Config are discussed in 3GPP TS 38.331 (“[TS38331]”) (e.g., 3GPP TS 38.331v17.5.0 (2023 Jul. 1), the contents of which are hereby incorporated by reference in its entirety).

TABLE 1.1.6.2.1-1
PDCP-Config IE

-- ASNISTART
-- TAG-PDCP-CONFIG-START

| PDCP-Config ::= | SEQUENCE { | |
|---|---|---|
| drb | SEQUENCE { | |
| discardTimer | ENUMERATED | {ms10, ms20, ms30, ms40, ms50, ms60, ms75, ms100, |
| | | ms150, ms200, ms250, ms300, ms500, ms750, ms1500, |
| | | infinity} OPTIONAL, -- Cond Setup |
| pdcp-SN-SizeUL | ENUMERATED | {len12bits, len18bits} OPTIONAL, --Cond Setup1 |
| pdcp-SN-SizeDL | ENUMERATED | {len12bits, len18bits} OPTIONAL, --Cond Setup2 |

| | |
|---|---|
| < ... > | |
| . . . , | |
| [ [ | |
| cipheringDisabled | ENUMERATED {true} |

OPTIONAL -- Cond ConnectedTo5GC

| | |
|---|---|
| ] ], | |
| [ [ | |
| discardTimerExt-r16 | SetupRelease {DiscardTimerExt-r16} OPTIONAL, --Cond DRB2 |
| moreThanTwoRLC-DRB-r16 | SEQUENCE { |
| splitSecondaryPath-r16 | LogicalChannelIdentity OPTIONAL, --Cond SplitBearer2 |
| duplicationState-r16 | SEQUENCE (SIZE (3)) OF BOOLEAN OPTIONAL --Need S |

```
  }  OPTIONAL,  -- Cond MoreThanTwoRLC-DRB
ethernetHeaderCompression-r16 SetupRelease {EthernetHeaderCompression-r16}  OPTIONAL  --Need M
  ] ],
  [ [
```

| | |
|---|---|
| survivalTimeStateSupport-r17 | ENUMERATED {true} OPTIONAL, -- Cond Drb-Duplication |
| uplinkDataCompression-r17 | SetupRelease {UplinkDataCompression-r17} OPTIONAL, --Cond Rlc-AM |
| discardTimerExt2-r17 | SetupRelease { DiscardTimerExt2-r17 } |
| OPTIONAL, -- Need M | |
| multicastHFN-AndRefSN-r17 | BIT STRING (SIZE (32) ) OPTIONAL, --Cond SetupOnlyMRB |
| ] ] , | |
| [ [ | |

max_delay ENUMERATED {ms7, ms10, ms15, ms20, ms30, ms40, ms50, ms60, ms100} OPTIONAL

] ]

TABLE 1.1.6.2.1-2
PDCP-Config field descriptions

cipheringDisabled
If included, ciphering is disabled for this DRB regardless of which ciphering algorithm is configured for the
SRB/DRBs. The field may only be included if the UE is connected to 5GC. Otherwise the field is absent. The
network configures all DRBs with the same PDU-session ID with same value for this field. The value for this field
cannot be changed after the DRB is set up.
discardTimer
Value in ms of discardTimer specified in [TS38323]. Value ms 10 corresponds to 10 ms, value ms20 corresponds to
20 ms and so on. The value for this field cannot be changed in case of reconfiguration with sync, if the bearer is
configured as DAPS bearer.
discardTimerExt
Value in ms of discardTimer specified in [TS38323]. Value ms0dot5 corresponds to 0.5 ms, value ms 1 corresponds
to 1ms and so on. If this field is present, the field discardTimer is ignored and discardTimerExt is used instead.
discardTimerExt2
Value in ms of discardTimerExt specified in [TS38323]. Value ms2000 corresponds to 2000 ms. If this field is
present, the field discardTimer and discardTimerExt are ignored and discardTimerExt2 is used instead.
duplicationState
This field indicates the uplink PDCP duplication state for the associated RLC entities at the time of receiving this IE.
If set to true, the PDCP duplication state is activated for the associated RLC entity. The index for the indication is
determined by ascending order of logical channel ID of all RLC entities other than the primary RLC entity indicated
by primaryPath in the order of MCG and SCG, as in clause 6.1.3.32 of [TS38321]. If the number of associated RLC
entities other than the primary RLC entity is two, UE ignores the value in the largest index of this field. If the field is
absent, the PDCP duplication states are deactivated for all associated RLC entities.
ethernetHeaderCompression
This fields configures Ethernet Header Compression. This field can only be configured for a bi-directional DRB or a
bi-directional multicast MRB. The network reconfigures ethernetHeaderCompression only upon reconfiguration
involving PDCP re-establishment and with neither drb-ContinueEHC-DL nor drb-ContinueEHC-UL configured.
Network only configures this field when uplinkDataCompression is not configured.
moreThanTwoRLC-DRB
This field configures UL data transmission when more than two RLC entities are associated with the PDCP entity for
DRBs.
pdcp-SN-SizeDL
PDCP sequence number size for downlink, 12 or 18 bits, as specified in [TS38323]. For SRBs only the value
len12bits is applicable. The value for this field cannot be changed in case of reconfiguration with sync, if the bearer
is configured as DAPS bearer.
pdcp-SN-SizeUL
PDCP sequence number size for uplink, 12 or 18 bits, as specified in [TS38323]. For SRBs only the value len12bits
is applicable. The value for this field cannot be changed in case of reconfiguration with sync, if the bearer is
configured as DAPS bearer.
primaryPath
Indicates the cell group ID and LCID of the primary RLC entity as specified in [TS38323], clause 5.2.1 for UL data
transmission when more than one RLC entity is associated with the PDCP entity. In this version of the specification,
only cell group ID corresponding to MCG is supported for SRBs, except for the split SRB2 of the IAB-MT, and, when
the SCG is deactivated, for DRBs. The NW indicates cellGroup for split bearers using logical channels in different
cell groups. The NW always indicates logicalChannel if CA based PDCP duplication is configured in the cell group
indicated by cellGroup of this field.
splitSecondaryPath
Indicates the LCID of the split secondary RLC entity as specified in [TS38323] for fallback to split bearer operation
when UL data transmission with more than two RLC entities is associated with the PDCP entity. This RLC entity
belongs to a cell group that is different from the cell group indicated by cellGroup in the field primaryPath.
survivalTimeStateSupport
Indicates whether the DRB associated with this PDCP entity has survival time state support. If this field is configured
to be true, all associated RLC entities are activated for PDCP duplication upon reception of a retransmission grant
addressed to CS-RNTI, as specified in [TS38321].
uplinkDataCompression
Indicates the UDC configuration that the UE shall apply. Network does not configure uplinkDataCompression for a
DRB, if headerCompression or ethernetHeaderCompression is already configured or outOfOrderDelivery or DAPS
is configured for the DRB. The maximum number of DRBs where uplinkDataCompression can be applied is two.
The network reconfigures uplinkDataCompression only upon reconfiguration involving PDCP re-establishment. If the
field is set to drb-ContinueUDC, the PDCP entity continues the uplink data compression protocol during PDCP re-
establishment, as specified in [TS38323]. The field is set to drb-ContinueUDC only in case of resuming an RRC
connection or reconfiguration with sync, where the PDCP termination point is not changed and the fullConfig is not
indicated.

### 1.1.6.2.2. XR Traffic Characteristic-Aware Scheduling

For the case of UL transmission, assistance/feedback information from the UE with respect to the characteristic particular to XR traffic, could also potentially aid in QoS aware scheduling. This could include information on, for example, the PDUs to PDU set mapping relation, size of PDU sets or the number of PDU sets stored in the UL buffer, or latency information for delay critical data such as the delay budget of the PDU or PDU set. Such information could also be conveyed using the BSR which could be helpful in some scenarios for example if a PDU set is transmitted over multiple bursts, such that after one burst transmission, part of the PDU set remains in the UL buffer. In such a case, the RAN node 1814 may benefit from information, such as the remaining time before expiration of max_delay in the approach of section 0, or the PDB or PDU set delay budget (PSDB) for a PDU or PDU set, respectively. For the considered example of conveying some delay information in the BSR, a new delay information mapping table could be created as shown in table 0-1 and a new MAC CE for enhanced BSR carrying delay information values for XR traffic could be used, such as the MAC CE shown by FIG. 5. This delay information could be provided per logical channel group as shown in FIG. 5 in which case it could be the worst case value, that is the smallest value of remaining delay budget of data carried by any given logical channel in a particular logical channel group. Alternatively, this value may be defined as the mean or average value.

FIG. 5 shows an example BSR MAC CE 500 with delay budget information. The BSR MAC CE 500 includes a buffer size field, which may be the same or similar as discussed previously w.r.t FIGS. 2-4. The BSR MAC CE 500 also includes an LCG-extᵢ field, which indicates the presence of the delay value field for the logical channel group i. The LCG-extᵢ field set to 1 indicates that the delay value field for the logical channel group i is reported. The LCG-extᵢ field set to 0 indicates that the delay value field for the logical channel group i is not reported.

The BSR MAC CE 500 also includes a delay value field, which identifies the delay information for the data available across all logical channels of a corresponding LCG after the MAC PDU has been built. The delay information includes a delay index that corresponds to a delay budget value in milliseconds (ms). Example values for the 5-bit delay value field are shown by table 0-1.

TABLE 0-1
Delay budget values for 5-bit Delay Budget field

| Delay Index | Delay value (ms) |
|---|---|
| 0 | 5 |
| 1 | ≤7 |
| 2 | ≤8 |
| 3 | ≤9 |
| 4 | ≤10 |
| 5 | ≤15 |
| 6 | ≤20 |
| 7 | ≤25 |
| 8 | ≤30 |
| 9 | ≤35 |
| 10 | ≤40 |
| 11 | ≤45 |
| 12 | ≤50 |
| 13 | ≤55 |
| 14 | ≤60 |
| 15 | ≤65 |
| 16 | ≤70 |
| 17 | ≤75 |
| 18 | ≤80 |
| 19 | ≤85 |
| 20 | ≤90 |
| 21 | ≤100 |
| 22 | ≤110 |
| 23 | ≤120 |
| 24 | ≤130 |
| 25 | ≤140 |
| 26 | ≤150 |
| 27 | ≤160 |
| 28 | ≤170 |
| 29 | ≤180 |
| 30 | ≤200 |
| 31 | Reserved |

### 1.1.6.3. Enhancements to Buffer Table

While not related to the original issue under discussion, but with regards to resource wastage due to allocation of excessive/unused UL grants, one reason could be the low granularity of the buffer table for large data volumes in the UL buffer. To this end, a new set of indices (e.g., 256, . . . , 256+M, where M is a number) could be introduced in the buffer table particular to typical PDU set sizes for XR traffic. This would increase the granularity of BS volume reporting, without altering the existing BSR table which works for the current NR system for other traffic types.

### 1.2. [AF2026] Enhancements to Support XR Traffic

The embodiments discussed herein can be used to make the process of buffer status reporting, packet discarding, and resource allocation more streamlined, for example, to have updated BSR(s) to report the remaining time before expiration of data in a UL buffer. Connected mode DRX (cDRX) enhancements is also an area of interest to study in order to provide XR specific power saving techniques to accommodate XR service characteristics. The present disclosure discusses XR-specific enhancements to improve UE power savings, capacity enhancements, and XR awareness. The mechanism discussed herein are relevant to objectives captured in XR topic as part of Rel-18 (see e.g., section 1.1, supra).

In particular, the present disclosure discusses three areas of enhancement for Rel-18 XR, including: enhancements to the PDCP SDU discard mechanism to enable per-PDU-set based discard which is the requirement of NR/5G, enhancements to BSRs for packet discard and delay value reporting, and mechanisms to resolve issues arising from SFN wraparound during XR traffic transmission. The embodiments discussed herein allow unnecessary transmissions of PDUs over the air interface to be reduced or avoided thereby reducing network congestion and reducing resource consumption. Enhancements to the BSR process could lead to capacity improvement and resolving issues arising from SFN wraparound could lead to power savings.

### 1.2.1. PDU Discard Aspects

The Tx PDCP entity (e.g., the PDCP entity implemented by the UE 1802) maintains a discard timer (discardTimer), which may be configured for data radio bearers (DRBs). The duration of the discardTimer is configured by upper layers (see e.g., table 1.1.6.2.1-1 and/or [TS38331]). In the Tx, a new timer is started upon reception of an SDU from upper layer(s). For Tx operation, at reception of a PDCP SDU from upper layer(s), the Tx PDCP entity starts the discardTimer associated with this PDCP SDU (if configured). When the discardTimer expires for a PDCP SDU, or the successful delivery of a PDCP SDU is confirmed by a PDCP status report, the Tx PDCP entity discards the PDCP SDU along with the corresponding PDCP data PDU. If the corresponding PDCP data PDU has already been submitted to lower layers, the discard is indicated to the lower layers. For signaling radio bearers (SRBs), when upper layers request a PDCP SDU discard, the PDCP entity discards all stored PDCP SDUs and PDCP PDUs. In some examples, discarding a PDCP SDU already associated with a PDCP SN causes an SN gap in the transmitted PDCP data PDUs, which increases PDCP reordering delay in the receiving PDCP entity. The way in which the SN gap is minimized after SDU discard may be up to UE implementation.

It is agreed in RAN2 that the Tx PDCP entity can perform PDU set discard in Rel-18 XR. There exists a mechanism for PDCP discard in [TS38323], which is based on the discard timer (discardTimer). When the discardTimer expires for a PDCP SDU, the Tx PDCP entity discards the PDCP SDUs along with the corresponding PDCP Data PDU. If the existing PDCP discard mechanism is used as a baseline for XR, four possible scenarios from an implementation perspective are considered herein, which are as follows: Scenario 1: PSDB available and all PDUs of a PDU set arrive simultaneously at the Tx; Scenario 2: PSDB not available and all PDUs of a PDU set arrive simultaneously at the Tx; Scenario 3: PSDB available and PDUs of a PDU set arrive sequentially at the Tx (e.g., with some non-zero inter-arrival time between the first and last PDU of a PDU set); and Scenario 4: PSDB not available and PDUs of a PDU set arrive sequentially at the Tx (e.g., with some non-zero inter-arrival time between the first and last PDU of a PDU set). For these scenarios, an existing discardTimer can be used (e.g., discardTimer in the PDCP-Config of Table 1.1.6.2.1-1 supra, the sl-DiscardTimer in the SL-PDCP-Config IE, and/or the like) or a newly defined discardTimer can be used, such as any of those discussed herein.

Another aspect to consider for PDU set discard is the PDU Set Integrated Handling Indication (PSIHI) defined by SA2, which indicates whether all PDUs are needed for the usage of the PDU Set by the application layer in the Rx side. For Rel-18, it is assumed by SA2 that a PDU set is only successfully delivered when all PDUs of that set have been successfully received, for example, partial delivery of PDU set is not considered. Therefore, for Rel-18 if the PDB expires for a single PDCP PDU, all PDUs/SDUs of that PDU set are to be discarded. However, for the sake of forward compatibility, the relation of PDU discard to PSIHI should still be established in suitable standards or specifications. For example, if in a future release it is acceptable for the Rx to have partial PDU set delivery, then the remaining PDUs of a PDU set are only discarded if PSIHI is toggled/enabled.

### 1.2.1.1. Scenario 1.2.1-1: PSDB Available and all PDUS of a PDU Set Arrive Simultaneously at the Transmitter

In some implementations, if PSDB is available and all PDUs of a PDU set arrive simultaneously at the Tx, then the same value of the discardTimer will be used for all PDUs of a PDU set. It is assumed here that the UE 1802 maintains or has available a mapping of PDUs to their respective PDU set. The UE 1802 could maintain a discardTimerPerSet to monitor the elapsed time duration, with maximum acceptable time duration dependent on the PSDB value received from upper layers by the UE 1802. The discardTimerPerSet can be started when the PDU set arrives at the Tx. The discardTimer for all PDUs of the PDU set is started at the same time, and hence expires at the same time since the packet delay budget (PDB) for all PDUs of a PDU set is the same (as PDB is defined per QoS flow, and PDUs within a PDU Set will have the same QoS requirement). From implementation perspective, there are two options.

In a first option, if PSDB is available, the Tx disregards expiration of discardTimer for any individual PDU of the PDU Set if all PDUs arrive simultaneously at the Tx. The PDU set is only discarded upon expiration of the discardTimerPerSet e.g., if PSDB duration has elapsed and all PDUs in the PDU set are not successfully received (assuming that PSIHI is enabled).

In a second option, a single discardTimer or discardTimerPerSet is used for the PDU set with the timer value associated with the PSDB value of the PDU set; when the timer expires, all the remaining PDUs of the PDU set that have not been delivered can be discarded. From implementation perspective, it may be more straightforward to use the single discardTimerPerSet in this case, and the legacy discardTimer is not used (or equivalently it is set to infinity). The discardTimerPerSet is started when the PDU set arrives at the Tx and has maximum duration dependent on the available PSDB value for the PDU set.

### 1.2.1.2. SCENARIO 1.2.1-2: PSDB not Available and all PDUS of a PDU Set Arrive Simultaneously at the Transmitter

In some implementations, if PSDB is not available and all PDUs of a PDU set arrive simultaneously at the Tx, then the start/stop mechanism for the discardTimer will be the same as in scenario 1.2.1-1. For example, the discardTimer for all PDUs of the PDU set is started at the same time, and hence expires at the same time or the single discardTimerPerSet is used which is started when the PDU set arrives at the Tx. In this case, however, since PSDB value is not available, then the RAN node 1814 can configure the value for discardTimerPerSet for the UE 1802 for the UL transmission through RRC signaling. If a discardTimerPerSet is not configured by the RAN node 1814, and PSIHI is enabled, then the existing PDB value can be used to determine loss of XR packet(s)/PDU(s).

### 1.2.1.3. Scenario 1.2.1-3: PSDB Available and PDUS of a PDU Set Arrive Sequentially at the Transmitter

For DL transmission, there is a maximum duration threshold for inter-arrival time between the first received PDU and the last received PDU(s) constituting a PDU Set. A similar threshold could also be defined for UL transmission. This threshold may be used for the case when a PSDB is available and PDUs of a PDU set arrive sequentially at the Tx. It may be possible that all PDUs of the PDU set may not arrive at the transmitting PDCP entity at the same time. In these implementations, the discardTimer could be started at different points in time for the different PDUs of the PDU set. If PSIHI is enabled, for example, all PDUs are required to be received for successful delivery of a PDU set, then if discardTimer expires for any of the PDUs of the PDU set, the remaining PDUs of that PDU set can be discarded if PSDB duration has elapsed. Here, the discardTimer for the first PDU that is not yet transmitted (or still buffered) which arrives at the Tx will expire first. If PSIHI is enabled, and discardTimerPerSet (based on the PSDB or PDB value) expires, the remaining PDCP SDUs in the PDU set can be discarded regardless of the expiration of their respective discardTimer.

On the other hand, if PSIHI is enabled, and discardTimer for a PDCP SDU of the PDU set expires but discardTimerPerSet has not yet expired, the Tx will not discard that PDCP SDU in this case until the expiry of discardTimerPerSet which could be based on the PSDB or PDB value. In some examples, some allowance for the maximum tolerable threshold of inter-arrival time for PDUs within a PDU set may also be considered, such that the first PDU that is not yet transmitted does not violate the PSDB criterion if the discardTimerPerSet is associated with the last PDU of the PDU set.

### 1.2.1.4. Scenario 1.2.1-4: PSDB not Available and PDUS of a PDU Set Arrive Sequentially at the Transmitter

When PSDB is not available and PDUs of a PDU set arrive sequentially at the Tx, a similar approach to scenario 1.2.1-3 can be used with respect to (w.r.t) the start and stop mechanism of the discardTimer. However, in this case since PSDB is not available, and if PSIHI is enabled, then the Tx strives (or attempts) to deliver all PDUs of the PDU set successfully. In this scenario, if PSIHI is enabled, and discardTimer for first PDCP SDU of the PDU set expires but discardTimer of the last PDU has not yet expired, the UE 1802 will disregard the discardTimer of the first PDU and will only discard the first PDCP SDU upon expiration of the discardTimer of the final PDCP SDU from that PDU set. In this case since PSDB value is not available, the discardTimerPerSet could be configured by the RAN node 1814, or the discardTimerPerSet could be started when the last PDCP SDU of the PDU set is received at the transmitted. Then, the discardTimerPerSet will be similar to the discardTimer of this last PDU, however, it will take precedence over the discardTimer of other PDCP SDUs of the PDU set.

### 1.2.1.5. Mechanism Applicable to Each of Scenarios 1.2.1-1 to 1.2.1-4

In scenarios 1.2.1-1 and 1.2.1-4 supra, an implementation of PDCP SDU discard mechanism using/not-using the existing discardTimer is provided, while also introducing a per PDU set discard timer, discardTimerPerSet. A summary of the implementation for these scenarios is provided infra.

Another implementation that could apply to all four scenarios 1.2.1-1 to 1.2.1-4 includes using a legacy discardTimer. Then, if PSIHI is enabled, and discardTimer expires for any individual PDU of the PDU set, all PDUs in the PDU set are discarded. Here the value for the discard timer is based on PSDB (when it is available), or on the PDB of individual PDUs otherwise (e.g., when PSDB is not available). Additionally or alternatively, the discardTimer might take the most restrictive value of the ones available (e.g., PSDB and/or PDB). Note however, that this implementation may not be forward compatible, for example, if in future releases there is the possibility of PSIHI to not being enabled. Then, the set based discard timer discardTimerPerSet can be used to allow a more conservative discard approach if partial delivery of PDU sets is considered useful.

Another point is that, for XR traffic, PDU set based discard is to be implemented. Then having individual discardTimers (e.g., one timer associated with each PDU) while it may work for Rel-18 where PSIHI is always enabled, it does use multiple discardTimers for a single PDU set. However, this behavior of multiple discardTimers for a single PDU set could be avoided through the use of a PDU set based discard timer. The drawback for using such approach is that it does not make optimal use of the characteristics of XR traffic which allow the RAN 1804 to discard multiple PDUs at the same time, with the use of potentially a single timer, instead of maintaining multiple discardTimers as in legacy.

### 1.2.1.6. Summarization of Discard Scenarios

To summarize scenarios 1.2.1-1 through 1.2.1-4, to enable PDU set handling and discard for XR traffic which has not been submitted to lower (MAC) layers, the SDU discard could be used as a baseline. However, to enable the discard operation at a PDU set level, a configurable parameter of discardTimerPerSet can be introduced, which will either take precedence over the legacy discardTimer, or the legacy discardTimer is not used (e.g., set to infinity).

For the case when all PDUs of a PDU set arrive simultaneously at the Tx, the discardTimerPerSet value could be based on the PSDB value if available, otherwise on the PDB value of any PDU of the PDU set. The discardTimerPerSet is started concurrently with the discardTimer of any PDU of the PDU set, since all PDUs arrive simultaneously.

For the case when PDUs of a PDU set arrive sequentially at the Tx, the discardTimerPerSet value could be based on the PSDB value if available, or some maximum latency constraint configured by the RAN node 1814, otherwise on the PDB value of e.g., the last PDU of the PDU set since from SA2 perspective in general, a PDU Set is discarded when RAN determines that it cannot deliver all PDUs of that PDU Set successfully over the radio within the PDB of the last PDU in that PDU Set. The maximum latency constraint can be defined while considering both the PSDB/PDB value, as well as the maximum threshold for inter-arrival time among PDUs of a PDU set. A maximum latency constraint can be defined in RAN for packet discard. This maximum latency constraint, max_delay, could be based on the PDB value or on the PSDB value if it is available. Since the RAN node 1814 is aware of the PDB value, and PDU to PDU set mapping, the RAN node 1814 may configure a max_delay value per PDU set (e.g., delay from the arrival of the first PDU of the PDU set in the AS). This max_delay could be considered the maximum time duration before which the RAN node 1814 must receive all packets in a PDU set considering all factors contributing towards end-to-end latency. The UE 1802 can track the elapsed time duration and can discard packets if they are likely to not meet the maximum latency constraint of max_delay.

It is possible to track the last PDU of a PDU set since it is agreed in SA2 [TS23502] to include the “End PDU of the PDU Set” information under user plane enhancements. The discardTimerPerSet value could be based on the configured max_delay value and started when the first PDU of the PDU set arrives at the Tx. The PDU Set is discarded when the Tx determines that it cannot deliver all PDUs of that PDU Set successfully over the radio within the PDB of the End PDU of the PDU Set.

If discardTimerPerSet is started with the reception of the first PDU of the PDU set, this will be aligned with the PSDB definition in [TS23502], which is the duration between the reception time of the first PDU (at the N6 termination point for DL or the UE for UL) and the delivery time of last PDU of a PDU Set. The value of the set based discard timer can be dependent on both the PSDB/PDB value and the allowed inter-arrival time between PDUs of a PDU set. Another approach is to have the discardTimerPerSet always dependent on the PDB value, and start concurrently with the discardTimer of the last PDU of the PDU set.

### 1.2.2. BSR Enhancements

### 1.2.2.1. BSR Enhancements for Packet Discard

When a UE 1802 decides or performs discard of some data, this can trigger the transmission of BSR to indicate the amount of data discarded, or the amount of data remaining in the UE's 1802 buffer. Specifically, a PDCP entity indicates a PDCP data volume to a MAC entity for BSR triggering and buffer size calculation as discussed in [TS38321]. A BSR may be triggered even when none of the logical channels which belong to an LCG contain UL data. It is also possible that even after PDU discard, some data remains in the UL buffer. The transmitted BSR can potentially use the existing BSR MAC CE to report the data in the UL buffer (for both zero and non-zero case), however, some update to the data volume calculation and triggering conditions for BSR may be required.

For the purpose of MAC buffer status reporting, the Tx PDCP entity considers the following as PDCP data volume: the PDCP SDUs for which no PDCP Data PDUs have been constructed; the PDCP Data PDUs that have not been submitted to lower layers; the PDCP Control PDUs; for AM DRBs, the PDCP SDUs to be retransmitted according to clauses 5.1.2 and 5.13 of [TS38323]; and for AM DRBs, the PDCP Data PDUs to be retransmitted according to clause 5.5 of [TS38323]. Here, the PDCP data volume is the amount of data available for transmission in an PDCP entity.

For the case of initial transmission, and for the purpose of BSR, the PDCP entity does not consider the PDCP Data PDUs that have been submitted to the lower layers, but discarded thereafter. However, the MAC entity determines the amount of UL data available for a logical channel according to the data volume calculation procedure in [TS38323]. To account for discarded PDUs/SDUs, the Tx PDCP entity can also consider the following as PDCP data volume: the PDCP SDUs or PDCP Data PDUs for which discard operation is performed. Table 1.2.2.1-1 shows an example clause that can be added to the data volume calculation procedure in 3GPP TS 38.323 (“[TS38323]”) (e.g., 3GPP TS 38.323 v17.5.0 (2023 Jun. 30), the contents of which are hereby incorporated by reference in its entirety) to determine the volume calculation of discarded data. Additionally or alternatively, it can be assumed up to implementation to calculate the discarded data volume with no need for specification update.

TABLE 1.2.2.1-1
5.6 Data volume calculation

For the purpose of MAC buffer status reporting, the transmitting PDCP
entity shall consider the following as PDCP data volume:
the PDCP SDUs for which no PDCP Data PDUs have been constructed;
the PDCP Data PDUs that have not been submitted to lower layers;
the PDCP SDUs or PDCP Data PDUs for which discard operation is
performed;
the PDCP Control PDUs;
for AM DRBs, the PDCP SDUs to be retransmitted according to clause
5.1.2 and clause 5.13;
for AM DRBs, the PDCP Data PDUs to be retransmitted according to
clause 5.5.

On one hand, it can be beneficial for the UE 1802 to report to the network about a reduction in the data volume of the UE's buffer in the event of PDU discard for UL data which was previously reported in a BSR to the network (e.g., for future scheduling, resource usage/planning). On the other hand, transmitting a BSR ever so often can also lead to power consumption at the UE 1802 and cause signaling overhead. A trade-off is required on how often such PDU discard triggered BSRs can be generated. To this end, some additional condition(s) might need to be met in connection with the discard of the data for the UE 1802.

In some implementations, a timer can be introduced, such that a BSR, once triggered in the event of PDU set discard, can only be re-triggered after the duration of discardBSR-Timer has elapsed. This can act as a prohibit timer not to send BSR due to a discard event as frequently. This prohibit time may be ignored in some specific cases. For example, if new UL data arrives to UE's 1802 buffers, the UE 1802 could report BSR even when this prohibit timer is running. For this example, the prohibit timer is mainly restricting the reporting of the extra information associated with eh discard timer. This concept of prohibit timer could equally be applicable to the delay reporting or remaining time reporting that is discussed in next section.

Additionally or alternatively, in the event of PDU-set discard, the initial discard update BSR is only triggered if the volume of discarded data is more than certain threshold, ul-DiscardVolumeThreshold. Alternatively, this threshold of the amount of data discarded could be defined as a relative information, for example, relative to the data that was stored in the buffer. Assuming that the UE's buffer's have X amount of data at any given time (where X is a number), network may configure the UE 1802 to report the updated BSR when discarded data is more than a predefined or configured amount, threshold, and/or percentage (e.g., 40%) of the amount of data stored in the buffer from last reported BSR. Example changes to [TS38331] for such purposes are shown by tables 1.2.2.1-2, 1.2.2.1-3, 1.2.2.1-X, 1.2.2.1-y.

TABLE 1.2.2.1-2
BSR-Config IE

| BSR-Config ::= | SEQUENCE { | |
|---|---|---|
| periodicBSR-Timer | ENUMERATED | { sf1, sf5, sf10, sf16, sf20, sf32, sf40, |
| | | sf64, sf80, sf128, sf160, sf320, sf640, |
| | | sf1280, sf2560, infinity }, |
| retxBSR-Timer | ENUMERATED | { sf10, sf20, sf40, sf80, sf160, sf320, sf640, |
| | | sf1280, sf2560, sf5120, sf10240, spare5, |
| | | spare4, spare3, spare2, spare1}, |
| logicalChannelSR-DelayTimer | ENUMERATED | { sf20, sf40, sf64, sf128, sf512, sf1024, |
| | | sf2560, spare1} OPTIONAL, -- Need R |
| . . . | | |
| discardBSR-Timer | ENUMERATED | { sf1, sf5, sf10, sf20, sf40, sf80, sf160, |

sf320, sf640, sf1280, sf2560, sf5120, sf10240,
spare5, spare4, spare3, spare2, spare1} OPTIONAL,

}
-- TAG-BSR-CONFIG-STOP
-- ASN1STOP

TABLE 1.2.2.1-3
BSR-Config field descriptions

discardBSR-Timer
Value in number of subframes. Value sf1 corresponds to 1 subframe,
value sf5 corresponds to 5 subframes and so on.
logicalChannelSR-Delay Timer
Value in number of subframes. Value sf20 corresponds to 20 subframes,
sf40 corresponds to 40 subframes, and so on.
periodicBSR-Timer
Value in number of subframes. Value sf1 corresponds to 1 subframe, value
sf5 corresponds to 5 subframes and so on.
retxBSR-Timer
Value in number of subframes. Value sf10 corresponds to 10 subframes,
value sf20 corresponds to 20 subframes and so on.

TABLE 1.2.2.1-4
UL-DiscardVolumeThreshold parameters

PDCP-Config ::= <omitted>

| | |
|---|---|
| UL-DiscardVolumeThreshold ::= ENUMERATED | {b0, b100, b200, b400, b800, b1600, b3200, |
| | b6400, b12800, b25600, b51200, b102400, |
| | b204800, b409600, b819200, b1228800, |
| | b1638400, b2457600, b3276800, b4096000, |
| | b4915200, b5734400, b6553600, infinity, |
| | spare8, spare7, spare6, spare5, spare4, |
| | spare3, spare2, spare1} |

TABLE 1.2.2.1-5
UL-DiscardVolumeThreshold field description

ul-DiscardVolume Threshold
Parameter specified in [TS38321] to indicate the minimum amount of
discarded data volume to trigger a BSR update. Value b0 corresponds to
0 bytes, value b100 corresponds to 100 kbytes, value b200 corresponds
to 200 kbytes, and so on. The network sets this field to infinity for UEs
not performing PDU discard operation. If the field is absent when the
radio bearer is configured, then the default value infinity is applied.

Example changes to [TS38321] clause 5.4.5 are shown by table 1.2.2.1-6.

TABLE 1.2.2.1-6
PDCP-Config field descriptions

A BSR shall be triggered if any of the following events occur for activated
cell group:
UL data, for a logical channel which belongs to an LCG, becomes
available to the MAC entity; and either
<omitted text>
retxBSR-Timer expires, and at least one of the logical channels which
belong to an LCG contains UL data, in which case the BSR is referred
below to as ‘Regular BSR’;
periodicBSR-Timer expires, in which case the BSR is referred below to
as ‘Periodic BSR’.
discardBSR-Timer expires, and total amount of discarded PDCP data
volume and discarded RLC data volume pending for (re)transmission is
equal to or larger than ul-DiscardVolumeThreshold, in which case the
BSR is referred below to as ‘Discard BSR’

### 1.2.2.2. BSR Enhancements for Delay Reporting

As discussed in section 1.1 supra, latency information for delay critical data such as the remaining time in the delay budget expiration of the PDU or PDU set could be conveyed using the BSR. This information can be helpful in some scenarios for example if a PDU set is transmitted over multiple bursts, such that after one burst transmission, part of the PDU set remains in the UL buffer. In such a case, RAN node 1814 may benefit from information, such as the remaining time before expiration of configured max_delay value, or the PDB or PSDB for a PDU or PDU set, respectively.

### 1.2.2.3. New Mac CE and BSR Mapping Tables for Delay Value Reporting

A new BSR MAC CE with delay index reporting per LCG along with data volume reporting could be used for the case when the delay value is reported for some or all LCGs in the BSR. FIG. 6 shows an example BSR MAC CE 600 with Remaining Time Information reported for some or all LCGs. The BSR MAC CE 600 includes LCG fields and buffer size fields, which may be the same or similar as discussed previously w.r.t FIGS. 2-5. The BSR MAC CE 600 also includes a delay value field that may carry a delay index for some or all LCGs. For example, an individual delay value fieldₘ may correspond to an LCG (e.g., an LCDᵢ field), and the delay index carried in the delay value fieldₘ maps to a delay value for the correspond LCG.

Additionally or alternatively, an LCG-ext parameter can be defined for each LCG (see e.g., FIG. 5 discussed previously). Then, LCG-ext is individually set to 1 for only those LCGs for which a delay value is reported (see e.g., FIG. 5 discussed previously). In these examples, the LCG-ext fields can be included in the MAC CE 600.

Similar to BSR mapping tables for data volume reporting, BSR mapping tables for delay value reporting can be defined (e.g., delay budget reporting tables, and/or the like). A new static delay information mapping table, with delay values between 5-200 ms can be created with fixed step size (e.g., 5 ms or the like) in the example shown by Table 1.2.2.3-1.

TABLE 1.2.2.3-1
Delay budget values (in ms) for 5-bit Delay Budget field

| Delay Index | Delay value (ms) |
|---|---|
| 0 | ≤5 |
| 1 | ≤10 |
| 2 | ≤15 |
| 3 | ≤20 |
| 4 | ≤25 |
| 5 | ≤30 |
| 6 | ≤35 |
| 7 | ≤40 |
| 8 | ≤45 |
| 9 | ≤50 |
| 10 | ≤55 |
| 11 | ≤60 |
| 12 | ≤65 |
| 13 | ≤70 |
| 14 | ≤75 |
| 15 | ≤80 |
| 16 | ≤85 |
| 17 | ≤90 |
| 18 | ≤95 |
| 19 | ≤100 |
| 20 | ≤105 |
| 21 | ≤110 |
| 22 | ≤115 |
| 23 | ≤120 |
| 24 | ≤125 |
| 25 | ≤130 |
| 26 | ≤135 |
| 27 | ≤140 |
| 28 | ≤145 |
| 29 | ≤150 |
| 30 | ≤155 |
| 31 | Reserved |

However, the delay value table could have a larger variation in acceptable delay values among different XR applications (e.g., a step size larger than 5 ms) or have a finer granularity of delay reporting (e.g., a step size smaller than 5 ms). Additionally or alternatively, multiple delay value tables can be used, wherein a UE 1802 (or XR application) can be configured to use a specified delay budget mapping table based on, for example, XR traffic characteristics and/or other parameters, criteria, or conditions. Additionally or alternatively, delay tables can also be dynamically generated, which could allow variable step size(s) and/or can be configurable based on specific requirements of XR traffic (e.g., a minimum and maximum remaining delay value configured by the RAN node 1814), XR traffic characteristics, and/or other parameters, criteria, or conditions. For dynamic generation of delay value tables or tables that are even configured in a semi-static manner, the corresponding configuration could be provided by RAN node 1814 per MAC entity (e.g., rather than per LCG).

### 1.2.2.4. Trigger Condition for Delay Reporting

For delay critical applications, if static or semi-static delay value mapping tables are created, and if delay values are communicated using the BSR, it may also be needed to introduce a new trigger for remaining delay. For data in the UL buffer, the UE 1802 can determine the remaining time before expiration of preconfigured timer based on the maximum delay tolerable by a PDU set (based on PDB value, or a configured max_delay parameter). At a given time, there could be multiple PDU sets residing in the UL buffer, and each PDU set may have its own PSDB (or PDB) value. The RAN node 1814 may not have a guaranteed way of keeping track of all PDU-sets that the UE 1802 has started transmitting, and whether the remaining budget for data stored in the UL buffer is limited/expiring. If a new trigger condition for reporting delay value is defined, it also needs to be considered that a delay reporting BSR is not triggered ever so often. While a straightforward way could be that the delay report is triggered if the remaining time for any given PDU set falls below a certain threshold criterion.

A second triggering condition could be based on considering the PDU Set Importance parameter or the priority of the data stored in the UL buffer. If multiple PDU sets with high priority or importance are to expire soon, then a delay report could be triggered to facilitate prioritized scheduling of such PDU sets. This condition could be based on the number of PDU sets, or on the volume of data with low remaining time. An example of spec update is shown as follows. Example changes to [TS38321] clause 5.4.5 are shown by table 1.2.2.4-1.

TABLE 1.2.2.4-1
A BSR shall be triggered if any of the following events occur for activated
cell group:
UL data, for a logical channel which belongs to an LCG, becomes
available to the MAC entity; and either
<omitted text>
If remaining time before expiration or loss of N number of PDU sets with
PDU Set Importance parameter value as high is below
PriorityDataDelayThreshold
If remaining time before expiration or loss of data volume
maxExpiredVolume is below ExpirationThreshold

An alternative approach is to not define new triggering condition. The RAN node 1814 could configure a delayReport parameter for delay critical applications. This configuration could be per DRB, per logical channel or per MAC entity. Then, if delayReport is supported and enabled, the UE 1802 reports the average or worst delay value per LCG and the associated data volume using mechanism similar to Regular or periodic BSR reporting, and a new trigger condition for delay reporting is not defined. A new MAC CE can be used to report the delay values (e.g., using MAC CE 600 of FIG. 6 and/or any other MAC CE discussed herein).

Any of the approaches discussed herein may be used in conjunction with each other (e.g., the may be combined in any suitable manner). Moreover, it is possible that when existing regular or periodic BSR reporting, UE 1802 decides whether to add the new/extra XR-specific information (e.g., related to packet discard or to the delay or remaining time left in buffer) only when specific condition is also met (e.g., when certain configurable threshold is met).

### 1.2.3. SFN Wraparound and HSFN Boundary Ambiguity Issues

### 1.2.3.1. Connected Mode DRX (CDRX) Operation Aspects

In [TS38321], the drx-onDurationTimer is or contains the duration at the beginning of a DRX cycle, and is started for both short and long DRX cycles after drx-SlotOffset from the beginning of the subframe as shown by table 1.2.3.1-1.

TABLE 1.2.3.1-1
When DRX is configured, the MAC entity shall:
[...]

| 1> | if the Short DRX cycle is used for a DRX group, and [(SFN × | |
|---|---|---|
| | 10) + subframe number] modulo (drx-ShortCycle) = | |
| | (drx-StartOffset) modulo (drx-ShortCycle): | |
| | 2> | start drx-onDurationTimer for this DRX group after |
| | | drx-SlotOffset from the beginning of the subframe. |
| 1> | if the Long DRX cycle is used for a DRX group, and [(SFN × | |
| | 10) + subframe number] modulo (drx-LongCycle) = | |
| | drx-StartOffset : | |
| | 2> | if DCP monitoring is configured for the active DL |
| | | BWP as specified in TS 38.213 [6], clause 10.3: |

| | |
|---|---|
| 3> | if DCP indication associated with the current |
| | DRX cycle received from lower layer |
| | indicated to start drx-onDurationTimer, as |
| | specified in TS 38.213 [6]; or |
| 3> | if all DCP occasion(s) in time domain, as |
| | specified in TS 38.213 [6], associated with |
| | the current DRX cycle occurred in Active Time |
| | considering grants/assignments/DRX |
| | Command MAC CE/Long DRX Command |
| | MAC CE received and Scheduling Request |
| | sent until 4 ms prior to start of the last DCP |
| | occasion, or during a measurement gap, or |
| | when the MAC entity monitors for a PDCCH |
| | transmission on the search space indicated by |
| | recoverySearchSpaceId of the SpCell |
| | identified by the C-RNTI while the |
| | ra-ResponseWindow is running (as specified |
| | in clause 5.1.4); or |
| 3> | if ps-Wakeup is configured with value true |
| | and DCP indication associated with the |
| | current DRX cycle has not been received |
| | from lower layers: |

| | |
|---|---|
| 4> | start drx-onDurationTimer after |
| | drx-SlotOffset from the beginning |
| | of the subframe. |

| | |
|---|---|
| 2> | else: |

| | |
|---|---|
| 3> | start drx-onDurationTimer for this DRX |
| | group after drx-SlotOffset from the beginning |
| | of the subframe. |

NOTE 2:
In case of unaligned SFN across carriers in a cell group, the SFN of the SpCell is used to calculate the DRX duration.

Here, the [(SFN×10)+subframe number] is to determine the offset in time domain, where the longest time span for timing synchronization for connected mode DRX (cDRX) without resetting to 0 is 10.24 seconds based on the definitions of SFN and subframe (e.g., SFN ∈[0,1023] ms and subframe ∈[0,9]).

One issue that may arise is traffic misalignment after SFN wraparound. As alluded to previously, cDRX uses the following formulas to determine the subframe to start drx-onDuration Timer: [(SFN×10)+subframe number] modulo (drx-ShortCycle)=(drx-StartOffset) modulo (drx-ShortCycle) and [(SFN×10)+subframe number] modulo (drx-LongCycle)=drx-StartOffset. The SFN range is 0 to 1023 and the subframe number range is 0 to 9, and therefore, the parameter [(SFN×10)+subframe number] has a range 0 to 10239 and then repeats these values every time SFN=0 again. In other words, the SFN wraps-around every 10240 milliseconds (ins). Consequently, the SFN wraparound issue may arise if the (c) DRX cycle length is not a factor of 10240 ms because an incorrect start of the (c) DRX cycle will be calculated every time the SFN value wraps around, and this incorrect start time then propagates this offset to the next cycles.

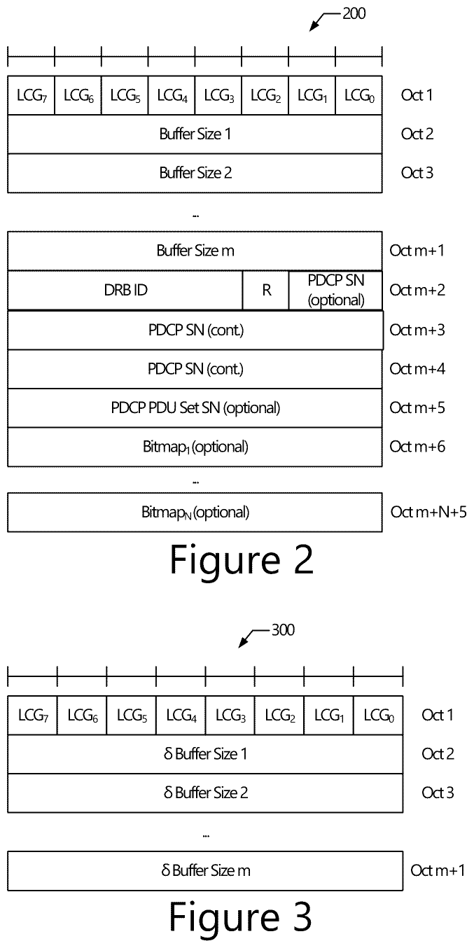

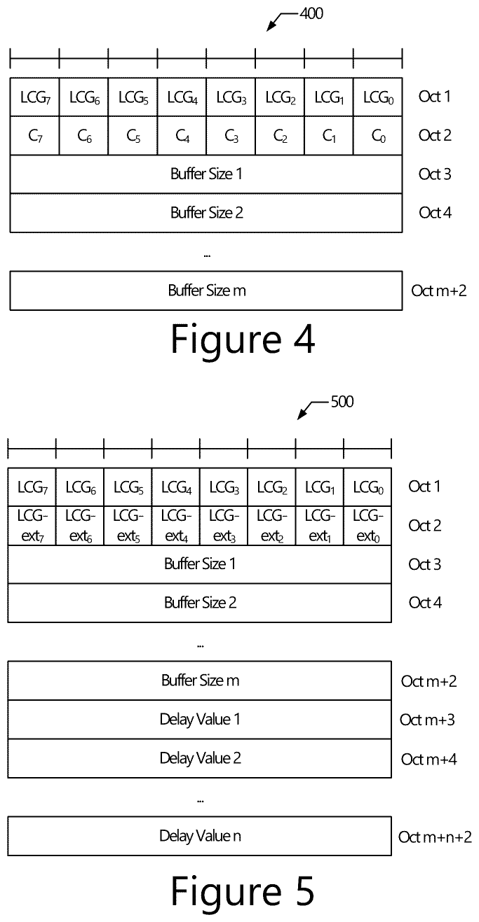

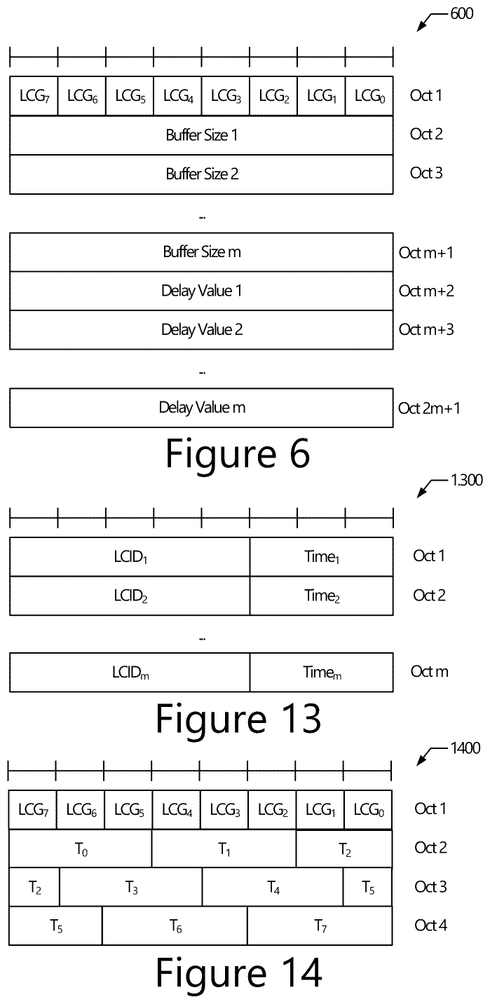

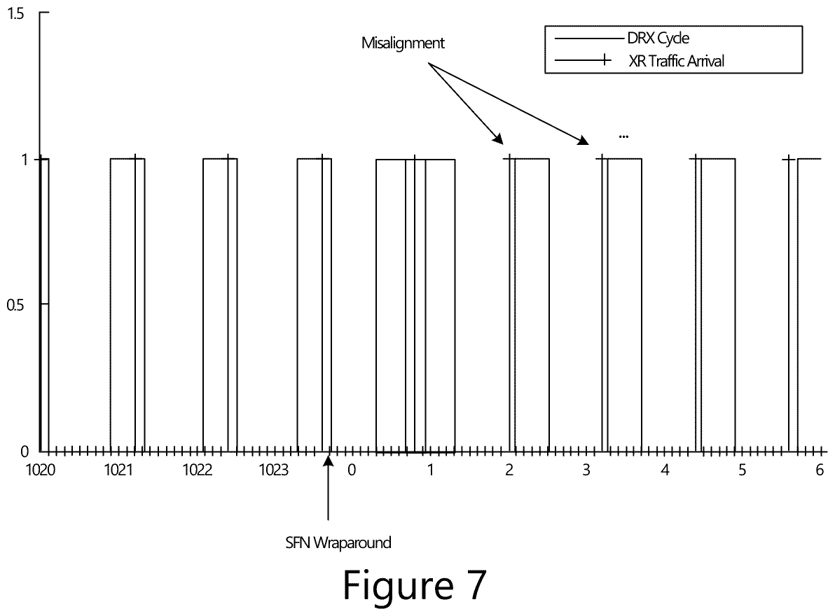

When cDRX cycle is not a divisor of 10.24 seconds (e.g., assuming that cDRX cycle were to match the non-integer prioridicty of the XR traffic), the SFN wraps around after every 10.24 seconds, which leads to a mismatch between the traffic arrival time and the on-duration of the DRX. FIG. 7 shows an example of mismatch between the traffic arrival time and the on duration of the DRX. To solve this issue, the time offset of the ON duration is changed in every hyper SFN (HSFN) (e.g., every 10.24 seconds) in order to match the XR traffic pattern.

While this issue is not specific or exclusive to XR traffic and occurs for any Rel-15/Rel-16 DRX cycle length that is not a factor of 10240 ms, it is expected that this SFN wrap-around issue can negatively affect XR traffic more severely than other types of traffic because (i) the length of the XR service duration is expected to be in the order of (dozens of) minutes, so the SFN will wrap around multiple times during the XR service, and (ii) XR service has a tight PDB and SFN wrap-around may take a few milliseconds each time it occurs, since the (c) DRX cycle and traffic arrival pattern are misaligned, which results in additional latency and increased UE power consumption since the UE 1802 is in DRX active time when traffic is not expected.

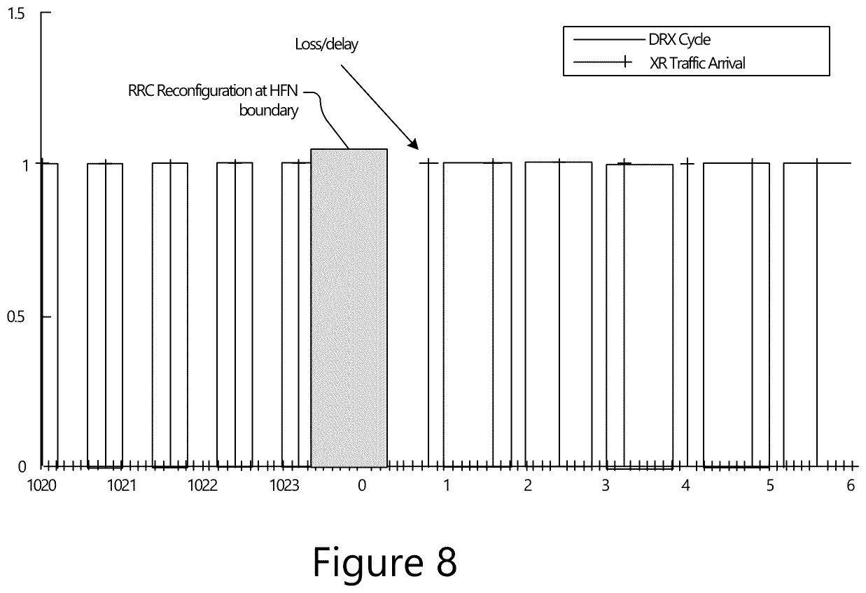

Another issue that may arise is HSFN boundary ambiguity, which is an inter-related issue to the SFN wraparound issue. The HSFN boundary ambiguity may arise when the NW (e.g., RAN node 1814 or the like) sends an RRC configuration for cDRX at the boundary of the HSFN. The UE 1802 may receive a DRX configuration in a next hyper-frame resulting in a mismatch between the UE 1802 and the NW regarding the timing of the cDRX ON duration. FIG. 8 shows an example of the HSFN boundary ambiguity issue.

### 1.2.3.2. Previously Proposed Solutions

In the last few RAN2 meetings, multiple companies have proposed three solution directions for the SFN wraparound issue.

A first proposed solution (Solution A) includes a cDRX-specific modification period. Solution A involves updating the DRX formula to avoid an SFN wraparound to occur during the length of the XR service duration, which could be in the order of tens of minutes. The understanding is that SFN will wrap around multiple times during an XR service, and for delay stringent XR applications, occurrence of SFN wraparound may cause a delay of several milliseconds which is undesirable under tight PDB requirements. This solution direction (A) uses similar concept to the modification period in extended DRX (eDRX) (see e.g., [TS38331]) defined by SFN values for which (HSFN*1024+SFN) mod m=0, and m is the number of radio frames comprising the modification period. For this solution direction A, a new C-DRX specific modification period/boundaries is defined to reset of the timing synchronization for the C-DRX.

A second proposed solution (Solution B) includes an offset adjustment using RRC pre-configured pattern or dynamic signaling. Solution B involves an RRC pre-configured pattern and dynamic adjustment for XR traffic alignment due to SFN wraparound, or to have L1/L2 signalling to adjust the offset value before or immediately after SFN wraparound.

Both solutions A and B are focused on the resolution of SFN wraparround issue (e.g., misalignment with XR traffic arrival at SFN wraparound), but these solutions do not consider the HSFN boundary ambiguity issue wherein the timing of cDRX ON duration which arises from the UE 1802 receiving RRC configuration for C-DRX at HSFN boundary.

For solution A, the new cDRX modification period is mainly used for reset of the cDRX (e.g., independent to legacy BCCH modification period/operation). For solution B, which relies on RRC reconfiguration, it may come into interruptions (e.g., of several milliseconds) whenever there is an RRC reconfiguration which could potentially cause delayed or lost data, both of which are undesirable for XR traffic with high reliability and low latency requirements.

A third proposed solution (Solution C) includes using a Rel-16 industrial internet of things (IIoT) solution for type 1 configured grant (CG). Solution C involves using an approach similar to Rel-16 IIoT where after receiving a configuration, the UE 1802 identifies the lowest N value corresponding to the nearest available CG occasion, and N is incremented after each CG occasion starting from the N identified in the first step. In this regard, the formulas of equations 1.2.3.2-1 and 1.2.3.2-2 have been proposed in RAN2 to change the trigger of the ON duration start.

[(SFN×10)+subframe number]=(drx-timeReferenceSFN×10+drx-StartOffset+N×drx-ShortCycle)modulo(10240) (1.2.3.2-1)

[(SFN×10)+subframe number]=(drx-timeReferenceSFN×10+drx-StartOffset+N×drx-LongCycle)modulo(10240) (1.2.3.2-2)

In equations 1.2.3.2-1 and 1.2.3.2-2 of solution C, the idea for N is similar to Type 1 CG in IIoT Rel-16, that is, it represents the Nth cDRX short and long cycle, respectively. For cDRX cycle as non-integer divisor of 10.24 seconds, the lowest N value corresponding to the nearest cDRX cycle is used.

A new solution that addresses both issue 1 and issue 2 is provided infra.

### 1.2.3.3. Solution to Issues SFN Wraparound and HSFN Boundary Ambiguity

To resolve the SFN wraparound issue, the constant N is used as shown by equation 1.2.3.3-1, where N is updated by 1 at each SFN wrap-around. This is similar to the use of HSFN in modification period in eDRX and as proposed in solution A. The new equations explained herein are used instead than legacy conditions defined in [TS38321] to trigger the start of the DRX ON duration for short cDRX cycle or long cDRX cycle when applicable (e.g., when using cDRX periodicities with non-integer values or when configured by the network). In this case, the value of N will be reset to 0 either via RRC signaling from the network, or based on some new parameter defined of max-N which is configured by the network. The reset of N could also be related to some fixed value, for example, the HSFN max length but this reset condition will also be configured by the network.

[([SFN+N×1024]×10)+subframe number]modulo(drx-ShortCycle)=(drx-StartOffset+drxReferenceSFN×10)modulo(drx-ShortCycle) (1.2.3.3-1)

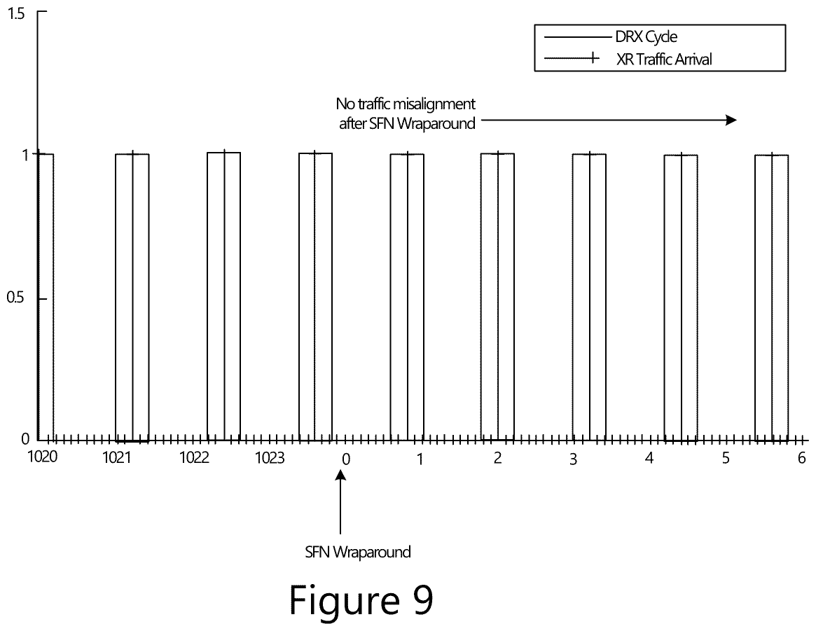

Using the “[SFN+N×1024]” and “drxReferenceSFN×10” in equation 1.2.3.3-1, the timing synchronization for cDRX is maintained, such that at an SFN wraparound event, the DRX reference time reset to 0 is offset by 10240 ms. This repeats at every SFN wraparound event during the traffic duration, thereby avoiding misalignment, as shown by FIG. 9. The time for which the timing synchronization is postponed depends on the value of N in equation 1.2.3.3-1.FIG. 9 shows an example where no traffic misalignment takes place after SFN wraparound, which is based on using the updated cDRX formula (e.g., equation 1.2.3.3-1).

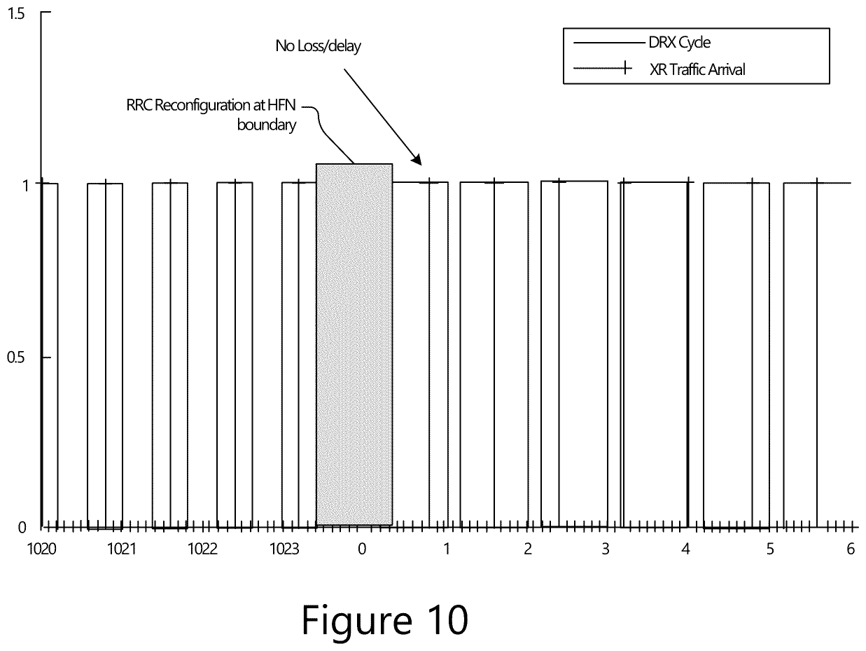

For the HSFN boundary ambiguity issue, for cDRX and XR traffic arrival time is similar to the related issues discussed for Type 1 configured grants in Rel-16 IIoT. In Rel-16 IIoT, a new timeReferenceSFN field was introduced in RRC, where an RRC message uses the nearest SFN boundary based on the timeReferenceSFN. In various implementations, similarly for cDRX, an drxReferenceSFN is introduced in RRC, which is a reference SFN used for determination of the offset of a resource in the time domain. The UE 1802 uses the closest SFN with the indicated number preceding the reception of the DRX configuration. This is shown as the addition of the term drxReferenceSFN×10 in equation 1.2.3.3-1. FIG. 10 shows an example of how a cDRX configuration is updated after receiving an RRC reconfiguration at the HSFN boundary using the updated DRX formula without incurring loss/delay due to the HSFN boundary ambiguity issue.

As explained in more detail infra, a similar change could also be applied for long Cycle as it is shown by equation 1.2.3.3-2.

[([SFN+N×1024]×10)+subframe number]modulo(drx-LongCycle)=(drx-StartOffset+drxReferenceSFN×10)modulo(drx-LongCycle) (1.2.3.3-2)

An example update to [TS38321] is shown by table 1.2.3.3-1.

TABLE 1.2.3.3-1
When DRX is configured, the MAC entity shall :
[...]

| 1> | if the Short DRX cycle is used for a DRX group, and [([SFN + | |
|---|---|---|
| | N × 1024] × 10) + subframe number] modulo (drx-ShortCycle) = | |
| | (drx-StartOffset+ drxReferenceSFN x 10) modulo (drx- | |
| | ShortCycle): | |
| | 2> | start drx-onDurationTimer for this DRX group after |
| | | drx-SlotOffset from the beginning of the subframe. |

| | |
|---|---|
| 1> | if the Long DRX cycle is used for a DRX group, and [([SFN + |
| | N × 1024] × 10) + subframe number] modulo (drx-LongCycle) = |
| | (drx-StartOffset + drxReferenceSFN x 10) modulo (drx- |
| | LongCycle): |
| | [...] |

### 1.3. [AF2971] Discard Operations for XR Traffic Under Network Congestion

As alluded to previously, “critical” or high importance packet groups/PDU sets may require special treatment/prioritization specially in the case of network congestion. A solution needs to be developed to make the process of packet discarding and resource allocation more streamlined, for example, to solve/minimize the issue when UE 1802 transmits low importance PDU sets while high importance PDU sets remain queued and may eventually be lost due to delay-budget expiration in the face of network congestion and lack of UL resources.

The present disclosure provides techniques and technologies for UEs 1802 to identify network critical situations (e.g., congestion). This can be useful when differentiated handling of XR traffic in UE 1802 side is preferable (e.g., as part of the discard operation, to prioritize some PDU sets over others, and/or the like). In various implementations, the discard operation for XR traffic is triggered in network critical situations/scenarios (e.g., network congestion), which is based on an indication of a network critical situation/scenario (e.g., network congestion). This indication may be an explicit indication and/or an implicit indication from the RAN node 1814 to the UE 1802. Relevant discard procedures are also discussed infra.

The embodiments discussed herein avoid unnecessary transmission of PDUs over the air interface, such as in scenarios with network congestion by discarding data with low importance to prioritize transmission of data with high importance. The discard operation in the face of network congestion could lead to capacity improvements and enhance user experience by prioritizing data more urgently/earnestly needed by the decoding Rx.

### 1.3.1. XR Traffic-Related Objectives

In the Rel-18 WID document RP-230786, titled “Updated WID on XR Enhancements for NR” (NR_XR_enh) specifies the enhancements identified in the study item “Study on XR Evaluations for NR”. The objectives of RP-230786 include specifying the enhancements related to capacity, which include multiple configured grant (CG) PUSCH transmission occasions in a period of a single CG PUSCH configuration (RAN1, RAN2); dynamic indication of unused CG PUSCH occasion(s) based on UL control information (UCI) by the UE (RAN1, RAN2); BSR enhancements including at least new buffer status table(s) (RAN2); delay reporting of buffered data in uplink (RAN2); and discard operation of PDU sets for DL and UL (RAN2, RAN3).

The following relevant agreements have been made in related topic so far in RAN2 WG: RAN2 #119bis: For UE Tx, PDCP discard should be performed per PDU set basis; for UE Tx, PDCP discard is managed per SDU for PDU set, the PDCP entity discards all PDCP SDUs associated with the PDU set; keep discard description at XR awareness (we assume it may impact both capacity and power saving). Can re-consider based on SI progress; and how to handle overlaps between XR awareness and capacity/power saving enhancements are for future discussion. RAN2 #120: RAN2 to support timer-based discarding of UL transmit side of PDCP PDU/SDUs of a PDU set; for future study (FFS) on how this is modelled in PDCP specification, can be discussed in WI phase. RAN2 #121: RAN2 thinks PSI can be useful for PDU set-based discard. RAN2 aims to introduce a mechanism to allow UE to handle discarding of packets with different PSI in case of congestion; FFS for other cases.

[TS23501] provides QoS parameters and user plane enhancements for PDU set QoS handling and/or for the 5G QoS model. The 5G QoS model is based on QoS flows. The QoS flow is the finest granularity of QoS differentiation in a PDU session. A QoS flow ID (QFI) is used to identify a QoS flow in the 5GS 1800. User Plane traffic with the same QFI within a PDU session receives the same traffic forwarding treatment (e.g., scheduling, admission threshold, admission control, and/or the like). The QFI is carried in an encapsulation header on N3 (and N9) i.e. without any changes to the e2e packet header. QFI shall be used for all PDU Session Types. The QFI shall be unique within a PDU Session. The QFI may be dynamically assigned or may be equal to the 5QI (see clause 5.7.2.1). Additional aspects of the QoS model are discussed in clause 5.7 of [TS23501]. The PDU set QoS parameters are discussed in section 1.4, infra.

For the case of XR traffic, PDU sets may carry different kind of content (e.g., I/B/P frames, or slices/tiles within an I/B/P frame etc.). RAN1 Rel-17 3GPP TR 38.838 describes how video traffic may be modeled using I and P frames, an example is shown by FIG. 11.

FIG. 11 shows an example of intra-coded picture frames (I-frames) and predicted picture frames (P frames) in XR traffic. In this example, a video frame (Fi) is divided into N packets (or slices), where i and N are numbers.

An XR application may require correct decoding of the I-frame to enable the decoding of sub-sequent P-frames, but it may be able to sustain loss of some P or B frames. Under user plane enhancements for XR, SA2 has introduced the parameter of PDU Set Importance (PSI). This parameter identifies the importance of a PDU set within a QoS flow. The understanding in SA2 is that RAN may use this parameter for PDU set level packet discarding in the presence of congestion.

In network congestion scenarios, the UE 1802 may have in its transmission buffer both high and low importance PDU sets. If the UE 1802 does not prioritize high importance PDU sets (e.g., by discarding low importance PDU sets), it may end up transmitting low importance PDU sets instead of high importance PDU sets. Then, for PDU sets for which PSI is high, they may be queued for a long time eventually causing their delay budget to expire and consequently lost. In this case, the Rx which may not be able to even decode subsequent low importance PDU sets also due to the loss of such high importance PDU sets.

### 1.3.2. XR Traffic with Network Congestion Aspects

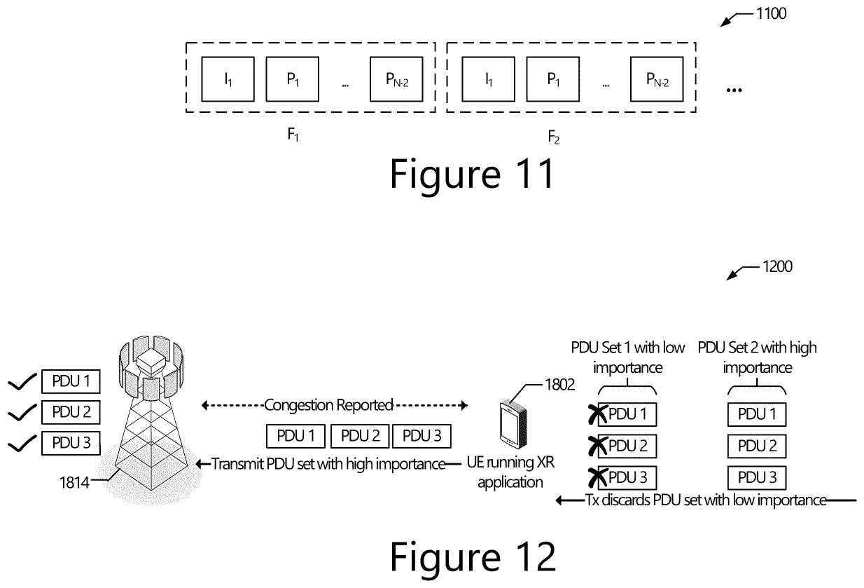

FIG. 12 shows an example arrangement 1200 where PDU discard takes place under network congestion. In the case of network congestion, the UE 1802 Tx could discard PDU sets based on a type of the PDU set. For example the UE 1802 can discard PDU sets identified or determined to be classified as including lower priority/importance PDUs, and to prioritize more important PDU sets (e.g., those corresponding to I-frame(s)).

If the NW is under congestion and is unable to allocate sufficient resources to the UE 1802, the Tx (e.g., the UE 1802) could prioritize high importance PDU sets and discard low importance (lower priority) PDU sets. In the DL, such PDU discard can be up to RAN node implementation. For UL transmission, if the NW is under congestion and is unable to allocate sufficient resources to the UE 1802, the UE 1802 should be able to prioritize high importance PDU sets and discard some or all of the packets of a low-importance/priority PDU set based on, for example, identifying or determining the PDU set's importance. The identification of a PDU set's importance may be based on PSIHI value(s), PSI value(s), and/or associated QoS parameter(s) and/or any other PDU set parameter(s)/value(s). Additionally, a PDU set's importance can be based on a predefined or configured threshold (e.g., PDU sets below an importance value are deemed “not important” and PDU sets above the importance value are deemed “important” or high priority), or can be based on a relative importance value (e.g., a PDU set with a highest importance value is not discarded and/or a PDU set with a lowest importance value, in comparison with the importance values of other PDU set, is discarded).

The mechanism for the UE 1802 to perform such congestion-based discard can depend on how the UE 1802 becomes aware of network congestion and/or how the UE 1802 is made aware of network congestion (e.g., with a congestion indication or the like). Two example approaches to indicate network congestion are described infra. Note that the provided mechanism could potentially be generalized in future releases. In Rel-18, the aspects discussed herein are described with reference to network congestion and discard operation, however, the use of these solutions could be extended by the network to other enhancements/scenarios.

### 1.3.2.1. Implicit Indication of Network Congestion

A first approach includes an implicit indication of congestion. The implicit indication can be based on how long the packets are buffered for at the UE 1802. In legacy approaches, if the UE 1802 relies on existing PDCP discard mechanisms, then essentially it does not consider the provided PSI parameter. Consequently, in congestion scenarios, the delay budget for high importance PDU sets may expire rendering them as lost, while low importance PDU sets may be transmitted instead.

### 1.3.2.1.1. Congestion Indication Timer

In some implementations, a new congestion indication timer can be defined and used as a proactive approach for discard in the face of congestion. In these implementations, the new congestion indication timer (congestionTimer) is used to monitor and/or indicate network congestion. The congestionTimer keeps track of the queued/buffered time of PDU sets (e.g., the amount of time a PDU set is stored or sits in the Tx-side buffer). The congestionTimer can be started along with the discardTimer of the first arriving PDU, or simultaneously with the discardTimerPerSet of the first arriving PDU-set in the UL buffer (e.g., after the buffer is empty). Additionally or alternatively, the congestionTimer could be started if a certain number of PDUs/PDU sets are lost and/or unsuccessful in UL transmission(s).

Additionally or alternatively, the congestionTimer could be started on a per-PDU set basis, upon arrival of the first PDU of a PDU set in the UL buffer. Here, discardTimerPerSet is a configurable parameter that is introduced to enable discard at PDU set level using this single per-PDU-set discard timer. In some examples, there may be multiple instances of the congestion Timer, where each congestionTimer instance corresponds with a PDU set that is stored in the buffer.

Upon expiration of the timer, network congestion is declared by the Tx (e.g., UE 1802 or RAN node 1814). If the congestionTimer expires, the UE 1802 could discard the low (or lowest) importance PDU set(s) even if a maximum delay constraint timer (discardTimerPerSet or discardTimer) has not expired for that PDU set. In this case the shorter/stringent congestionTimer may supersede the discardTimer per PDU, or discardTimerPerSet per PDU-set for triggering the discard operation of low importance PDU sets.

### 1.3.2.1.2. Congestion Indication Buffer Threshold

In some implementations, a congestion indication buffer threshold (threshold) can be used to indicate network congestion. The threshold may be defined for the data volume in the UL buffer. Here, if the queue/buffer for buffered data at the UE 1802 builds up beyond the threshold, the UE 1802 discards the low (or lowest) importance PDU set(s). In some examples, the buffer size calculation is the same or similar to the data volume calculation discussed herein (see e.g., table 1.2.2.1-1, supra) and/or as discussed in [TS38323].

The threshold can be a predefined or configurable value, percentage, and/or other parameter or condition. In a first example, the threshold is expressed as an amount (e.g., a number bits or bytes) of occupied space (e.g., a buffer size limit) or an amount of unoccupied space (e.g., buffer free space) in the UL buffer. In a second example, the threshold is expressed as a percentage of the buffer size/capacity (e.g., X % of the buffer size being occupied or unoccupied). Additionally or alternatively, multiple thresholds can be defined, wherein a least important PDU set is discarded when a first threshold is exceeded, the two least important PDU sets are discarded when a second threshold is exceeded, and so forth. In this example, the first threshold may be greater than or less than a second threshold.

Additionally or alternatively, the threshold(s) can be used in conjunction with other conditions, such as signal measurement thresholds/values and/or any of the other mechanisms discussed herein. In some examples, the congestionTimer and the threshold can work separately or in combination. One drawback of using such an approach is that low importance PDU sets may be discarded even if there is little or no congestion (e.g., when there is a temporary delay) or the buffer volume increases temporarily, which could ultimately affect (e.g., video quality) at the Rx decoder. However, some conditions or criteria can be defined to reduce the likelihood of false positives being declared, thereby reducing the likelihood of discarding PDU sets when there is little to no congestion. Additionally, in some cases, the threshold condition may not be as accurate a representation of congestion as the explicit indication discussed in section 1.3.2.2, infra, however, the congestion indication threshold may require less signaling overhead than an explicit indication.

### 1.3.2.1.3. Differentiated Handling for Different Criticality Levels

As discussed previously, the congestionTimer and the threshold can work in conjunction with one another. In some implementations, the UE 1802 can handle different levels of congestion with timer configuration and/or configured buffer threshold. In these implementations, the NW (e.g., RAN node 1814) provides information of a critical scenario (e.g., based on network congestion) that could be used by the UE 1802 to determine when to apply differentiated handling at the UE side. For example, the NW may provide a time value (or timer value) and/or trigger condition(s)/event(s) to be used as a threshold to trigger when the buffered data could be considered delayed when a critical scenario (e.g., congestion) may have occurred. Additionally or alternatively, different values (or thresholds) could be provided if different levels of criticality are differentiated (e.g., different levels of network congestion or congestion severity). Then, based on the corresponding level, the UE 1802 may take more or less aggressive decisions. If different levels of criticality (which could be related to levels of congestion or levels of robustness/reliability required) are used to determine whether the UE 1802 is to perform one or more action(s) (e.g., discard, duplication, usage of different RLC entity, prioritizing, and/or the like). Moreover, these levels can also be used to determine how often the UE 1802 should apply the differentiated handling and/or to which kind/type of packet/traffic they should be applied (e.g., any packet, packets belonging to PDU set(s) with a low PSI, packets with a remaining time left smaller than certain threshold, and/or the like). Different levels or types of discard based on different levels of PSIs can be considered in this approach.

### 1.3.2.2. Explicit Indication of Network Congestion

In some implementations, the NW (e.g., RAN node 1814) can provide an explicit indication of a critical scenario (e.g., network congestion) to the UE 1802. Here, the UE 1802 can leverage RAN-assisted discard, such that the NW can explicitly send an indication (e.g., based on congestion severity or other critical situation) to the UE 1802. Upon receiving the explicit indication from the NW, the UE 1802 can perform PDU set discard of low importance PDU(s)/PDU set(s) if it considers it to be necessary. The determination of whether to perform the PDU set discard operation can also be based on one or more implicit conditions, such as the thresholds, congestionTimer, and/or any other mechanisms and/or conditions/criteria discussed herein. Additionally or alternatively, the explicit indication can serve as a NW trigger for congestion-based discard in UL at the UE 1802 Tx. Example changes to [TS38323] for these implementations are shown by table 1.3.2.2-1.

TABLE 1.3.2.2-1
5.x Congestion based discard

When the UE receives a congestion indication from the network for an
LCID, then the UE shall discard PDCP SDUs belonging to PDU set for
which PDU Set Importance is set to low, for the time value,
NWCongestionTime, configured by the network. The UE can resume
normal operation after NWCongestionTime expiration.

The explicit indication from the RAN node 1814 could introduce some signaling overhead, however, the explicit indication could also prevent more or less than necessary PDU discard in the face of congestion, which could reduce congestion-related overhead.

The RAN-assisted congestion-based discard could be supported by system information block (SIB) (though it may be slow for XR traffic) or by RRC reconfiguration. The RAN node 1814 could also indicate congestion through L1 signaling, or send a MAC layer indication congestion or to trigger congestion based PDU set discard. Such indication could also include the length of time (based on some prediction at network side) until which the UE 1802 should assume network congestion to last and/or for UE 1802 to perform discard of low importance PDU sets as needed. This indication could be for a single or multiple LCIDs, or it could be per LCG. Example MAC CEs are shown by FIGS. 13 and 14.

FIG. 13 depicts an example MAC CE 1300 for congestion indication and/or discard trigger per logical channel ID (LCID). The MAC CE 1300 includes one or more LCIDₘ fields and one or more timeₘ fields. The LCID field identifies the logical channel instance of the corresponding MAC SDU or the type of the corresponding MAC CE or padding as described in Tables 6.2.1-1, 6.2.1-1c and 6.2.1-2 for the DL-SCH and UL-SCH respectively. There is one LCID field per MAC subheader. BSR formats are identified by MAC subheaders with LCIDs and/or extended LCIDs (eLCIDs) as specified in table 6.2.1-2 and/or table 6.2.1-2b of [TS38321] (e.g., LCID of 45, 46, 59, 60, 61, 62, or a new LCID value; and/or eLCID of codepoint-index pair of 245-309, 246-310, 247-311, 248-312, 249-313, 255-319, or some other codepoint-index pair). The size of the LCID field is 6 bits. If the LCID field is set to 34, one additional octet is present in the MAC subheader containing the eLCID field and follow the octet containing LCID field. If the LCID field is set to 33, two additional octets are present in the MAC subheader containing the eLCID field and these two additional octets follow the octet containing LCID field.

FIG. 14 depicts an example MAC CE 1400 for congestion indication or discard trigger per LCG. The MAC CE 1400 includes LCGᵢ field(s) and Tᵢ field(s)/bits. The LCGᵢ field(s) may be the same or similar as the LCGᵢ field(s) discussed previously w.r.t FIGS. 2-6.

The timeₘ fields in MAC CE 1300 and the Tᵢ field(s)/bits in the MAC CE 1400 may carry or include a time index value for a corresponding LCID or LCG. An example index table for 3-bit time values is shown by table 1.3.2.2-1.

TABLE 1.3.2.2-1
Time values (in ms) for 3-bit Time (T) field

| Index | Time value (ms) |
|---|---|
| 0 | 5 |
| 1 | ≤10 |
| 2 | ≤15 |
| 3 | ≤20 |
| 4 | ≤25 |
| 5 | ≤30 |
| 6 | ≤35 |
| 7 | ≤40 |
| 8 | ≤45 |

Additionally or alternatively, the NW can signal explicit congestion information in the headers of one or more packets/PDUs. For example, the NW could use a reserved bit of the UE's header or extend current headers when it needs to inform the UE 1802 of a current or potential congestion situation so that the UE 1802 can enable corresponding handling mechanisms (e.g., discard, duplication, usage of different RLC entity, prioritizing, and/or the like) that could help alleviate the congestion related situation.

### 1.3.2.2.1. Differentiated Handling for Different Levels of Congestion

In some implementations, the UE 1802 can handle different levels of congestion with the explicit network indication and/or for different criticality levels. Here, the NW provides information of a critical scenario to be used by the UE 1802 to trigger differentiated handling at the UE side. In some examples, the NW may be able to provide different levels of criticality (e.g., congestion severity) and based on this information, the UE 1802 can decide how much of the queued/buffered data could or should be discarded based on the level of criticality. To understand that based on the corresponding level, the UE 1802 may take more or less aggressive decisions to minimize or improve the situation in the network (e.g., reduce congestion). If different levels of criticality (which could be related to levels of congestion or levels of robustness/reliability required) could be used to determine whether the UE 1802 performs one or more action(s) (e.g., discard, duplication, usage of different RLC entity, prioritizing, and/or the like). Moreover, these levels could also be used by the UE ys02 to determine how often the UE 1802 should apply the differentiated handling mechanisms and/or for which kind of packet/traffic they should be applied (e.g., any packet, packets belonging to PDU set(s) with a low PSI, packets with a remaining time left smaller than certain threshold, and/or the like). In some examples, individual levels of criticality can be associated to a UE 1802, DRB, SRB, LCID, and/or LCG.

### 1.3.2.2.2. UE Requests (or Checks with) the Network about Potential Congestion Situation (or Information)

In some implementations, the UE 1802 can request a criticality (or congestion) indication from the network upon queue build up beyond a certain threshold, in a congestion query message conveyed in UL as a MAC CE. This could be defined as a new MAC CE or some enhancement to the BSR. The RAN node 1814 could respond with a MAC layer indication to convey requested information (e.g., on congestion), which could trigger congestion based PDU set discard. Such indication sent in response to the UE's query could also include the length of time (based on some prediction at network side) till which UE 1802 should assume network congestion to last and perform discard of low importance PDU sets as needed. An example MAC CE for congestion query is shown by FIG. 15 and an example enhanced BSR MAC CE is shown by FIG. 16. The response from RAN node 1814 to congestion query will be similar to FIG. 13 (or FIG. 15) in this case, or similar to FIG. 14 (or FIG. 16) when congestion information is requested using BSR.

FIG. 15 depicts an example MAC CE 1500 for congestion query, and FIG. 16 depicts an example MAC CE 1600 with or including enhancement(s) to BSR. The MAC CE 1500 includes LCIDₘ field(s)/bits, conₓ field/bits (where x is a number), and reserved bits (R), and the MAC CE 1600 includes buffer size field(s), LCGᵢ field(s)/bits, and conₓ field/bits. In these examples, the conₓ field/bits (where x is a number) indicates if a congestion indication is needed for a corresponding LCG. Additionally, the buffer size field(s), LCGᵢ field(s)/bits, and LCIDₘ field(s) may be the same as the buffer size field(s), LCGᵢ field(s)/bits, and LCIDₘ field(s)/bits discussed previously w.r.t FIGS. 2-6 and 13-14.

Additionally or alternatively, the UE query/request (e.g., using MAC CEs 1300/1500 and 1400/1600) could be indicated using an RRC message, such as a UE Assistance Information message, some other RRC message (see e.g., [TS38331]), and/or a new RRC message.

### 1.4. PDU Set Aspects

### 1.4.1. PDU Set QOS Parameters

PDU set QoS parameters are used to support PDU set based QoS handling in the NG-RAN 1804. At least one PDU Set QoS Parameter is sent to the NG-RAN 1804 to enable PDU Set based QoS handling. The following PDU Set QoS Parameters are specified: (1) PDU Set Delay Budget (PSDB); (2) PDU Set Error Rate (PSER); (3) PDU Set Integrated Handling Information (PSIHI).

The QoS Profile may include the PDU Set QoS Parameters described in this clause (see e.g., [TS23501] § 5.7.1.2). The PCF 1856 determines the PDU Set QoS Parameters based on information provided by the AF 1860 and/or local configuration. The PDU Set QoS parameters are sent to the SMF 1846 as part of PCC rule. The SMF 1846 sends them to NG-RAN 1804 as part of the QoS Profile. If the NG-RAN 1804 receives PDU Set QoS Parameters and supports them, it enables the PDU Set based QoS handling and applies PDU Set QoS Parameters as described herein and/or in [TS23501] § 5.7.7.

### 1.4.2. PDU Set Delay Budget (PSDB)

The PSDB defines an upper bound for the delay that a PDU Set may experience for the transfer between the UE 1802 and the N6 termination point at the UPF 1848, for example, the duration between the reception time of the first PDU (at the N6 termination point for DL or the UE 1802 for UL) and the time when all PDUs of a PDU Set have been successfully received (at the UE 1802 for DL or N6 termination point for UL). PSDB applies to the DL PDU Set received by the PDU session anchor (PSA) UPF 1848 over the N6 interface, and to the UL PDU Set sent by the UE 1802. To enable support for PSDB, a maximum inter arrival time between the first received PDU and the last received PDU of a PDU Set may need to comply with an SLA, and this maximum inter arrival time may not exceed the PSDB.

In some examples, a QoS flow is associated with only one PSDB, although in other examples, a QoS flow may be associated with more than one PSDB. The value of the PSDB is the same in UL and DL, or may be different for UL and DL. In some examples, the PSDB is an optional parameter that may be provided by the PCF 1856. The provided PSDB can be used by the NG-RAN 1804 to support the configuration of scheduling and link layer functions. When the PSDB is available, the PSDB supersedes the PDB for the given QoS flow. The AN PSDB is derived at NG-RAN 1804 by subtracting CN PDB (as described in clause 5.7.3.4 of [TS23501]) from the PSDB.

### 1.4.3. PDU Set Error Rate (PSER)

The PSER defines an upper bound for the rate of PDU Sets that have been processed by the sender of a link layer protocol (e.g., RLC in RAN of a 3GPP access) but that are not successfully delivered by the corresponding receiver to the upper layer (e.g., PDCP in RAN of a 3GPP access). Thus, the PSER defines an upper bound for a rate of non-congestion related PDU Set losses. The purpose of the PSER is to allow for appropriate link layer protocol configurations (e.g., RLC and HARQ in RAN of a 3GPP access). In some examples, a PDU Set is considered as successfully delivered only when all PDUs of a PDU Set are delivered successfully. The way in which the RAN 1804 enforces the PSER is up to RAN implementation.

In some examples, a QoS flow is associated with only one PSER, although in other examples, a QoS flow may be associated with more than one PSER. In some examples, the PSER is an optional parameter. If the PSER is available, the PSER supersedes the PER. The value of the PDU Set Error Rate is the same in UL and DL.

### 1.4.4. PDU Set Integrated Handling Information

The PDU Set Integrated Handling Information (PSIHI) indicates whether all PDUs of the PDU Set are needed for the usage of the PDU Set by the application layer in the receiver side. PSIHI is an optional parameter.

### 1.4.5. PDU Set Based Handling

A PDU Set comprises one or more PDUs carrying an application layer payload such as, for example, a video frame or video slice, XR data/traffic, and/or the like. The PDU Set based QoS handling by the NG-RAN 1804 is determined by PDU Set QoS parameters discussed herein and/or as specified in clause 5.7.7 of [TS23501], and PDU Set information as provided by the PSA UPF 1848 as discussed herein and/or as described in clause 5.37.5.2 of [TS23501].

In addition to the PDU related service information, the AF 1860 may provide PDU Set related assistance information for dynamic PCC control. One or more of the following PDU Set related assistance information may be provided to the NEF 1852 and/or PCF 1856 using the AF session with required QoS procedures (see e.g., clauses 4.15.6.6 and 4.15.6.6a of [TS23501]): PDU Set QoS parameters as described in clause 5.7.7 of [TS23501] and/or a protocol description. The protocol description indicates protocol and payload type used by a service data flow.

AF 1860 provided PDU Set QoS Parameters and Protocol Description may be used in determining PCC rules by the PCF 1856 as defined in clause 6.1.3.27.4 of 3GPP TS 23.503 and the protocol description may be used for identifying the PDU Set information by the PSA UPF 1848.

When the PCF 1856 determines that PDU Set based QoS Handling is to be performed for an application service flow, the PCF 1856 generates a PCC rule containing the PDU Set QoS parameters (e.g., PSER, PSDB and PSIHI) and the SMF 1846 determines a QoS Profile for the QoS flow. Alternatively, the SMF 1846 may be configured to support PDU Set QoS without receiving PCC rules from a PCF 1856.

The PSA UPF 1848 identifies PDUs that belong to PDU Sets. If the UPF 1848 receives a PDU that does not belong to a PDU Set based on Protocol Description for PDU Set identification, then the UPF 1848 still maps it to a PDU Set and determines the PDU Set Information as described in section 1.4.6 and/or in clause 5.37.5.2 of [TS23501]. In some examples, if the PSA UPF 1848 receives a PDU that does not belong to a PDU Set, then it is assumed that the UPF 1848 determines the PDU Set Importance (PSI) value based on pre-configuration.

### 1.4.6. PDU Set Information and Identification

To support PDU Set based QoS handling, the PSA UPF 1848 identifies PDUs that belong to PDU Sets and determines the below PDU Set Information which it sends to the NG-RAN 1804 in the GTP-U header. The PDU Set information is used by the NG-RAN 1804 for PDU Set based QoS handling as described above.

The PDU Set Information comprises: PDU Set sequence number; indication of End PDU of the PDU Set; PDU sequence number within a PDU Set; PDU Set size (e.g., in bytes); and/or PSI, which identifies the relative importance of a PDU Set compared to other PDU Sets within a QoS flow.

The NG-RAN 1804 may use the Priority Level (see e.g., clause 5.7.3.3 of [TS23501]) across QoS flows and PSI within a QoS flow for PDU Set level packet discarding in presence of congestion. In addition to considering the PSI within a QoS flow, NG-RAN 1804 could also consider the relative PSI across QoS flows of the same Priority Level when determining which PDU Set needs to be discarded, which is up to implementation and configuration of operator. In some examples, the PDU Set information can be different for different PDU Sets within a QoS flow.

The SMF 1846 instructs PSA UPF 1848 to perform PDU Set marking and may provide the PSA UPF 1848 the Protocol Description indicating the header, extension header (e.g., RTP/SRTP and/or the like) and payload type (e.g., H.264 and/or the like) used by the service data flow. The Protocol Description may be received in the PCC rule, based on information provided by the AF 1860 or by PCF 1856 local policies as described in clause 5.37.5.1 of [TS23501].

The PSA UPF 1848 can identify the PDU Set Information using the Protocol Description and the received RTP/SRTP headers or using implementation specific means. The details of the RTP/SRTP headers, header extensions and/or payloads used to identify PDU Set Information are defined in 3GPP TS 26.522.

For each DL PDU received on N6 for which PDU Set based QoS handling is indicated from the SMF 1846, the PSA UPF 1848 applies the rules for PDU Set identification and provides PDU Set Information which is available to the RAN in the GTP-U header.

### 1.4.7. Non-Homogenous Support of PDU Set Based Handling in Ng-Ran

By sending at least one PDU Set QoS parameter to the NG-RAN 1804, the SMF 1846 requests the NG-RAN 1804 to activate PDU Set QoS handling for a given QoS flow and the NG-RAN 1804 provides the SMF 1846 with an indication of whether the PDU Set QoS parameter is accepted or not. At NG-RAN 1804 Xn handover and N2 handover, the target NG-RAN 1804 provides to the SMF 1846 with an indication of whether the target NG-RAN node 1814 supports PDU Set based handling, as specified in 3GPP TS 38.413. Based on the NG-RAN 1804 indications, the SMF 1846 configures the PSA UPF 1848 to activate/deactivate the PDU Set identification and marking.

In the case where the PSA UPF 1848 identifies and marks PDUs with PDU Set information in GTP-U header it starts doing so from a complete PDU Set. In the case of handover from a source NG-RAN node 1814 not supporting PDU Set handling to a target NG-RAN node 1814 supporting PDU Set handling, whether there is a reason for the target NG-RAN node to temporarily handle both unmarked PDUs and marked PDUs within the same QoS flow is FFS.

### 1.5. Buffer Status Reporting (BSR) Aspects

The buffer status reporting (BSR) procedure is used to provide a serving RAN node (e.g., gNB 1814a) with information about UL data volume in the MAC entity (e.g., at the MAC layer of a UE 1802 or another RAN node 1814). The RRC layer/entity configures the following parameters to control the BSR: periodicBSR-Timer; retxBSR-Timer; logicalChannelSR-DelayTimerApplied; logicalChannelSR-DelayTimer; logicalChannelSR-Mask; logicalChannelGroup, logicalChannelGroupIAB-Ext; and/or sdt-LogicalChannelSR-DelayTimer.

Each logical channel may be allocated to an LCG using the parameter logicalChannelGroup. The maximum number of LCGs is eight except for IAB-MTs configured with logicalChannelGrouplAB-Ext, for which the maximum number of LCGs is 256.

The MAC entity determines the amount of UL data available for a logical channel according to the data volume calculation procedure in 3GPP TS 38.322 (“[TS38322]”) (e.g., 3GPP TS 38.322 v17.3.0 (2023 Jun. 30), the contents of which are hereby incorporated by reference in its entirety) and/or [TS38323].

A BSR is triggered if any of the following events occur for activated cell group: (i) UL data, for a logical channel which belongs to an LCG, becomes available to the MAC entity, and either this UL data belongs to a logical channel with higher priority than the priority of any logical channel containing available UL data which belong to any LCG and/or none of the logical channels which belong to an LCG contains any available UL data, in which case the BSR is referred to as a “Regular BSR”; (ii) UL resources are allocated and number of padding bits is equal to or larger than the size of the Buffer Status Report MAC CE plus its subheader, in which case the BSR is referred to as a “Padding BSR”; (iii) retxBSR-Timer expires, and at least one of the logical channels which belong to an LCG contains UL data, in which case the BSR is referred to as a “Regular BSR”; (iv) periodicBSR-Timer expires, in which case the BSR is referred to as a “Periodic BSR”; (v) when certain data PDUs are determined to be discarded, such as when at least one of the logical channels which belongs to an LCG contains UL data and/or none of the logical channels which belong to an LCG contains any available UL data, in which case the BSR is referred to as a “Discard update BSR”; and/or (vi) a discardBSR-Timer expires, and total amount of discarded PDCP data volume and discarded RLC data volume pending for (re)transmission is equal to or larger than ul-DiscardVolumeThreshold, in which case the BSR is referred to as a “Discard BSR”. When Regular BSR triggering events occur for multiple logical channels simultaneously, each logical channel triggers one separate Regular BSR. The MAC entity performs any of the operations discussed herein for a Discard BSR.

The MAC entity performs the following operations for a Regular BSR: if the BSR is triggered for a logical channel for which logicalChannelSR-DelayTimerApplied with value true is configured by upper layers and SDT procedure is not on-going according to clause 5.27 of [TS38321]: start or restart the logicalChannelSR-DelayTimer; else if BSR is triggered for a logical channel for which logicalChannelSR-DelayTimerApplied with value true is configured by upper layers and SDT procedure is on-going according to clause 5.27 of [TS38321]: start or restart logicalChannelSR-DelayTimer with the value as configured by the sdt-LogicalChannelSR-DelayTimer; else, if running, stop the logicalChannelSR-DelayTimer.

For Regular BSR and Periodic BSR, the MAC entity for which logicalChannelGroupIAB-Ext is not configured by upper layers performs the following operations: if more than one LCG has data available for transmission when the MAC PDU containing the BSR is to be built: report Long BSR for all LCGs which have data available for transmission; else: report Short BSR.

For Regular BSR and Periodic BSR, the MAC entity for which logicalChannelGroupIAB-Ext is configured by upper layers performs the following operations: if more than one LCG has data available for transmission when the MAC PDU containing the BSR is to be built: if the maximum LCG ID among the configured LCGs is 7 or lower: report Long BSR for all LCGs which have data available for transmission, else: report Extended Long BSR for all LCGs which have data available for transmission; else: report Extended Short BSR.

For Padding BSR, the MAC entity for which logicalChannelGroupIAB-Ext is not configured by upper layers performs the following operations: if the number of padding bits is equal to or larger than the size of the Short BSR plus its subheader but smaller than the size of the Long BSR plus its subheader: if more than one LCG has data available for transmission when the BSR is to be built: if the number of padding bits is equal to the size of the Short BSR plus its subheader: report Short Truncated BSR of the LCG with the highest priority logical channel with data available for transmission, else: report Long Truncated BSR of the LCG(s) with the logical channels having data available for transmission following a decreasing order of the highest priority logical channel (with or without data available for transmission) in each of these LCG(s), and in case of equal priority, in increasing order of LCGID; else: report Short BSR; else if the number of padding bits is equal to or larger than the size of the Long BSR plus its subheader: report Long BSR for all LCGs which have data available for transmission.

For Padding BSR, the MAC entity for which logicalChannelGroupIAB-Ext is configured by upper layers performs the following operations: if the number of padding bits is equal to or larger than the size of the Extended Short BSR plus its subheader but smaller than the size of the Extended Long BSR plus its subheader: if more than one LCG has data available for transmission when the BSR is to be built: if the number of padding bits is smaller than the size of the Extended Long Truncated BSR with zero Buffer Size field plus its subheader: report Extended Short Truncated BSR of the LCG with the highest priority logical channel with data available for transmission, else: report Extended Long Truncated BSR of the LCG(s) with the logical channels having data available for transmission following a decreasing order of the highest priority logical channel (with or without data available for transmission) in each of these LCG(s), and in case of equal priority, in increasing order of LCGID; else: report Extended Short BSR; else if the number of padding bits is equal to or larger than the size of the Extended Long BSR plus its subheader: report Extended Long BSR for all LCGs which have data available for transmission.

For BSR triggered by retxBSR-Timer expiry, the MAC entity considers that the logical channel that triggered the BSR is the highest priority logical channel that has data available for transmission at the time the BSR is triggered.

Additionally or alternatively, the MAC entity performs the following operations: if the Buffer Status reporting procedure determines that at least one BSR has been triggered and not cancelled: if UL-SCH resources are available for a new transmission and the UL-SCH resources can accommodate the BSR MAC CE plus its subheader as a result of LCP: instruct the Multiplexing and Assembly procedure to generate the BSR MAC CE(s) as defined in clause 6.1.3.1 of [TS38321]; start or restart periodicBSR-Timer except when all the generated BSRs are long or short Truncated or Extended long or short Truncated BSRs; and start or restart retxBSR-Timer; if a Regular BSR has been triggered and logicalChannelSR-DelayTimer is not running: if there is no UL-SCH resource available for a new transmission; if the MAC entity is configured with configured UL grant(s) and the Regular BSR was triggered for a logical channel for which logicalChannelSR-Mask is set to false; and/or if the UL-SCH resources available for a new transmission do not meet the LCP mapping restrictions (see e.g., clause 5.4.3.1 of [TS38321]) configured for the logical channel that triggered the BSR: trigger a Scheduling Request. In some examples, UL-SCH resources are considered available if the MAC entity has been configured with, receives, or determines an UL grant. If the MAC entity has determined at a given point in time that UL-SCH resources are available, this need not imply that UL-SCH resources are available for use at that point in time.

In some examples, a MAC PDU contains at most one BSR MAC CE, even when multiple events have triggered a BSR. The Regular BSR and the Periodic BSR shall have precedence over the padding BSR. In some examples, the MAC entity restarts retxBSR-Timer upon reception of a grant for transmission of new data on any UL-SCH.

In some examples, all triggered BSRs may be cancelled when the UL grant(s) can accommodate all pending data available for transmission but is not sufficient to additionally accommodate the BSR MAC CE plus its subheader. In some examples, all BSRs triggered prior to MAC PDU assembly shall be cancelled when a MAC PDU is transmitted and this PDU includes a Long, Extended Long, Short, or Extended Short BSR MAC CE which contains buffer status up to (and including) the last event that triggered a BSR prior to the MAC PDU assembly.

In some examples, MAC PDU assembly can happen at any point in time between UL grant reception and actual transmission of the corresponding MAC PDU. BSR and SR can be triggered after the assembly of a MAC PDU which contains a BSR MAC CE, but before the transmission of this MAC PDU. In addition, BSR and SR can be triggered during MAC PDU assembly. Additionally or alternatively, if a HARQ process is configured with cg-RetransmissionTimer and if the BSR is already included in a MAC PDU for transmission on configured grant by this HARQ process, but not yet transmitted by lower layers, it is up to UE implementation how to handle the BSR content.

### 2. CELLULAR NETWORK ASPECTS

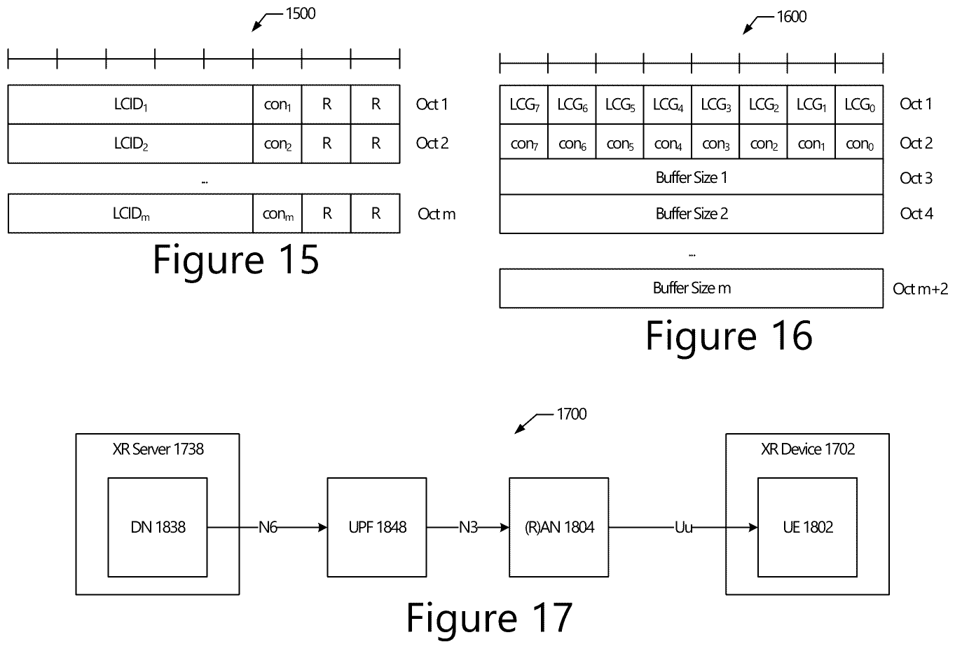

FIG. 17 depicts an example XR traffic model 1700. The XR traffic model xr100 follows the 5GS architecture discussed infra w.r.t FIG. 18 and/or as defined in [TS23501]. In particular, the user plane aspects are considered as shown by FIG. 17 for which an XR server 1738 is in the external DN 1838 or in a trusted DN 1838, and the XR device 1702 is a 5G-capable UE, which may be the same or similar as UE 1802 of FIG. 18.

As examples, the XR server 1738 may be hosted in the cloud (e.g., by one or more cloud compute nodes of a cloud computing service) or may be hosted at the edge (e.g., by one or more edge compute nodes of an edge computing system/network). The XR device 1702 can include suitable XR hardware components for communicating and rendering/displaying XR content. Examples of such XR hardware components include processor circuitry, output circuitry (e.g., actuators, display(s), and/or the like), optical elements (e.g., waveguides (e.g., diffractive, reflective, holographic, polarized, and/or the like), diffusers, lenses, mirrors, projectors, picture generation units, holographic optical elements (HOEs), and/or the like), one or more sensors, and input circuitry. The input circuitry and/or sensor(s) may include, for example, image capture devices (e.g., visible-light cameras, infrared cameras, ultraviolet-light cameras, and/or the like), proximity sensors, GPS circuitry, and/or microelectromechanical systems (MEMS) sensors, such as accelerometers, gyroscopes, solid state compasses, and/or the like. Additionally or alternatively, the sensor(s), input circuitry, and/or output circuitry, may include any of the devices/components as the peripheral devices 2004 discussed infra w.r.t FIG. 20. As examples, the XR device 1702 may be a head-up display (HUD), head-mounted display (HMD) and/or optical HMD, AR/VR headset, smart glasses, EyeTap device, XR contact lenses and/or bionic contact lenses, smart watch, handheld XR device, projector/projection mapper, and/or any other suitable devices, such as any of those discussed herein.

In this example, the exchange of data is carried out using the 5GS 1800. Interfaces to the 5GC functions for charging, QoS control, and/or the like are not shown by FIG. 17, but may include any of those discussed infra w.r.t FIG. 18 and/or as discussed in [TS23501]. Additionally, aspects of the XR traffic model 1700 are discussed in 3GPP TR 26.926 v2.0.0 (2023 Sep. 5), 3GPP TR 26.928 v18.0.0 (2023 Mar. 30), 3GPP TR 26.925 v17.1.0 (2022 Mar. 31), 3GPP TR 38.838 v17.0.0 (2022 Jan. 4), and 3GPP TS 26.501 v18.2.0 (2023 Jun. 29), the contents of each of which are hereby incorporated by reference in their entireties.

FIG. 18 depicts an example network architecture 1800. The network 1800 may operate in a manner consistent with 3GPP technical specifications for LTE or NR/5G systems (5GS). However, the example embodiments are not limited in this regard and the described examples may apply to other networks that benefit from the principles described herein, such as future 3GPP systems, non-3GPP cellular systems, other wireless area networks (WANs), and/or the like.

The network 1800 includes a UE 1802, which is any mobile or non-mobile computing device designed to communicate with a RAN 1804 via an over-the-air connection. The UE 1802 is communicatively coupled with the RAN 1804 by a Uu interface, which may be applicable to both LTE and 5GS. Examples of the UE 1802 include, but are not limited to, a smartphone, tablet computer, wearable device (e.g., smart watch, fitness tracker, smart glasses, smart contact lenses, smart clothing/fabrics, smart shows, and/or the like), desktop computer, workstation, laptop computer, in-vehicle infotainment system, in-car entertainment system, instrument cluster, head-up display (HUD) device, helmet-mounted display/head-mounted display, XR headset, virtual retinal display (VRD), onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein.

The network 1800 may include a set of UEs 1802 coupled directly with one another via a D2D, ProSe, PC5, and/or sidelink (SL) interface, and/or any other suitable interface such as any of those discussed herein. In 3GPP systems, SL communication involves communication between two or more UEs 1802 using 3GPP technology without traversing a network node. These UEs 1802 may be M2M/D2D/MTC/IoT devices and/or vehicular systems that communicate using an SL interface, which includes, for example, one or more SL logical channels (e.g., Sidelink Broadcast Control Channel (SBCCH), Sidelink Control Channel (SCCH), and Sidelink Traffic Channel (STCH)); one or more SL transport channels (e.g., Sidelink Shared Channel (SL-SCH) and Sidelink Broadcast Channel (SL-BCH)); and one or more SL physical channels (e.g., Physical Sidelink Shared Channel (PSSCH), Physical Sidelink Control Channel (PSCCH), Physical Sidelink Feedback Channel (PSFCH), Physical Sidelink Broadcast Channel (PSBCH), and/or the like). The UE 1802 may perform blind decoding attempts of SL channels/links according to the various examples herein.

The UE 1802 may communicate with an AP 1806 via an over-the-air (OTA) connection. The AP 1806 manages a WLAN connection, which may serve to offload some/all network traffic from the RAN 1804. The connection between the UE 1802 and the AP 1806 may be consistent with any IEEE 802.11 protocol. Additionally, the UE 1802, RAN 1804, and AP 1806 may utilize cellular-WLAN aggregation/integration (e.g., LWA/LWIP). Cellular-WLAN aggregation may involve the UE 1802 being configured by the RAN 1804 to utilize both cellular radio resources and WLAN resources.

The RAN 1804 includes one or more network access nodes (NANs) 1814, each of which terminate air-interface(s) for the UE 1802 by providing access stratum (AS) protocols including RRC, PDCP, RLC, MAC, and PHY protocols. In this manner, the NAN 1814 enables data/voice connectivity between CN 1840 and the UE 1802. The NANs 1814 may be a macrocell base station or a low power base station for providing femtocells, picocells or other like cells having smaller coverage areas, smaller user capacity, or higher bandwidth compared to macrocells; or some combination thereof. Each NAN 1814 manages one or more cells, cell groups, component carriers (CCs) in carrier aggregation (CA), and the like to provide the UE 1802 with an air interface for network access. The UE 1802 may be simultaneously connected with a set of cells provided by the same or different NANs 1814. For example, the UE 1802 and RAN 1804 may use CA to allow the UE 1802 to connect with a set of CCs, each corresponding to a PCell, SCell, PSCell, SpCell, and/or the like. In dual connectivity (DC) scenarios, a first NAN 1814 may be a master node that provides an MCG and a second NAN 1814 may be secondary node that provides an SCG. The first/second NANs 1814 may be any combination of eNB, gNB, ng-eNB, and the like.

The NG-RAN 1804 supports multi-radio DC (MR-DC) operation where a UE 1802 is configured to utilize radio resources provided by two distinct schedulers, located in at least two different NG-RAN nodes 1814 connected via a non-ideal backhaul, one NG-RAN node 1814 providing NR access and the other NG-RAN node 1814 providing either E-UTRA or NR access. One node acts as a master node and the other as a secondary node, and the master node and secondary node are connected via a network interface and at least the MN is connected to the core network (e.g., CN 1840). In some implementations, the MN and/or the SN can be operated with shared spectrum channel access. Further details of MR-DC operation, including conditional PSCell addition (CPA) and conditional PSCell change (CPC), can be found in 3GPP TS 36.300 v17.5.0 (2023 Jul. 6) (“[TS36300]”), [TS38300], and 3GPP TS 37.340 v17.5.0 (2023 Jun. 30), the contents of each of which are hereby incorporated by reference in their entireties.

The UE 1802 can be configured to perform signal/cell measurement and reporting procedures to provide the network with information about the quality of one or more wireless channels and/or the communication media in general, and this information can be used to optimize various aspects of the communication system. The physical signals and/or reference signals (RS) that is/are measured include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), sounding reference signal (SRS), and/or the like. Additionally or alternatively, the UE 1802 can be configured to perform/collect signal/cell measurements of RS and/or physical channels, and provide measurement reports to one or more NANs 1814. The measurement reports include, for example, signal strength measurements, signal quality measurements, and/or the like. Each measurement report is tagged with a timestamp and/or a location of the measurement (e.g., the UEs 1802 location where the measurement was performed/collected). As examples, the measurement and reporting procedures performed by the UE 1802 can include those discussed in 3GPP TS 38.211 v17.5.0 (2023 Jun. 26), 3GPP TS 38.212 v17.5.0 (2023 Mar. 30), 3GPP TS 38.213 v17.6.0 (2023 Jun. 26), 3GPP TS 38.214 v17.6.0 (2023 Jun. 26), [TS38215], 3GPP TS 38.101-1 v18.2.0 (2023 Jun. 30), 3GPP TS 38.104 v18.2.0 (2023 Jun. 30), and/or 3GPP TS 38.133 v18.2.0 (2023 Jun. 30), [TS38331], the contents of each of which are hereby incorporated by reference in their entireties. Examples of the measurements included in the measurement reports include one or more of: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (E_{b}/N₀), energy per chip to interference power density ratio (E_{c}/I₀), energy per chip to noise power density ratio (E_{c}/N₀), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames, GNSS code measurements, GNSS carrier phase measurements and/or accumulated delta range (ADR), channel interference measurements, thermal noise power measurements, received interference power measurements, power histogram measurements, channel load measurements, station statistics, and/or additional or alternative measurements, such as any of those discussed in 3GPP TS 36.214 v17.0.0 (2022 Mar. 31), 3GPP TS 38.215 v17.3.0 (2023 Mar. 30) (“[TS38215]”), 3GPP TS 38.314 v17.3.0 (2023 Jun. 30), 3GPP TS 28.552 v18.3.0 (2023 Jun. 27) (“[TS28552]”), 3GPP TS 32.425 v17.1.0 (2021-06-24) (“[TS32425]”), 3GPP TS 32.401 v17.0.0 (2022 Apr. 1), and IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), the contents of each of which are hereby incorporated by reference in their entireties. Additionally or alternatively, any of the aforementioned measurements (or combination of measurements) may be collected by one or more NANs 1814 and provided to the edge compute node(s), NF(s), and/or any other entity/elements, such as any of those discussed herein.

In any of the examples discussed herein, any suitable data collection and/or measurement mechanism(s) may be used to collect the observation data such as, for example, data marking, sequence numbering, packet tracing, signal measurement, data sampling, and/or timestamping techniques. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g., OS type and version, and the like). Various configurations may be used to define any of the aforementioned data collection parameters. Such configurations may be defined by suitable specifications/standards, such as any of those discussed herein.

The RAN nodes 1814 may include a set of gNBs 1814a. Each gNB 1814a connects with 5G-enabled UEs 1802 using a 5G-NR air interface (Uu interface) with parameters and characteristics as discussed in [TS38300], among many other 3GPP standards. The RAN nodes 1814 may also include a set of ng-eNBs 1814b that connect with UEs 1802 via the 5G Uu and/or an LTE Uu interface. The gNBs 1814a and the ng-eNBs 1814b connect with the 5GC 1840 through respective NG interfaces, which include an N2 interface, an N3 interface, and/or other interfaces. The gNB 1814a and the ng-eNB 1814b are connected with each other over an Xn interface. Additionally, individual gNBs 1814a are connected to one another via respective Xn interfaces, and individual ng-eNBs 1814b are connected to one another via respective Xn interfaces. The NG interface may be split into two parts, an NG user plane (NG-U) interface, which carries traffic data between the nodes of the NG-RAN 1814 and a UPF 1848 (e.g., N3 interface), and an NG control plane (NG-C) interface, which is a signaling interface between the nodes of the NG-RAN 1814 and an AMF 1844 (e.g., N2 interface). The Xn interfaces may be separated into control/user plane interfaces, which allows the NANs 1814 to communicate information related to handovers (HOs), data/context transfers, mobility, load management, interference coordination, and the like.

The NG-RAN 1814 may provide a 5G-NR air interface (Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a DL resource grid that includes PSS/SSS/PBCH. The 5G-NR air interface may utilize bandwidth parts (BWPs) for various purposes, for example, dynamic adaptation of the SCS.

One example implementation is a “CU/DU split” architecture where the NANs 1814 are embodied as a gNB-Central Unit (CU) that is communicatively coupled with one or more gNB-Distributed Units (DUs), where each DU may be communicatively coupled with one or more Radio Units (RUs) (see e.g., 3GPP TS 38.300 v17.5.0 (2023 Jun. 30) (“[TS38300]”), 3GPP TS 38.401 v17.5.0 (2023 Jun. 29) (“[TS38401]”), 3GPP TS 38.410 v 17.1.0 (2022 Jun. 23), and 3GPP TS 38.473 v17.5.0 (2023 Jun. 29), the contents of each of which are incorporated by reference in their entireties). Any other type of architectures, arrangements, and/or configurations can be used. For example, in some implementations, the RAN 1804, CN 1840, and/or edge computing nodes (e.g., server(s) 1838) can be disaggregated into various functions as discussed in U.S. application Ser. No. 17/704,658 filed on 25 Mar. 2022 (“['658]”).

The RAN 1804 is communicatively coupled to CN 1840 that includes network elements and/or network functions (NFs) to provide various functions to support data and telecommunications services to customers/subscribers (e.g., UE 1802). The components of the CN 1840 may be implemented in one physical node or separate physical nodes. NFV may be utilized to virtualize any or all of the functions provided by the network elements of the CN 1840 onto physical compute/storage resources in servers, switches, and the like. A logical instantiation of the CN 1840 may be referred to as a network slice, and a logical instantiation of a portion of the CN 1840 may be referred to as a network sub-slice.

In the example of FIG. 18, the CN 1840 is a 5G core network (5GC) 1840 including an Authentication Server Function (AUSF) 1842, Access and Mobility Management Function (AMF) 1844, Session Management Function (SMF) 1846, User Plane Function (UPF) 1848, Network Slice Selection Function (NSSF) 1850, Network Exposure Function (NEF) 1852, Network Repository Function (NRF) 1854, Policy Control Function (PCF) 1856, Unified Data Management (UDM) 1858, Application Function (AF) 1860, Edge Application Server Discovery Function (EASDF) 1861, and Network Data Analytics Function (NWDAF) 1862 coupled with one another over various interfaces as shown. The NFs in the 5GC 1840 are briefly introduced as follows.

The NWDAF 1862 includes one or more of the following functionalities: support data collection from NFs and AFs 1860; support data collection from OAM 240; NWDAF service registration and metadata exposure to NFs and AFs 1860; support analytics information provisioning to NFs and AFs 1860; support machine learning (ML) model training and provisioning to NWDAF(s) 1862. Some or all of the NWDAF functionalities can be supported in a single instance of an NWDAF 1862. The NWDAF 1862 also includes an analytics reporting capability (e.g., an analytics logical function (AnLF)) comprising means that allow discovery of the type of analytics that can be consumed by an external party and/or the request for consumption of analytics information generated by the NWDAF 1862. The NWDAF 1862 may contain an AnLF and/or a model training logical function (MTLF). In some implementations, the NWDAF 1862 contains only an MTLF, only an AnLF, or both logical functions. The 5GS allows an NWDAF containing an AnLF (also referred to herein as “NWDAF-ANLF”) to use trained ML model provisioning services from the same or different NWDAF containing an MTLF (also referred to herein as “NWDAF-MTLF”). The AnLF is a logical function in the NWDAF 1862 that performs inference, derives analytics information (e.g., derives statistics, inferences, and/or predictions based on analytics consumer requests) and exposes analytics services. Analytics information are either statistical information of past events, or predictive information. The MTLF is a logical function in the NWDAF 1862 that trains AI/ML models and exposes new training services (e.g., providing trained ML model) (see e.g., [TS23288] §§ 7.5, 7.6). In some implementations, the MnS-P, MnF, and/or MnF-PA 440 discussed previously may be an NWDAF-MTLF and the MnS-C (inside or outside an MnF) may be an NWDAF-AnLF, another NWDAF-MTLF, and/or another NF, such as any of those discussed herein. Additional aspects of NWDAF 1862 functionality are defined in 3GPP TS 23.288 v18.2.0 (2023 Jun. 21) (“[TS23288]”).

The AUSF 1842 stores data for authentication of UE 1802 and handle authentication-related functionality. The AUSF 1842 may facilitate a common authentication framework for various access types.

The AMF 1844 allows other functions of the 5GC 1840 to communicate with the UE 1802 and the RAN 1804 and to subscribe to notifications about mobility events w.r.t the UE 1802. The AMF 1844 is also responsible for registration management (e.g., for registering UE 1802), connection management, reachability management, mobility management, lawful interception of AMF-related events, and access authentication and authorization. The AMF 1844 provides transport for SM messages between the UE 1802 and the SMF 1846, and acts as a transparent proxy for routing SM messages. AMF 1844 also provides transport for SMS messages between UE 1802 and an SMSF. AMF 1844 interacts with the AUSF 1842 and the UE 1802 to perform various security anchor and context management functions. Furthermore, AMF 1844 is a termination point of a RAN-CP interface, which includes the N2 reference point between the RAN 1804 and the AMF 1844. The AMF 1844 is also a termination point of NAS (N1) signaling, and performs NAS ciphering and integrity protection. The AMF 1844 also supports NAS signaling with the UE 1802 over an N3IWF interface. The N3IWF provides access to untrusted entities.

N3IWF may be a termination point for the N2 interface between the (R)AN 1804 and the AMF 1844 for the control plane, and may be a termination point for the N3 reference point between the (R)AN 1804 and the 1848 for the user plane. As such, the AMF 1844 handles N2 signaling from the SMF 1846 and the AMF 1844 for PDU sessions and QoS, encapsulate/de-encapsulate packets for IPSec and N3 tunneling, marks N3 user-plane packets in the UL, and enforces QoS corresponding to N3 packet marking taking into account QoS requirements associated with such marking received over N2. N3IWF may also relay UL and DL control-plane NAS signaling between the UE 1802 and AMF 1844 via an N1 reference point between the UE 1802 and the AMF 1844, and relay UL and DL user-plane packets between the UE 1802 and UPF 1848. The N3IWF also provides mechanisms for IPsec tunnel establishment with the UE 1802. The AMF 1844 may exhibit an Namf service-based interface, and may be a termination point for an N14 reference point between two AMFs 1844 and an N17 reference point between the AMF 1844 and a 5G-EIR (not shown by FIG. 18). In addition to the functionality of the AMF 1844 described herein, the AMF 1844 may provide support for Network Slice restriction and Network Slice instance restriction based on NWDAF analytics.

The SMF 1846 is responsible for SM (e.g., session establishment, tunnel management between UPF 1848 and NAN 1814); UE IP address allocation and management (including optional authorization); selection and control of UP function; configuring traffic steering at UPF 1848 to route traffic to proper destination; termination of interfaces toward policy control functions; controlling part of policy enforcement, charging, and QoS; lawful intercept (for SM events and interface to LI system); termination of SM parts of NAS messages; DL data notification; initiating AN specific SM information, sent via AMF 1844 over N2 to NAN 1814; and determining SSC mode of a session. SM refers to management of a PDU session, and a PDU session or “session” refers to a PDU connectivity service that provides or enables the exchange of PDUs between the UE 1802 and the DN 1836. The SMF 1846 may also include the following functionalities to support edge computing enhancements (see e.g., [TS23548]): selection of EASDF 1861 and provision of its address to the UE as the DNS server for the PDU session; usage of EASDF 1861 services as defined in [TS23548]; and for supporting the application layer architecture defined in [TS23558], provision and updates of ECS address configuration information to the UE 1802. Discovery and selection procedures for EASDFs 1861 is discussed in [TS23501] § 6.3.23.

The UPF 1848 acts as an anchor point for intra-RAT and inter-RAT mobility, an external PDU session point of interconnect to DN 1836, and a branching point to support multi-homed PDU session. PDU connectivity service and PDU session aspects are discussed in 3GPP TS 38.415 v17.0.0 (2022 Apr. 6) and 3GPP TS 38.413 v17.3.0 (2023 Jan. 6). The UPF 1848 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs UL traffic verification (e.g., SDF-to-QoS flow mapping), transport level packet marking in the UL and DL, and performs DL packet buffering and DL data notification triggering. UPF 1848 may include an UL classifier to support routing traffic flows to a data network.

The NSSF 1850 selects a set of network slice instances serving the UE 1802. The NSSF 1850 also determines allowed NSSAI and the mapping to the subscribed S-NSSAIs, if needed. The NSSF 1850 also determines an AMF set to be used to serve the UE 1802, or a list of candidate AMFs 1844 based on a suitable configuration and possibly by querying the NRF 1854. The selection of a set of network slice instances for the UE 1802 may be triggered by the AMF 1844 with which the UE 1802 is registered by interacting with the NSSF 1850; this may lead to a change of AMF 1844. The NSSF 1850 interacts with the AMF 1844 via an N22 reference point; and may communicate with another NSSF in a visited network via an N31 reference point (not shown).

The NEF 1852 securely exposes services and capabilities provided by 3GPP NFs for third party, internal exposure/re-exposure, AFs 1860, edge computing networks/frameworks, and the like. In such examples, the NEF 1852 may authenticate, authorize, or throttle the AFs 1860. The NEF 1852 stores/retrieves information as structured data using the Nudr interface to a Unified Data Repository (UDR). The NEF 1852 also translates information exchanged with the AF 1860 and information exchanged with internal NFs. For example, the NEF 1852 may translate between an AF-Service-Identifier and an internal 5GC information, such as DNN, S-NSSAI, as described in clause 5.6.7 of [TS23501]. In particular, the NEF 1852 handles masking of network and user sensitive information to external AF's 1860 according to the network policy. The NEF 1852 also receives information from other NFs based on exposed capabilities of other NFs. This information may be stored at the NEF 1852 as structured data, or at a data storage NF using standardized interfaces. The stored information can then be re-exposed by the NEF 1852 to other NFs and AFs, or used for other purposes such as analytics. For example, NWDAF analytics may be securely exposed by the NEF 1852 for external party, as specified in [TS23288]. Furthermore, data provided by an external party may be collected by the NWDAF 1862 via the NEF 1852 for analytics generation purpose. The NEF 1852 handles and forwards requests and notifications between the NWDAF 1862 and AF(s) 1860, as specified in [TS23288]. The NEF 1852 can provide interface(s) to edge compute nodes, which can be used to process wireless connections with the RAN 1814.

The NRF 1854 supports service discovery functions, receives NF discovery requests from NF instances, and provides information of the discovered NF instances to the requesting NF instances. The NRF 1854 also maintains NF profiles of available NF instances and their supported services. The NF profile of NF instance maintained in the NRF 1854 includes the various information discussed in [TS23501], [TS23502], [TS23288], 3GPP TS 29.510 v18.3.0 (2023 Jun. 26), 3GPP TS 23.287 v18.0.0 (2023 Mar. 31), 3GPP TS 23.247 v18.2.0 (2023 Jun. 21), and/or the like.

The PCF 1856 provides policy rules to control plane functions to enforce them, and may also support unified policy framework to govern network behavior. The PCF 1856 may also implement a front end to access subscription information relevant for policy decisions in a UDR of the UDM 1858. In addition to communicating with functions over reference points as shown, the PCF 1856 exhibit an Npcf service-based interface.

The UDM 1858 handles subscription-related information to support the network entities' handling of communication sessions, and stores subscription data of UE 1802. For example, subscription data may be communicated via an N8 reference point between the UDM 1858 and the AMF 1844. The UDM 1858 may include two parts, an application front end and a UDR. The UDR may store subscription data and policy data for the UDM 1858 and the PCF 1856, and/or structured data for exposure and application data (including PFDs for application detection, application request information for multiple UEs 1802) for the NEF 1852. The Nudr service-based interface may be exhibited by the UDR to allow the UDM 1858, PCF 1856, and NEF 1852 to access a particular set of the stored data, as well as to read, update (e.g., add, modify), delete, and subscribe to notification of relevant data changes in the UDR. The UDM 1858 may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1858 may exhibit the Nudm service-based interface.

EASDF 1861 exhibits an Neasdf service-based interface, and is connected to the SMF 1846 via an N88 interface. One or multiple EASDF instances may be deployed within a PLMN, and interactions between 5GC NF(s) and the EASDF 1861 take place within a PLMN. The EASDF 1861 includes one or more of the following functionalities: registering to NRF 1854 for EASDF 1861 discovery and selection; handling the DNS messages according to the instruction from the SMF 1846; and/or terminating DNS security, if used. Handling the DNS messages according to the instruction from the SMF 1846 includes one or more of the following functionalities: receiving DNS message handling rules and/or BaselineDNSPattern from the SMF 1846; exchanging DNS messages from/with the UE 1802; forwarding DNS messages to C-DNS or L-DNS for DNS query; adding EDNS client subnet (ECS) option into DNS query for an FQDN; reporting to the SMF 1846 the information related to the received DNS messages; and/or buffering/discarding DNS messages from the UE 1802 or DNS Server. The EASDF has direct user plane connectivity (e.g., without any NAT) with the PSA UPF over N6 for the transmission of DNS signaling exchanged with the UE 1802. The deployment of a NAT between EASDF 1861 and PSA UPF 1848 may or may not be supported. Additional aspects of the EASDF 1861 are discussed in [TS23548].

AF 1860 provides application influence on traffic routing, provide access to NEF 1852, and interact with the policy framework for policy control. The AF 1860 may influence UPF 1848 (re)selection and traffic routing. Based on operator deployment, when AF 1860 is considered to be a trusted entity, the network operator may permit AF 1860 to interact directly with relevant NFs. In some implementations, the AF 1860 is used for edge computing implementations. An NF that needs to collect data from an AF 1860 may subscribe/unsubscribe to notifications regarding data collected from an AF 1860, either directly from the AF 1860 or via NEF 1852.

The 5GC 1840 may enable edge computing by selecting operator/3rd party services to be geographically close to a point that the UE 1802 is attached to the network. This may reduce latency and load on the network. In edge computing implementations, the 5GC 1840 may select a UPF 1848 close to the UE yx02 and execute traffic steering from the UPF 1848 to DN 1836 via the N6 interface. This may be based on the UE subscription data, UE location, and information provided by the AF 1860, which allows the AF 1860 to influence UPF (re)selection and traffic routing.

The data network (DN) 1836 is a network hosting data-centric services such as, for example, operator services, the internet, third-party services, and/or enterprise networks. The DN 1836 may represent various network operator services, Internet access, or third party services that may be provided by one or more servers 1838. As examples, the server(s) 1838 can be or include application (app) server(s), content server(s), web server(s), database server(s), edge compute node(s) or edge server(s), DNS server(s), cloud compute node(s) or cloud compute resource(s), and/or the like. The DN 1836 may be an operator external public, a private PDN, or an intra-operator packet data network, for example, for provision of IMS services. In some implementations, the DN 1836 may represent one or more local area DNs (LADNs), which are DNs 1836 (or DN names (DNNs)) that is/are accessible by a UE 1802 in one or more specific areas, which provides connectivity to a specific DNN, and whose availability is provided to the UE 1802. Outside of these specific areas, the UE 1802 is not able to access the LADN/DN 1836.

Additionally or alternatively, the DN 1836 may be an edge DN 1836, which is a (local) DN that supports the architecture for enabling edge applications. In these examples, the server(s) 1838 represent physical hardware systems/devices providing app server functionality and/or the app software resident in the cloud or at edge compute node(s) that performs server function(s). The server(s) 1838 provides an edge hosting environment (or an edge computing platform) that provides support for implementing or operating edge app execution and/or for providing one or more edge services. The 5GS 1800 can use one or more edge compute nodes to provide an interface and offload processing of wireless communication traffic. In these examples, the edge compute nodes may be included in, or co-located with one or more RANs 1804 or RAN nodes 1814. For example, the edge compute nodes can provide a connection between the RAN 1804 and UPF 1848 in the 5GC 1840. The edge compute nodes can use one or more NFV instances instantiated on virtualization infrastructure within the edge compute nodes to process wireless connections to and from the RAN 1814 and UPF 1848.

An edge computing network (or collection of edge compute nodes) provide a distributed computing environment for application and service hosting, and also provide storage and processing resources so that data and/or content can be processed in close proximity to subscribers (e.g., users of UEs 1802) for faster response times. The edge compute nodes also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 1802. The VI of the edge compute nodes provide virtualized environments and virtualized resources for the edge hosts, and the edge computing applications may run as VMs and/or application containers on top of the VI. Examples of the ECT includes the MEC framework (see e.g., ETSI GS MEC 003 v3.1.1 (2022 March)), Open RAN (O-RAN) (see e.g., O-RAN Working Group 1 (Use Cases and Overall Architecture): O-RAN Architecture Description, O-RAN ALLIANCE WG1, O-RAN Architecture Description v09.00, Release R003 (June 2023)), Multi-Access Management Services (MAMS) framework (see e.g., Kanugovi et al., Multi-Access Management Services (MAMS), INTERNET ENGINEERING TASK FORCE (IETF), Request for Comments (RFC) 8743 (March 2020)), and/or 3GPP System Architecture for enabling Edge Applications (see e.g., 3GPP TS 28.104 v18.0.1 (2023 Jun. 22), 3GPP TS 28.105 v18.0.0 (2023 Jun. 22), 3GPP TS 23.222 v18.2.0 (2023 Jun. 21), 3GPP TS 23.434 v18.5.0 (2023 Jun. 21), 3GPP TS 23.501 v18.2.2 (2023 Jul. 7) (“[TS23501]”), 3GPP TS 23.502 v18.2.0 (2023 Jun. 29) (“[TS23502]”), 3GPP TS 23.548 v18.2.0 (2023 Jun. 22), 3GPP TS 23.558 v18.3.0 (2023 Jun. 21), 3GPP TS 23.682 v18.0.0 (2023 Mar. 31), 3GPP TS 28.532 v17.5.2 (2023 Jul. 5) (“[TS28532]”), 3GPP TS 28.533 v17.3.0 (2023 Mar. 30), 3GPP TS 28.535 v17.7.0 (2023 Jun. 22), 3GPP TS 28.536 v17.5.0 (2023 Mar. 30), 3GPP TS 28.538 v18.3.0 (2023 Jun. 22), 3GPP TS 28.541 v18.4.1 (2023 Jun. 30), 3GPP TS 28.545 v17.0.0 (2021-06-24), 3GPP TS 28.550 v18.1.0 (2023 Mar. 30), 3GPP TS 28.554 v18.2.0 (2023 Jun. 22) (“[TS28554]”), 3GPP TS 28.622 v18.3.0 (2023 Jun. 22), 3GPP TS 29.122 v18.2.0 (2023 Jun. 26), 3GPP TS 29.222 v18.2.0 (2023 Jun. 26), 3GPP TS 29.522 v18.2.0 (2023 Jun. 27), 3GPP TS 33.122 v18.0.0 (2023 Jun. 22) (collectively referred to as “[3GPPEdge]”)), the contents of each of which are hereby incorporated by reference in their entireties).

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure. Examples of such edge computing/networking technologies Further, the techniques disclosed herein may relate to other IoT edge network systems and configurations, and other intermediate processing entities and architectures may also be used for purposes of the present disclosure.

The interfaces of the 5GC 1840 include reference points and service-based interfaces. A reference point, at least in some examples, is a point at the conjunction of two non-overlapping functional groups, elements, or entities. The reference points in the 5GC 1840 include: N1 (between the UE 1802 and the AMF 1844), N2 (between RAN 1814 and AMF 1844), N3 (between RAN 1814 and UPF 1848), N4 (between the SMF 1846 and UPF 1848), N5 (between PCF 1856 and AF 1860), N6 (between UPF 1848 and DN 1836), N7 (between SMF 1846 and PCF 1856), N8 (between UDM 1858 and AMF 1844), N9 (between two UPFs 1848), N10 (between the UDM 1858 and the SMF 1846), N11 (between the AMF 1844 and the SMF 1846), N12 (between AUSF 1842 and AMF 1844), N13 (between AUSF 1842 and UDM 1858), N14 (between two AMFs 1844; not shown), N15 (between PCF 1856 and AMF 1844 in case of a non-roaming scenario, or between the PCF 1856 in a visited network and AMF 1844 in case of a roaming scenario), N16 (between two SMFs 1846; not shown), and N22 (between AMF 1844 and NSSF 1850). Other reference point representations not shown in FIG. 18 can also be used, such as any of those discussed in [TS23501].

The service-based representation of FIG. 18 represents NFs within the control plane that enable other authorized NFs to access their services. A service-based interface (SBI), at least in some examples, is an interface over which an NF can access the services of one or more other NFs. In some implementations, the service-based interfaces are API-based interfaces (e.g., HTTP/2, RESTful, SOAP, and/or any other API or web service) that can be used by an NF to call or invoke a particular service or service operation. The SBIs in the 5GC 1840 include: Namf (SBI exhibited by AMF 1844), Nsmf (SBI exhibited by SMF 1846), Nnef (SBI exhibited by NEF 1852), Npcf (SBI exhibited by PCF 1856), Nudm (SBI exhibited by the UDM 1858), Naf (SBI exhibited by AF 1860), Nnrf (SBI exhibited by NRF 1854), Nnssf (SBI exhibited by NSSF 1850), Nausf (SBI exhibited by AUSF 1842). Other service-based interfaces (e.g., Nudr, N5g-eir, and Nudsf) not shown in FIG. 18 can also be used, such as any of those discussed in [TS23501].

Although not shown by FIG. 18, the system 1800 may also include NFs that are not shown such as, for example, UDR, Unstructured Data Storage Function (UDSF), Network Slice Admission Control Function (NSACF), Network Slice-specific and Stand-alone Non-Public Network (SNPN) Authentication and Authorization Function (NSSAAF), UE radio Capability Management Function (UCMF), 5G-Equipment Identity Register (5G-EIR), CHarging Function (CHF), Time Sensitive Networking (TSN) AF 1860, Time Sensitive Communication and Time Synchronization Function (TSCTSF), Data Collection Coordination Function (DCCF), Analytics Data Repository Function (ADRF), Messaging Framework Adaptor Function (MFAF), Binding Support Function (BSF), Non-Seamless WLAN Offload Function (NSWOF), Service Communication Proxy (SCP), Security Edge Protection Proxy (SEPP), Non-3GPP InterWorking Function (N3IWF), Trusted Non-3GPP Gateway Function (TNGF), Wireline Access Gateway Function (W-AGF), and/or Trusted WLAN Interworking Function (TWIF) as discussed in [TS23501]. Additional or alternative reference points and service-based interfaces that can be part of the 5GS 1840 are also discussed in [TS23501].

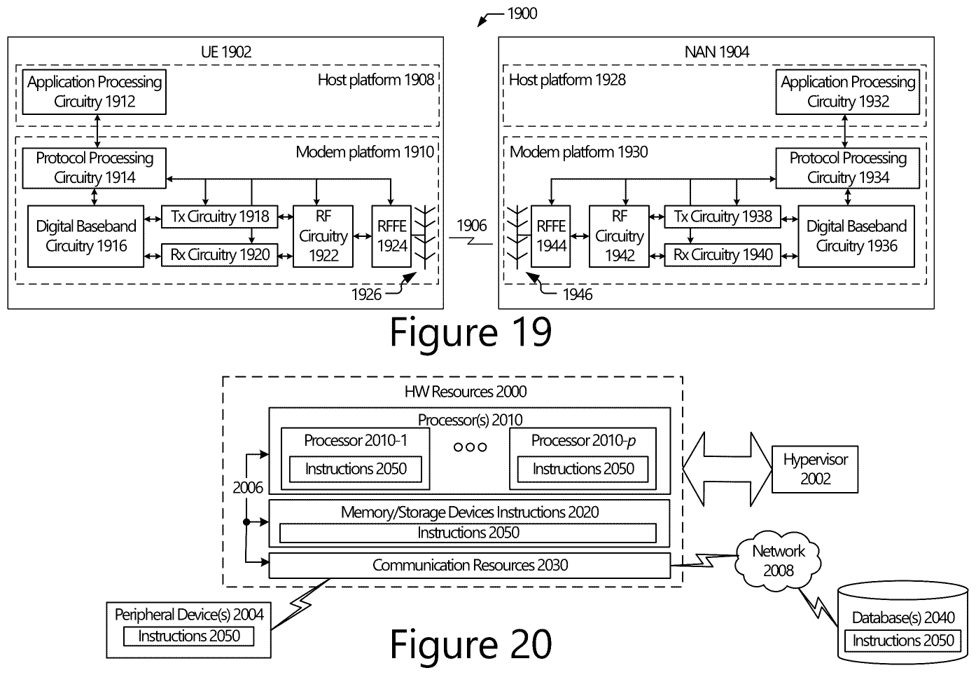

FIG. 19 illustrates a wireless network 1900 that includes a UE 1902 communicatively coupled with a NAN 1904 via connection 1906. The UE 1902 and NAN 1904 may be the same or similar as the UE 1802 and NAN 1804, respectively. The connection 1906 is an air interface to enable communicative coupling, which is consistent with cellular communications protocols, such as LTE, a 5G/NR operating at mmWave or sub-6 GHz frequencies, and/or according to any other RAT discussed herein.

The UE 1902 includes a host platform 1908 coupled with a modem platform 1910. The host platform 1908 includes application processing circuitry 1912, which is coupled with protocol processing circuitry 1914 of the modem platform 1910. The application processing circuitry 1912 runs various applications for the UE 1902 that source/sink application data. The application processing circuitry 1912 implements one or more layer operations to transmit/receive application data to/from a data network. These layer operations include transport (e.g., UDP, TCP, QUIC, and/or the like), network (e.g., IP, and/or the like), and/or operations of other layers. The protocol processing circuitry 1914 implements one or more of layer operations to facilitate transmission or reception of data over the connection 1906. The layer operations implemented by the protocol processing circuitry 1914 includes, for example, MAC, RLC, PDCP, RRC and NAS operations.

The modem platform 1910 includes digital baseband circuitry 1916 that implements one or more layer operations that are “below” layer operations performed by the protocol processing circuitry 1914 in a network protocol stack. These operations includes, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and other related functions.

The modem platform 1910 includes transmit (Tx) circuitry 1918, receive (Rx) circuitry 1920, radiofrequency (RF) circuitry 1922, and an RF front end (RFFE) 1924, which includes or connects to one or more antenna panels 1926. The Tx circuitry 1918 includes a digital-to-analog converter, mixer, intermediate frequency (IF) components, and/or the like; the Rx circuitry 1920 includes an analog-to-digital converter, mixer, IF components, and/or the like; the RF circuitry 1922 includes a low-noise amplifier, a power amplifier, power tracking components, and/or the like; the RFFE 1924 includes filters (e.g., surface/bulk acoustic wave filters), switches, antenna tuners, beamforming components (e.g., phase-array antenna components), and/or the like; and the antenna panels 1926 (also referred to as “Tx/Rx components”) include one or more antenna elements, such as planar inverted-F antennas (PIFAs), monopole antennas, dipole antennas, loop antennas, patch antennas, Yagi antennas, parabolic dish antennas, omni-directional antennas, and/or the like. The selection and arrangement of the components of the Tx circuitry 1918, Rx circuitry 1920, RF circuitry 1922, RFFE 1924, and antenna panels 1926 may be specific to details of a specific implementation such as, for example, whether communication is TDM or FDM, in mmWave or sub-6 gHz frequencies, and/or the like. The Tx/Rx components may be arranged in multiple parallel Tx/Rx chains, may be disposed in the same or different chips/modules, and/or the like. The protocol processing circuitry 1914 includes one or more instances of control circuitry (not shown) to provide control functions for the Tx/Rx components.

A UE reception is established by and via the antenna panels 1926, RFFE 1924, RF circuitry 1922, Rx circuitry 1920, digital baseband circuitry 1916, and protocol processing circuitry 1914. The antenna panels 1926 may receive a transmission from the NAN 1904 by receive-beamforming signals received by a set of antennas/antenna elements of the antenna panels 1926. A UE transmission is established by and via the protocol processing circuitry 1914, digital baseband circuitry 1916, Tx circuitry 1918, RF circuitry 1922, RFFE 1924, and antenna panels 1926. The Tx components of the UE 1904 may apply a spatial filter to the data to be transmitted to form a Tx beam emitted by the antenna elements of the antenna panels 1926.

Similar to the UE 1902, the NAN 1904 includes a host platform 1928 coupled with a modem platform 1930. The host platform 1928 includes application processing circuitry 1932 coupled with protocol processing circuitry 1934 of the modem platform 1930. The modem platform may further include digital baseband circuitry 1936, Tx circuitry 1938, Rx circuitry 1940, RF circuitry 1942, RFFE circuitry 1944, and antenna panels 1946. The components of the NAN 1904 may be similar to and substantially interchangeable with like-named components of the UE 1902. In addition to performing data transmission/reception as described previously, the components of the NAN 1908 may perform various logical functions that include, for example, RNC functions such as radio bearer management, UL and DL dynamic radio resource management, data packet scheduling, and/or various other functions, such as any of those discussed herein.

FIG. 20 illustrates hardware resources 2000 capable of reading instructions from a machine-readable or computer-readable medium (e.g., a non-transitory machine-readable storage medium) and perform any one or more of the methodologies discussed herein. The hardware resources 2000 may correspond to any of the entities/elements discussed herein, such as the UE 1802, 1902; NANs 1814, 1904; server(s) 1838; and/or any of the NFs discussed w.r.t FIG. 18. The hardware resources 2000 include one or more processors (or processor cores) 2010, one or more memory/storage devices 2020, and one or more communication resources 2030, each of which may be communicatively coupled via a interconnect (IX) 2006 or other interface circuitry, which implement any suitable bus and/or IX technologies. Where node virtualization (e.g., NFV) is utilized, a hypervisor 2002 may be executed to provide an execution environment for one or more network slices/sub-slices to utilize the hardware resources 2000. The hardware resources 2000 may be implemented in or by an individual compute node, which may be housed in an enclosure of various form factors. Additionally or alternatively, the hardware resources 2000 may be implemented by multiple compute nodes that may be deployed in one or more data centers and/or distributed across one or more geographic regions.

The processors 2010 include, for example, a processor 2010-1 to 2010-p (where p is a number). The processors 2010 may be or include, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof.

The memory/storage devices 2020 include, for example, main memory, disk storage, or any suitable combination thereof. The memory/storage devices 2020 may include, but are not limited to, any type of volatile, non-volatile, semi-volatile memory, and/or any combination thereof. As examples, the memory/storage devices 2020 can be or include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), Multi-Level Cell (MLC), Quad-Level Cell (QLC), Tri-Level Cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, and/or a combination of any of the aforementioned memory devices, and/or other memory.

The communication resources 2030 include, for example, interconnection controllers and/or network interface controllers, components, or other suitable devices to communicate with one or more peripheral devices 2004, one or more databases 2040, and/or other network elements via a network 2008. The network 2008 may represent any suitable network (e.g., DN 1836, the Internet, an enterprise network, WAN, LAN, WLAN, VPN, and/or the like), an edge computing network, a cloud computing service, and/or the like. For example, the communication resources 2030 can include wired communication components (e.g., for coupling via USB, Ethernet, and/or the like), cellular communication components, NFC components, Bluetooth® (or Bluetooth® Low Energy) components, WiFi® components, and other communication components.

Instructions 2050 comprise software, program code, application(s), applet(s), an app(s), firmware, microcode, machine code, and/or other executable code for causing at least any of the processors 2010 to perform any one or more of the methodologies and/or techniques discussed herein. The instructions 2050 may reside, completely or partially, within at least one of the processors 2010 (e.g., within the processor's cache memory), the memory/storage devices 2020, or any suitable combination thereof. Any portion of the instructions 2050 may be transferred to the hardware resources 2000 from any combination of the peripheral devices 2004 and/or the databases 2040. Accordingly, the memory of processors 2010, the memory/storage devices 2020, the peripheral devices 2004, and the databases 2040 are examples of computer-readable and machine-readable media.

In some implementations, the peripheral devices 2004 may represent one or more sensors (also referred to as “sensor circuitry”). The sensor circuitry includes devices, modules, or subsystems whose purpose is to detect events or changes in its environment and send the information (sensor data) about the detected events to some other a device, module, subsystem, and/or the like. Individual sensors may be exteroceptive sensors (e.g., sensors that capture and/or measure environmental phenomena and/external states), proprioceptive sensors (e.g., sensors that capture and/or measure internal states of a compute node or platform and/or individual components of a compute node or platform), and/or exproprioceptive sensors (e.g., sensors that capture, measure, or correlate internal states and external states). Examples of such sensors include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors, including sensors for measuring the temperature of internal components and sensors for measuring temperature external to the compute node or platform); pressure sensors; barometric pressure sensors; gravimeters; altimeters; image capture devices (e.g., cameras); light detection and ranging (LiDAR) sensors; proximity sensors (e.g., infrared radiation detector and the like); depth sensors, ambient light sensors; optical light sensors; ultrasonic transceivers; microphones; and the like. Additionally or alternatively, the sensors can include GPS circuitry, solid state compass, and/or other sensors.

Additionally or alternatively, the peripheral devices 2004 may represent one or more actuators, which allow a compute node, platform, machine, device, mechanism, system, or other object to change its state, position, and/or orientation, or move or control a compute node (e.g., node 2000), platform, machine, device, mechanism, system, or other object. The actuators comprise electrical and/or mechanical devices for moving or controlling a mechanism or system, and converts energy (e.g., electric current or moving air and/or liquid) into some kind of motion. As examples, the actuators can be or include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms, projectile actuators/mechanisms, and/or audible sound generators, visual warning devices, and/or other like electromechanical components. The compute node 2000 may be configured to operate one or more actuators based on one or more captured events, instructions, control signals, and/or configurations received from a service provider, client device, and/or other components of a compute node or platform. Additionally or alternatively, the actuators are used to change the operational state, position, and/or orientation of the sensors.

### 3. EXAMPLE IMPLEMENTATIONS

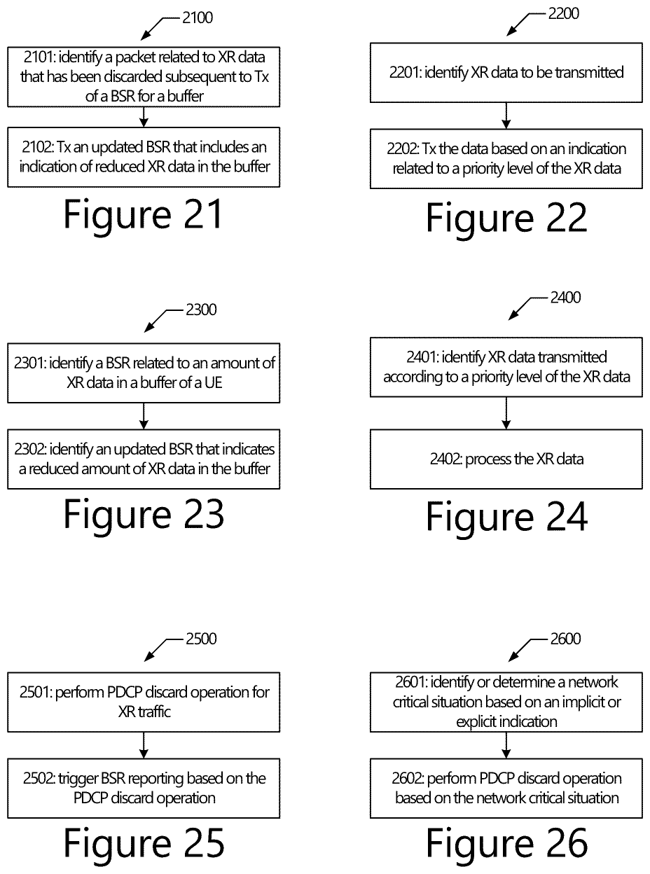

FIGS. 21-26 shows various processes 2100-2600 for practicing aspects of the present disclosure. The examples operations of processes 2100-2600 can be arranged in different orders, one or more of the depicted operations may be combined and/or divided/split into multiple operations, depicted operations may be omitted, and/or additional or alternative operations may be included in any of the depicted processes.

FIG. 21 shows an example process m100 that can be performed by a UE 1802 or some other device. Process 2100 begins at operation 2101 where the UE 1802 identifies a packet related to XR data has been discarded subsequent to transmission of a BSR related to a buffer of the UE 1802. At operation m102, the UE 1802 transmits an updated BSR that includes an indication of reduced XR data in the buffer based on the packet being discarded.

FIG. 22 shows an example process 2200 that can be performed by a UE 1802. Process 2200 begins at operation 2201 where the UE 1802 identifies that XR data is to be transmitted. At operation 2202, the UE 1802 transmits the data based on an indication related to a priority level of the XR data.

FIG. 23 shows an example process m200 that can be performed by a RAN node 1814. Process 2300 begins at operation 2301 where the RAN node 1814 identifies or determines an amount of XR data in a buffer of the UE 1802 based on a BSR received from a UE 1802. At operation 2302, the RAN node 1814 identifies or determines a reduced amount of XR data in the buffer based on an updated BSR from the UE 1802.

FIG. 24 shows an example process 2400 that can be performed by a RAN node 1814. Process 2400 begins at operation m201 where the RAN node 1814 identifies or determines XR data transmitted by a UE 1802 in accordance with a priority level related to the XR data. At operation m202, the RAN node 1814 processes the received XR data.

FIG. 25 shows an example process 2500 that can be performed by a compute node, such as a UE 1802, NAN 1814, and/or some other device. Process 2500 begins at operation 2501 where the compute node performs a PDCP discard operation for XR data. At operation m202, the compute node is triggered to generate and send a BSR based on the PDCP discard operation.

FIG. 26 shows an example process 2600 that can be performed by a compute node, such as a UE 1802, NAN 1814, and/or some other device. Process 2600 begins at operation 2601 where the compute node identifies or determines a network critical situation based on an implicit or explicit indication. At operation 2602, the compute node performs a PDCP discard operation based on the network critical situation. In some examples, the PDCP discard operation at operation 2602 may be the same or similar, or correspond to, the PDCP discard operation at operation 2501 in process 2500.

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes an method to be employed as a user equipment (UE), the method comprising: operating a packet data convergence protocol (PDCP) entity to perform a PDCP discard operation to discard, upon expiration of a discard timer, at least one protocol data unit (PDU) set stored in a transmission buffer; and operating a medium access control (MAC) entity to trigger generation and transmission of a buffer status report (BSR) based on the PDCP discard operation.

Example 2 includes the method of example 1 and/or some other example(s) herein, wherein the discard timer comprises a set of discard timer instances, wherein each discard timer instance in the set of discard timer instances corresponds to respective PDUs in the at least one PDU set.

Example 3 includes the method of example 2 and/or some other example(s) herein, wherein, when all PDUs in the at least one PDU set arrive simultaneously at the transmission buffer, the operating the PDCP entity includes: when a discard timer per set timer is configured by higher layers, disregarding the expiration of the discard timer instances corresponding to any of PDU in the at least one PDU set, and discarding an entirety of the at least one PDU upon expiration of a discard timer per set timer

Example 4 includes the method of example 2 and/or some other example(s) herein, wherein, when all PDUs in the at least one PDU set arrive simultaneously at the transmission buffer, the operating the PDCP entity includes: when the discard timer per set timer is not configured by higher layers, discarding an entirety of the at least one PDU upon expiration of the discard timer.

Example 5 includes the method of examples 3-4 and/or some other example(s) herein, wherein: a value of the discard timer per set timer is based on a PDU set delay budget (PSDB) when the PSDB is available for the at least one PDU; and the value of the discard timer per set timer is configured by higher layers when the PSDB is not available for the at least one PDU.

Example 6 includes the method of examples 2-5 and/or some other example(s) herein, wherein, when PDUs in the at least one PDU set arrive sequentially at the transmission buffer and when a PDU set integrated handling indication (PSIHI) is enabled, the operating the PDCP entity includes: discarding an entirety of the at least one PDU upon expiration of a discard timer instance of at least one PDU in the at least one PDU set.

Example 7 includes the method of example 6 and/or some other example(s) herein, wherein the operating the PDCP entity includes: when a PSDB associated with the at least one PDU is available, disregarding the discard timer, and discarding the entirety of the at least one PDU upon expiration of a discard timer per set timer; and

Example 8 includes the method of example 6 and/or some other example(s) herein, wherein the operating the PDCP entity includes: when the PSDB associated with the at least one PDU is not available, discarding the entirety of the at least one PDU upon expiration of a discard timer instance of a last arriving PDU of the at least one PDU set into the transmission buffer.

Example 9 includes the method of examples 2-8 and/or some other example(s) herein, wherein, when a PSIHI is enabled, the operating the PDCP entity includes: discarding an entirety of the at least one PDU upon expiration of any discard timer instance of the set of discard timer instances.

Example 10 includes the method of example 9 and/or some other example(s) herein, wherein each discard timer instance is set to a value of a PSDB when the PSDB is available for the at least one PDU set.

Example 11 includes the method of example 9 and/or some other example(s) herein, wherein each discard timer instance is set to a value of a corresponding packet delay budget (PDB) when the PSDB is not available for the at least one PDU set.

Example 12 includes the method of examples 1-11 and/or some other example(s) herein, the operating the PDCP entity includes: considering, as a PDCP data volume, PDCP service data units (SDUs) or PDCP data PDUs for which the PDCP discard operation is performed.

Example 13 includes the method of examples 1-12 and/or some other example(s) herein, wherein the operating the MAC entity includes: triggering the generation and transmission of the BSR when a discard BSR timer expires and a total amount of discarded PDCP data volume and discarded radio link control (RLC) data volume pending for transmission is equal to or larger than a discard volume threshold.

Example 14 includes the method of examples 1-13 and/or some other example(s) herein, wherein the operating the MAC entity includes: generating a MAC control element (CE) to include the BSR.

Example 15 includes the method of example 14 and/or some other example(s) herein, wherein the MAC CE includes a set of logical channel group (LCG) fields and a set of buffer size fields, and wherein: each LCG field in the set of LCG fields is associated with an LCG and corresponds to a buffer size field of the set of buffer size fields, wherein an individual LCG field in the set of LCG fields being set to 1 indicates that its corresponding buffer size field for its associated LCG is reported in the MAC CE and the individual LCG field being set to 0 indicates that its corresponding buffer size field for its associated LCG is not reported in the MAC CE; and each buffer size field in the set of buffer size fields identifies a total amount of data available according to a data volume calculation procedure.

Example 16 includes the method of example 14 and/or some other example(s) herein, wherein the MAC CE includes a set of LCG fields and a set of delta buffer size fields, and wherein: each LCG field in the set of LCG fields is associated with an LCG and corresponds to a delta buffer size field of the set of delta buffer size fields, wherein an individual LCG field in the set of LCG fields being set to 1 indicates that its corresponding delta buffer size field for its associated LCG is reported in the MAC CE and the individual LCG field being set to 0 indicates that its corresponding delta buffer size field for its associated LCG is not reported in the MAC CE; and each delta buffer size field in the set of delta buffer size fields identifies, according to a data volume calculation procedure, a difference between a current amount of data available and a previous amount of data available reported in a previously sent BSR.

Example 17 includes the method of examples 15-16 and/or some other example(s) herein, wherein the MAC CE includes a set of criticality fields, wherein each criticality field in the set of criticality fields indicates presence of critical data for a corresponding LCG, wherein an individual criticality field in the set of criticality fields being set to 1 indicates that logical channels in its corresponding LCG carry critical data and the individual criticality field in the set of criticality fields being set to 0 indicates that the logical channels in its corresponding LCG do not carry critical data.

Example 18 includes the method of examples 15-17 and/or some other example(s) herein, wherein the MAC CE includes a set of data value fields, wherein individual data value fields in the set of data value fields indicates a delay budget for a corresponding LCG.

Example 19 includes the method of example 18 and/or some other example(s) herein, wherein each of the individual data value fields carry a delay index that corresponds to a delay budget value for the corresponding LCG.

Example 20 includes the method of examples 15-19 and/or some other example(s) herein, wherein the MAC CE includes a set of bitmap fields, each bitmap field in the set of bitmap fields corresponds to a PDU set, each bit in each bitmap field corresponds to a PDU in its corresponding PDU set, and each bit in each bitmap field indicates whether its corresponding PDU has been discarded or not.

Example 21 includes the method of examples 1-20 and/or some other example(s) herein, wherein the operating the PDCP entity includes: triggering performance of the PDCP discard operation based on a network congestion indication.

Example 22 includes the method of example 21 and/or some other example(s) herein, wherein the network congestion indication is an implicit indication based on expiration of a congestion timer and/or a congestion indication threshold based on an amount of data stored in the transmission buffer.

Example 23 includes the method of example 21 and/or some other example(s) herein, wherein the network congestion indication is an explicit indication obtained from a radio access network (RAN) node, wherein the explicit network congestion is included in a MAC CE or headers of one or more downlink packets

Example 24 includes the method of example 23 and/or some other example(s) herein, wherein the operating the PDCP entity includes: discarding, based on receipt of the explicit indication, SDUs or PDUs belonging to the at least one PDU set for a configured network congestion time; and resuming normal operation after expiration of the configured network congestion time.

Example Z01 includes one or more computer readable media comprising instructions, wherein execution of the instructions by processor circuitry is to cause the processor circuitry to perform the method of any one of examples 1-24. Example Z02 includes a computer program comprising the instructions of example Z01. Example Z03 includes an Application Programming Interface defining functions, methods, variables, data structures, and/or protocols for the computer program of example Z02. Example Z04 includes an API or specification defining functions, methods, variables, data structures, protocols, and the like, defining or involving use of any of examples 1-24 or portions thereof, or otherwise related to any of examples 1-24 or portions thereof. Example Z05 includes an apparatus comprising circuitry loaded with the instructions of example Z01. Example Z06 includes an apparatus comprising circuitry operable to run the instructions of example Z01. Example Z07 includes an integrated circuit comprising one or more of the processor circuitry of example Z01 and the one or more computer readable media of example Z01. Example Z08 includes a computing system comprising the one or more computer readable media and the processor circuitry of example Z01. Example Z09 includes an apparatus comprising means for executing the instructions of example Z01. Example Z10 includes a signal generated as a result of executing the instructions of example Z01. Example Z11 includes a data unit generated as a result of executing the instructions of example Z01. Example Z12 includes the data unit of example Z10 and/or some other example(s) herein, wherein the data unit is a datagram, network packet, data frame, data segment, a Protocol Data Unit (PDU), a Service Data Unit (SDU), a message, or a database object. Example Z13 includes a signal encoded with the data unit of examples Z11 and/or Z12. Example Z14 includes an electromagnetic signal carrying the instructions of example Z01. Example Z15 includes an apparatus comprising means for performing the method of any one of examples 1-24 and/or some other example(s) herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### 4. TERMINOLOGY

For the purposes of the present document, the following terms and definitions are applicable to the examples and embodiments discussed herein. Additionally, the terminology provided in '365, '519, and '705 may also be applicable to aspects of the present disclosure.

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network. Examples of access technologies include wired access technologies (e.g., wireline, wireline-cable, wireline broadband forum, Ethernet and variants thereof, fiber optics networks, digital subscriber line (DSL) and variants thereof, Data Over Cable Service Interface Specification (DOCSIS) technologies, hybrid fiber-coaxial (HFC) technologies, and/or the like) and wireless access technologies/RATs (e.g., including any of those listed in '285 and '757).

The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like). The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi)set, random access list, hash consing, zipper data structure, and/or the like).

The terms “configuration”, “policy”, “ruleset”, and/or “operational parameters”, at least in some examples refer to a machine-readable information object that contains instructions, conditions, parameters, and/or criteria that are relevant to a device, system, or other element/entity. The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information. The term “field” at least in some examples refers to individual contents of an information element or other data structure, and/or a data element that contains content.

The term “serving cell” at least in some examples refers to a primary cell (PCell) for a UE in a connected mode or state (e.g., RRC_CONNECTED) and not configured with carrier aggregation (CA) and/or dual connectivity (DC). Additionally or alternatively, the term “serving cell” at least in some examples refers to a set of cells comprising zero or more special cells and one or more secondary cells for a UE in a connected mode or state (e.g., RRC_CONNECTED) and configured with CA. The term “primary cell” or “PCell” at least in some examples refers to a master cell group (MCG) cell, operating on a primary frequency, in which a UE either performs an initial connection establishment procedure or initiates a connection re-establishment procedure. The term “primary secondary cell”, “primary SCG cell”, or “PSCell” at least in some examples refers to a primary cell of a secondary cell group (SCG). The term “secondary cell” or “SCell” at least in some examples refers to a cell providing additional radio resources on top of a special cell (SpCell) for a UE configured with CA. The term “special cell” or “SpCell” at least in some examples refers to a PCell for non-DC operation or refers to a PCell of an MCG or a PSCell of an SCG for DC operation. In some examples, the terms “PCell” and “PSCell” are collectively referred to as a “special cell”, “spCell”, or “SpCell”.

Although many of the various examples in the present disclosure are provided with use of specific cellular/mobile network terminology, it will be understood these examples may be applied to many other deployments of wide area networks and local wireless networks, as well as the integration of wired networks (including optical networks and associated fibers, transceivers, and/or the like). Furthermore, various standards (e.g., 3GPP, ETSI, O-RAN, and/or the like) define aspects for implementing such standards, but it should be understood that the requirements of any particular standard should not limit the aspects discussed herein, and such requirements can be modified by the aspects discussed herein, or can be used in combination with the aspects discussed herein. Aspects of the inventive subject matter may be referred to herein, individually and/or collectively, merely for convenience and without intending to limit the scope of this application to any single aspect or inventive concept that is/are disclosed. Specific aspects have been illustrated and described herein, and it should be appreciated that any arrangement capable of achieving the same purpose may be substituted for the specific aspects shown and described herein. This disclosure is intended to cover any and all adaptations or variations of various aspects. Combinations of the various aspects described herein and other aspects not specifically described herein will be apparent to those of skill in the art upon reviewing the above description.

1. An apparatus of a user equipment (UE), the apparatus comprising:
memory circuitry to store a protocol stack including a packet data convergence protocol (PDCP) entity and a medium access control (MAC) entity; and
processor circuitry connected to the memory circuitry, wherein the processor circuitry is to:
operate the PDCP entity to perform a PDCP discard operation to discard, upon expiration of a discard timer, at least one protocol data unit (PDU) set stored in a transmission buffer; and
operate the MAC entity to trigger generation and transmission of a buffer status report (BSR) based on the PDCP discard operation.

2. The apparatus of claim 1, wherein the discard timer comprises a set of discard timer instances, wherein each discard timer instance in the set of discard timer instances corresponds to respective PDUs in the at least one PDU set.

3. The apparatus of claim 2, wherein, when all PDUs in the at least one PDU set arrive simultaneously at the transmission buffer, the processor circuitry is to operate the PDCP entity to:
when a discard timer per set timer is configured by higher layers,
disregard the expiration of the discard timer instances corresponding to any of PDU in the at least one PDU set, and
discard an entirety of the at least one PDU upon expiration of a discard timer per set timer; and
when the discard timer per set timer is not configured by higher layers, discard an entirety of the at least one PDU upon expiration of the discard timer.

4. The apparatus of claim 3, wherein:
a value of the discard timer per set timer is based on a PDU set delay budget (PSDB) when the PSDB is available for the at least one PDU; and
the value of the discard timer per set timer is configured by higher layers when the PSDB is not available for the at least one PDU.

5. The apparatus of claim 2, wherein, when PDUs in the at least one PDU set arrive sequentially at the transmission buffer and when a PDU set integrated handling indication (PSIHI) is enabled, the processor circuitry is to operate the PDCP entity to:
discard an entirety of the at least one PDU upon expiration of a discard timer instance of at least one PDU in the at least one PDU set.

6. The apparatus of claim 5, wherein the processor circuitry is to:
when a PSDB associated with the at least one PDU is available, disregard the discard timer, and discard the entirety of the at least one PDU upon expiration of a discard timer per set timer; and
when the PSDB associated with the at least one PDU is not available, discard the entirety of the at least one PDU upon expiration of a discard timer instance of a last arriving PDU of the at least one PDU set into the transmission buffer.

7. The apparatus of claim 2, wherein, when a PSIHI is enabled, the processor circuitry is to operate the PDCP entity to:
discard an entirety of the at least one PDU upon expiration of any discard timer instance of the set of discard timer instances, wherein:
each discard timer instance is set to a value of a PSDB when the PSDB is available for the at least one PDU set; and
each discard timer instance is set to a value of a corresponding packet delay budget (PDB) when the PSDB is not available for the at least one PDU set.

8. The apparatus of claim 1, wherein the processor circuitry is to operate the PDCP entity to:
consider, as a PDCP data volume, PDCP service data units (SDUs) or PDCP data PDUs for which the PDCP discard operation is performed.

9. The apparatus of claim 1, wherein the processor circuitry is to operate the MAC entity to:
trigger the generation and transmission of the BSR when a discard BSR timer expires and a total amount of discarded PDCP data volume and discarded radio link control (RLC) data volume pending for transmission is equal to or larger than a discard volume threshold.

10. The apparatus of claim 1, wherein the processor circuitry is to operate the PDCP entity to:
trigger performance of the PDCP discard operation based on a network congestion indication.

11. The apparatus of claim 10, wherein the network congestion indication is an implicit indication based on expiration of a congestion timer and/or a congestion indication threshold based on an amount of data stored in the transmission buffer.

12. The apparatus of claim 10, wherein the network congestion indication is an explicit indication obtained from a radio access network (RAN) node, wherein the explicit network congestion is included in a MAC CE or headers of one or more downlink packets.

13. The apparatus of claim 12, wherein the processor circuitry is to operate the PDCP entity to:
discard, based on receipt of the explicit indication, SDUs or PDUs belonging to the at least one PDU set for a configured network congestion time; and
resume normal operation after expiration of the configured network congestion time.

14. A non-transitory computer-readable medium (NTCRM) comprising instructions for operating a medium access control (MAC) entity of a network protocol stack, wherein execution of the instructions by one or more processors is to cause a user equipment (UE) to:
detect that a packet data convergence protocol (PDCP) discard operation has been performed to discard at least one protocol data unit (PDU) set stored in a transmission buffer;
generate a MAC control element (CE) to include a buffer status report (BSR) based on the PDCP discard operation; and
cause transmission of the MAC CE to a radio access network (RAN) node.

15. The NTCRM of claim 14, wherein the MAC CE includes a set of logical channel group (LCG) fields and a set of buffer size fields, and wherein:
each LCG field in the set of LCG fields is associated with an LCG and corresponds to a buffer size field of the set of buffer size fields, wherein an individual LCG field in the set of LCG fields being set to 1 indicates that its corresponding buffer size field for its associated LCG is reported in the MAC CE and the individual LCG field being set to 0 indicates that its corresponding buffer size field for its associated LCG is not reported in the MAC CE; and
each buffer size field in the set of buffer size fields identifies a total amount of data available according to a data volume calculation procedure.

16. The NTCRM of claim 14, wherein the MAC CE includes a set of LCG fields and a set of delta buffer size fields, and wherein:
each LCG field in the set of LCG fields is associated with an LCG and corresponds to a delta buffer size field of the set of delta buffer size fields, wherein an individual LCG field in the set of LCG fields being set to 1 indicates that its corresponding delta buffer size field for its associated LCG is reported in the MAC CE and the individual LCG field being set to 0 indicates that its corresponding delta buffer size field for its associated LCG is not reported in the MAC CE; and
each delta buffer size field in the set of delta buffer size fields identifies, according to a data volume calculation procedure, a difference between a current amount of data available and a previous amount of data available reported in a previously sent BSR.

17. The NTCRM of claim 15, wherein the MAC CE includes a set of criticality fields, wherein each criticality field in the set of criticality fields indicates presence of critical data for a corresponding LCG, wherein an individual criticality field in the set of criticality fields being set to 1 indicates that logical channels in its corresponding LCG carry critical data and the individual criticality field in the set of criticality fields being set to 0 indicates that the logical channels in its corresponding LCG do not carry critical data.

18. The NTCRM of claim 15, wherein the MAC CE includes a set of data value fields, wherein individual data value fields in the set of data value fields indicates a delay budget for a corresponding LCG.

19. The NTCRM of claim 18, wherein each of the individual data value fields carry a delay index that corresponds to a delay budget value for the corresponding LCG.

20. The NTCRM of claim 15, wherein the MAC CE includes a set of bitmap fields, each bitmap field in the set of bitmap fields corresponds to a PDU set, each bit in each bitmap field corresponds to a PDU in its corresponding PDU set, and each bit in each bitmap field indicates whether its corresponding PDU has been discarded or not.
